(19) United States
(12) Patent Application Publication
(10) Pub. No.: US 2011/0004488 A1
(43) Pub. Date: Jan. 6, 2011

(54) Server-guidance of health-care I

(76) Inventor: Anuthep Benja-Athon, New York, NY (US)

Correspondence Address: ANUTHEP BENJA-ATHON, M.D.;Ground Floor, 210 E 36th St., New York, NY, 10016, US

(21) Appl. No.: 12/924,054

(22) Filed: Sep. 20, 2010

Related U.S. Application Data
(63) Continuation-in-part of application No. 12/804,588, filed on Jul. 26, 2010.
Application No. 12/804,588 is a continuation-in-part of application No. 12/799,207, filed on Apr. 21, 2010.
Application No. 12/799,207 is a continuation-in-part of application No. 12/658,112, filed on Feb. 3, 2010.
Application No. 12/658,112 is a continuation-in-part of application No. 12/655,748, filed on Jan. 7, 2010.
Application No. 12/655,748 is a continuation-in-part of application No. 12/592,714, filed on Dec. 2, 2009.
Application No. 12/592,714 is a continuation-in-part of application No. 12/584,718, filed on Sep. 11, 2009.
Application No. 12/584,718 is a continuation-in-part of application No. 12/381,654, filed on Mar. 16, 2009.
Application No. 12/381,654 is a continuation-in-part of application No. 12/322,529, filed on Feb. 4, 2009.
Application No. 12/322,529 is a continuation-in-part of application No. 12/321,141, filed on Jan. 16, 2009.
Application No. 12/321,141 is a continuation-in-part of application No. 12/156,674, filed on Jun. 4, 2008.
Application No. 12/156,674 is a continuation-in-part of application No. 12/080,433, filed on Apr. 3, 2008.
Application No. 12/080,433 is a continuation-in-part of application No. 12/069,409, filed on Feb. 11, 2008.
Application No. 12/069,409 is a continuation-in-part of application No. 11/986,657, filed on Nov. 26, 2007, now abandoned.
Application No. 11/986,657 is a continuation-in-part of application No. 11/803,621, filed on May 16, 2007.
Application No. 11/803,621 is a continuation-in-part of application No. 11/716,062, filed on Mar. 9, 2007, now abandoned.
Application No. 11/716,062 is a continuation-in-part of application No. 11/649,873, filed on Jan. 5, 2007, now abandoned.
Application No. 11/649,873 is a continuation-in-part of application No. 11/344,485, filed on Feb. 1, 2006.
Application No. 11/344,485 is a continuation-in-part of application No. 11/637,662, filed on Dec. 13, 2006, now abandoned.
Application No. 11/637,662 is a continuation-in-part of application No. 11/599,847, filed on Nov. 16, 2006, now abandoned.
Application No. 11/599,847 is a continuation-in-part of application No. 11/431,046, filed on May 10, 2006, now abandoned.
Application No. 11/431,046 is a continuation-in-part of application No. 11/543,895, filed on Oct. 6, 2006, now abandoned.
Application No. 11/543,895 is a continuation-in-part of application No. 11/523,945, filed on Sep. 21, 2006, now abandoned.
Application No. 11/523,945 is a continuation-in-part of application No. 11/510,820, filed on Aug. 28, 2006, now abandoned.
Application No. 11/510,820 is a continuation-in-part of application No. 11/477,121, filed on Jun. 29, 2006, now abandoned.
Application No. 11/477,121 is a continuation-in-part of application No. 11/114,763, filed on Apr. 27, 2005, now abandoned.
Application No. 11/114,763 is a continuation-in-part of application No. 11/196,823, filed on Aug. 4, 2005, now abandoned.
Application No. 11/196,823 is a continuation-in-part of application No. 11/973,866, filed on Oct. 11, 2007, now abandoned.
Application No. 11/973,866 is a continuation-in-part of application No. 11/293,689, filed on Dec. 5, 2005, now abandoned.
Application No. 11/293,689 is a continuation-in-part of application No. 11/150,878, filed on Jun. 13, 2005, now abandoned.
Application No. 11/150,878 is a continuation-in-part of application No. 11/074,236, filed on Mar. 7, 2005, now abandoned.
Application No. 11/074,236 is a continuation-in-part of application No. 11/022,410, filed on Dec. 27, 2004, now abandoned.
Application No. 11/022,410 is a continuation-in-part of application No. 09/191,795, filed on Nov. 13, 1998, now Pat. No. 6,132,218.

(51) Int. Cl. G06Q 50/00; G06Q 10/00; G06F 17/30

(52) U.S. Cl. 705/2; 707/769; 707/E17.014

(57) ABSTRACT

A server-computer system and method for computer server-automatically and continually managing and monitoring diseases and disorders and quality, quantity and continuity of health, health-care and health-care services being provided and to be provided by physicians to patients in a network or networks of computer servers and computers and mobile devices.

This application is a continuation-in-part of Ser. No. 12/804,588 entitled An intelligent computer-biological electronic-neural health-care system filed Jul. 26, 2010, a continuation-in-part of Ser. No. 12/799,207 entitled Computer-created-consensus-based health-care system filed Apr. 21, 2010, a continuation-in-part of Ser. No. 12/658,112 entitled A system and method for computer-generations of diagnoses filed Feb. 3, 2010, a continuation-in-part of Ser. No. 12/655,748 entitled the Artificial-intelligent system and method for managing health-care filed Jan. 7, 2010, a continuation-in-part of Ser. No. 12/592,714 entitled the Healthcare Exchange IV filed Dec. 2, 2009, a continuation-in-part of Ser. No. 12/584,718 filed Sep. 11, 2009, a continuation-in-part of Ser. No. 12/381,654 filed Mar. 16, 2009 entitled the Adaptable compositions of health information, a continuation-in-part of Ser. No. 12/322,529 entitled the Healthcare Exchange II filed Feb. 4, 2009, a continuation-in-part of Ser. No. 12/321,141 entitled the Best system of health and health-care data management filed Jan. 16, 2009, a continuation-in-part of Ser. No. 12/156,674 entitled A precise medical information retrieval filed Jun. 4, 2008, a continuation-in-part of Ser. No. 12/080,433 entitled The Healthcare Exchange filed Apr. 3, 2008, a continuation-in-part of Ser. No. 12/069,409 entitled the Filing of Health and Health-care data filed Feb. 11, 2008, continuation-in-part of Ser. No. 11/986,657 entitled A hierarchy of medical word headers filed Nov. 26, 2007, a continuation-in-part of Ser. No. 11/803,621 entitled Patients' and physicians' data management filed May 16, 2007, a continuation-in-part of Ser. No. 11/716,062 entitled A sieve of words in health-care data filed Mar. 9, 2007, a continuation-in-part of Ser. No. 11/649,873 entitled A system of calibrating physicians' practices of medicine filed Jan. 5, 2007, a continuation-in-part of Ser. No. 11/344,485 entitled Physicians-patients-health-care-buyers accounting system filed Feb. 1, 2006, a continuation-in-part of Ser. No. 11/637,662 entitled A vital hierarchy of data on diseases filed Dec. 13, 2006, a continuation-in-part of Ser. No. 11/599,847 entitled A hybrid intelligence in medicine filed Nov. 16, 2006, a continuation-in-part of Ser. No. 11/431,046 entitled A system of health-care information management filed Nov. 2, 2006, a continuation-in-part of Ser. No. 11/543,895 entitled Vital elements of speech recognition filed Oct. 6, 2006, a continuation-in-part of Ser. No. 11/523,945 entitled The networking of digital health information filed Sep. 21, 2006, a continuation-in-part of Ser. No. 11/510,820 entitled Words for managing health and health-care information filed Aug. 28, 2006, a continuation-in-part of Ser. No. 11/477,121 entitled the Medical Vocabulary Templates in Speech Recognition filed Jun. 29, 2006, a continuation-in-part of Fidelity of physicians' thoughts to digital data conversions filed Jan. 9, 2006, a continuation-in-part of Ser. No. 11/114,763 entitled A system of influencing health-care utilizations filed Apr. 27, 2005, a continuation-in-part of Ser. No. 11/196,823 entitled Routing of health information files filed Aug. 4, 2005, a continuation-in-part of Ser. No. 11/973,866 entitled An intelligent system of speech recognizing physicians' data, a continuation-in-part of Ser. No. 11/293,689 entitled A system of conserving health-care buyers' resources filed Dec. 5, 2005, a continuation-in-part of Ser. No. 11/150,878 entitled Physicians' optimal management of health information filed Jun. 13, 2005, a continuation-in-part of Ser. No. 11/074,236 entitled A system of management of health-care resources filed Mar. 7, 2005, a continuation-in-part of Ser. No. 11/022,410 entitled Physicians' way of information productions filed Dec. 27, 2004 which are pending and a continuation-in-part of U.S. Pat. No. 6,132,218 entitled Images for communication of medical information in computer granted Oct. 17, 2000 to this present patent applicant.

### FIELD OF INVENTION

The networks of servers and devices for safe-guarding and optimizing health and lives.

### BACKGROUND OF THE INVENTION

The American health-care system—relatively best albeit archaic health-care system on earth—not only improve and quality of life and standard of living of people but, being archaic, has also grown and deteriorate to lower the standard of living and cause pains and suffering and escalating costs for all Americans and, worst, premature and unexpected morbidity, demises and deaths for a lot of Americans.

The present invention—an innovative and massive health-care endeavor created by and for physicians and patients—not only counteracts, checks and quashes said negativity but also enables and sustains further developments and progress of the American health-care system to benefit all Americans, and the world lacking same, for today and millenniums.

However, the present invention uniquely and realistically provides an innovative and the most powerful servers and computers networks-intelligent system and method for improving and/or optimizing physicians' practice of medicine and deliveries of health, health-care and health-care services to people based at much lesser costs and losses to people including physicians and nations. Said adverse events, conditions, settings and outcomes are minimized or eliminated by the present invention.

The present invention optimally expedites and improves medical-decision and health-care processes and the managements and deliveries of health-care and health-care services to patients and, together with said pending patent applications, are the only means and solution for solving the current health and health-care woes affecting all Americans and, consequently, they produce the best health-care system the world ever known and have and the global benefits for billions of people are immense.

### SUMMARY OF THE INVENTION

The American health-care system—relatively the best albeit archaic health-care system on earth—not only improve and quality of life and standard of living of people but, being archaic, has also grown and deteriorate to lower the standard of living and cause pains and suffering and escalating costs for all Americans and, worst, premature and preventable morbidity, demises and deaths of many Americans and humans.

The present invention is computer-server system for computer server-automatically, instantly, continually and constantly managing and monitoring diseases and disorders and quality, quantity and continuity of health, health-care and health-care services, being provided and to be provided by individual physicians and physicians in individual groups of physicians and health-care providers to patients and individual patients related to individual diagnoses, individual syndromes or individual diagnoses in individual groups of related diagnoses in the SQL databases and tables in and manage by a SQL Server in a functioning and operating computer server or servers for said physicians and patients using computers and mobile wireless communication devices in a network or networks of said servers and devices.

### DESCRIPTION OF THE PREFERRED EMBODIMENTS

The present invention provides a computer-server system for computer server-automatically, repetitively, continually, constantly on 24/7 basis and perpetually managing and monitoring diseases and disorders and quality, quantity and continuity of health, health-care and health-care services for all diseases and disorders such as, but not limited to, chronic, common and prevalent diseases and disorders being provided and to be provided by individual physicians, physicians and among physicians and/or health-care providers in individual groups of physicians and health-care providers in diverse and different localities, regions, states and nations to patients and individual patients in diverse and different settings, practices, localities, regions, states and nations related to individual diagnoses, individual syndromes or individual diagnoses in individual groups of related diagnoses in the SQL databases and tables in and manage by a SQL Server in a functioning and operating computer server or servers for billions of people including physicians, health-care providers and patients in diverse and different localities, regions, states and nations to patients and individual patients in diverse and different settings, practices, localities, regions, states and nations in a regional, national and global networks of computer servers and communication devices.

First, the present invention provides a system and method for computer server-automatically, repetitively, continually, constantly on 24/7 basis and perpetually guiding, assisting and adapting decision makings, judgements, determinations and executions of health, health-care and health-care services provided and to be provided by said individual physicians and among physicians in said individual groups of physicians and individual patients impacting on the health, health-care and health-care services related to individual diagnoses, individual syndromes or individual diagnoses in individual groups of related diagnoses being provided or to be provided to patients or individual patients by individual physicians or physicians in individual groups of physicians and health-care providers and on the inputs of said decision makings, judgements, determinations and executions into said SQL databases and tables which, consequently, result or have bearing on the server-automatic qualifications or approvals and regulations of individual payments for health-care and health-care services to individual physicians and proportional payments, distributions, adjustments, debits, redistributions and readjustments of payments in and among individual adaptable and expanding compositions of adaptable accounts of individual patients and individual physicians in individual groups of physicians related to individual diagnoses or individual diagnoses in individual groups of related diagnoses and related health, health-care and health-care services provided to said individual patients by said individual physicians or individual groups of physicians and related individual disbursements relating and corresponding to said payments in individual adaptable and expanding compositions of adaptable accounts of said individual patients in the SQL databases in and manage by a SQL server. Said system and method comprise: i) a process for repetitively, displaying, viewing and using server-generated electronic related templates of numerous related Web pages on said viewing screens comprising drop-down or pop-up templates of lists of interactive related words, terms, phrases, sentences, texts, synonyms, acronyms, texts, numbers, data, graphics and any combinations thereof and related adjectives and variables henceforth words and terms in any or all categories—see infra for definition—and related individual diagnoses or individual syndromes in all medical and surgical specialties in said adaptable and expanding individual relations of said individual unique relational SQL units in and among said SQL databases and tables in and manage by said SQL Server by said physicians or patients using said devices; ii) a process for repetitively pointing with mice and/or fingers, clicking and selecting said interactive words and terms in any or all categories related to individual diagnoses or individual syndromes in said related templates on said viewing screens by said physicians or patients using said devices and/or a process for keyboarding words and terms in any or all categories related to individual diagnoses or individual syndromes into said related templates by said physicians or patients using said devices for repetitively creating and generating said individual words and representing information and data on health, health-care and health-care services on or relating to individual diagnoses or individual diagnoses in individual groups of related diagnoses of diseases and disorders and related health, health-care and health-care services which are integral components of said health, health-care and health-care-service information and data on or relating to diseases and disorders and patients used and use by physicians of all and diverse medical and surgical practices or specialties for and in the communications of said information and data among and between physicians and between physicians and patients and related to individual prices, monetary values or costs in said processor units and outputted, related and compiled in said SQL databases in and manage by said SQL Server; iii) a process for repetitively pointing with mice and/or fingers, clicking and selecting said interactive words and terms in any or all categories related to individual diagnoses or individual syndromes in said related templates on said viewing screens by said physicians or patients using said devices and/or a process for keyboarding words and terms in any or all categories related to individual diagnoses or individual syndromes into said related templates by said physicians or patients using said devices for repetitively creating and generating words and terms in said categories related to individual diagnoses or individual syndromes which are integral components of electronic information and data on health, health-care and health-care-services in individual electronic medical records, on or relating to individual patients, generated and submitted to said processor units and memories by said physicians; iv) a process for repetitively generating said individual words and terms representing information and data on health, health-care and health-care services and related said individual diagnoses or said individual diagnoses in individual groups of related diagnoses continually and perpetually generated and submitted by said physicians and between and among said individual physicians in individual groups of physicians and adaptable and expanding editions of versions of said information and data on individual diagnoses or individual diagnoses in individual groups of related diagnoses of diseases and disorders and editions of related versions of information and data on related health-care and health-care services and editions of related versions of compositions of accounts and successive editions of related versions of information and data on individual diagnoses or individual diagnoses in individual groups of related diagnoses of diseases and disorders and successive editions of related versions of information and data on health, health-care and health-care services relating to said versions of diagnoses and successive editions of compositions of accounts by physicians and said computer, computer server or servers and manage by said SQL server; v) a process for server-automatically and instantly identifying, determining and displaying and warning of individual deficiencies, inconsistencies, faults and misses in said decision makings, judgements, determinations and executions of said health, health-care and health-care services related to any or all categories and related definitive or preliminary diagnoses represented by individual deficiencies, inconsistencies, faults and misses in said individual selections and keyboarded words and terms in said templates on said viewing screens referencing to and correlating, collaborating and comparing with the pooled and compiled decision makings, judgements, determinations and executions on said health, health-care and health-care services related to individual diagnoses, individual syndromes or individual diagnoses in individual groups of related individual diagnoses or individual syndromes related to physicians related to SQL keys in said adaptable and expanding individual relations of said individual unique relational SQL units in and among said SQL databases and tables; vi) a process for server-automatically, instantly and concomitantly compensating or correcting for or advising and providing options and alternatives to said individual deficiencies, inconsistencies, faults and misses, prior to the inputs of said selections or keyboarded words and terms, by retrieving from and displaying interactive words and terms in said adaptable and expanding individual relations of said individual unique relational SQL units in and among said SQL databases and tables on said viewing screens for said physicians or patients; vii) a process for submitting said selections, keyboarded words and terms and corrections and editions to said processor units, memories from which server-automatically and repetitively outputting said words and terms in any or all categories related to individual diagnoses, individual syndromes or diagnoses in individual groups of related diagnoses related to individual physicians and patients to relate and compile in said relational individual SQL units in said adaptable and expanding relations of SQL units in said SQL databases in and manage by said SQL in said computer server or servers; and, consequently, viii) a process for computer-automatically and repetitively applying said plurality of computer server-executable algorithms; ix) a process for server-automatically, instantly and repetitively scanning, matching correlating, collaborating and comparing individual words and terms in any or all said categories in individual inputs or queries repetitively generated and submitted to said processor units and memories by said individual physicians, physicians or said physicians in individual groups of physicians and health-care providers or said individual patients using said devices, with same, similar, synonymous or equivalent words and terms in any or all categories related to individual diagnoses or individual syndromes in said individual unique relational SQL units in said individual relations of said individual unique relational SQL units in and among said SQL databases and tables, or vice versa; and, consequently, x) a process for server-automatically, instantly and repetitively scanning, matching, correlating, collaborating and comparing individual words and terms in any or all said categories related to individual diagnoses or individual syndromes and individual patients in individual inputs repetitively generated and submitted to said processor units and memories by said individual physicians, physicians or said physicians in individual groups of physicians and health-care providers or individual patients using said devices, with said individual unique relational SQL units in said individual relations of said individual unique relational SQL units in and among said SQL databases and tables, or vice versa; xi) a process for server-automatically, instantly and repetitively scanning, matching, correlating, collaborating and comparing individual words and terms in any or all said categories related to individual diagnoses or individual syndromes, individual patients and individual physicians, physicians or said physicians in individual groups of physicians and health-care providers in individual inputs repetitively generated and submitted to said processor units and memories by said individual physicians or said physicians and health-care providers or said individual patients using said devices, with said individual unique relational SQL units in said individual relations of said individual unique relational SQL units in and among said SQL databases and tables, or vice versa; xii) a process for said individual physicians or physicians in individual groups of physicians to repetitively relate individual patients or patients related to individual diagnoses, individual syndromes or diagnoses in individual groups of diagnoses and related said categories related to individual SQL keys to individual SQL keys related to individual physicians, physicians, health-care providers, or physicians in individual groups of physicians and health-care providers in said SQL databases and tables using said devices and said relations of physicians, patients and diagnoses related to said individual SQL keys are server-automatically, repetitively and continually retrieved and displayed on said viewing screens of said physicians and patients who viewed, interactive with, use and select said interactive displays on said viewing screens of said devices; xiii) a process for server-automatically, repetitively and continually relating individual diagnoses, individual syndromes or diagnoses in individual groups of diagnoses and individual patients to individual physicians, physicians, health-care providers or physicians in individual groups of physicians and health-care providers related to said diagnoses related to individual SQL keys in said SQL databases and tables which are server-automatically, repetitively and continually retrieved and displayed on said viewing screens of said physicians and patients who viewed, interactive with, use and select said interactive displays on said viewing screens of said devices; xiv) a process for server-automatically and repetitively selecting, retrieving and displaying adaptable and expanding compositions of said SQL relations of individual relational SQL units related to individual diagnoses, individual syndromes or diagnoses in individual groups of related diagnoses and related differential diagnoses and related categories and individual physicians or physicians in said individual groups of physicians and health-care providers related to said individual SQL keys in said SQL databases and tables on said viewing screens of said devices to individual patients and people; xv) a process for server-automatically guiding and adapting said decision makings, judgements, determinations and executions of said individual physicians and among physicians in said individual groups of physicians, and individual patients and impacting on the generations and inputs of said information and data into said processor units and memories coupled to said SQL Server comprising said SQL databases and tables, said adaptable and expanding relations of SQL units in said SQL databases in and manage by said SQL in said computer server or servers; and xvi) a process for server-automatically generating and repetitively displaying individual diagnoses, individual syndromes or individual diagnoses in individual groups of related diagnoses and related categories and individual physicians or physicians in individual groups of physicians and health-care providers and related individual patients or patients related to individual SQL keys in said individual relational SQL units in said SQL databases and tables and server-automatically and continually retrieved, viewable in server-automatically generated and displayed interactive related electronic templates, HTML related Web pages and on interactive and related 2-dimensional and 3-dimensional, human figurines and images, graphics, charts, videos and as dynamic data, transactional data and streaming data and any combinations thereof and the like and derivatives on said viewing screens of said devices and useable by and interactive with said individual physicians and physicians in individual groups of physicians and health-care providers, individual patients and patients using said devices.

Second, further and consequent to supra, the present invention provides a system and method for computer server-automatically, repetitively and continually patterning, standardizing and tuning said decision makings, judgements, determinations and executions on the productions and executions of said quality, quantity and continuity of health, health-care and health-care services, related to individual diagnoses, individual syndromes or individual diagnoses in individual groups of related diagnoses, being provided or to be provided to patients or individual patients in diverse and different localities, regions, states and nations to patients and individual patients in diverse and different settings, practices, localities, regions, states and nations by individual physicians or physicians in individual groups of physicians and health-care providers in diverse and different localities, regions, states and nations to patients and individual patients in diverse and different settings, practices, localities, regions, states and nations. Said system and method comprise: i) said process for server-automatically and continually guiding, assisting and adapting decision makings, judgements, determinations and executions impacting on the health, health-care and health-care services, related to individual diagnoses, individual syndromes or individual diagnoses in individual groups of related diagnoses, being provided or to be provided to patients or individual patients by individual physicians or physicians in individual groups of physicians and health-care providers and the generations and inputs of information and data on said decision makings, judgements, determinations and executions into said SQL databases and tables; ii) a process for server-automatically, repetitively and continually composing and relating individual diagnoses, individual syndromes or diagnoses in individual groups of diagnoses and related any and all categories to individual patients or patients related to said individual SQL keys in said SQL databases and tables and continually viewable and useable by and interactive with said individual patients, patients or people; iii) a process for server-automatically and repetitively selecting, retrieving and displaying adaptable and expanding compositions of said SQL relations of individual relational SQL units related to individual diagnoses or diagnoses in individual groups of related diagnoses and related differential diagnoses and related categories and individual physicians or physicians in said individual groups of physicians and health-care providers related to said individual SQL keys in said SQL databases and tables on said viewing screens of said devices to individual patients and people; iv) a process for individual physicians or physicians in individual groups of physicians repetitively generating and composing adaptable and expanding SQL relations of individual relational SQL units related to individual diagnoses or individual diagnoses in individual groups of related diagnoses and related categories and individual physicians or physicians in individual groups of physicians and health-care providers related to individual patients related to individual SQL keys in said SQL databases and tables and viewable and useable by and interactive with said individual physicians and physicians in individual groups of physicians and health-care providers; v) a process for individual physicians or physicians in individual groups of physicians to repetitively relate individual diagnoses, individual syndromes or diagnoses in individual groups of diagnoses and individual patients to individual physicians or physicians in individual groups of physicians and health-care providers related to individual SQL keys in said SQL databases and tables and viewable and useable by and interactive with said individual physicians and physicians in individual groups of physicians and health-care providers; vi) a process for server-automatically, repetitively and continually relating individual diagnoses, individual syndromes or diagnoses in individual groups of diagnoses and individual patients to individual physicians or physicians in individual groups of physicians and health-care providers related to individual SQL keys in said SQL databases and tables and continually viewable and useable by and interactive with said individual physicians and physicians in individual groups of physicians and health-care providers; vii) a process for individual physicians or physicians in individual groups of physicians to repetitively compose and relate individual diagnoses, individual syndromes or diagnoses in individual groups of diagnoses and related any and all categories to individual patients or patients related to said individual SQL keys in said SQL databases and tables viewable and useable by and interactive with said individual patients or patients; viii) a process for server-automatically and continually qualifying and regulating payments for health-care and health-care services to individual physicians and proportional payments, distributions, adjustments, debits, redistributions and readjustments of payments in and among individual adaptable and expanding compositions of adaptable accounts of individual physicians in individual groups of physicians related to individual diagnoses or individual diagnoses in individual groups of related diagnoses and related health, health-care and health-care services provided to said individual patients by said individual groups of physicians and related individual disbursements relating and corresponding to said payments in individual adaptable and expanding compositions of adaptable accounts of said individual patients in the SQL databases in and manage by a SQL server coupled to and enabled by said innovative computer programs and software in said computer server or servers viewable, manageable, adjustable and used by and interactive with said individual physicians and individual patients using said devices; and ix) a process for server-automatically, repetitively and continually expressions and displays of said adaptable and expanding individual relations of said individual unique relational SQL units in and among said SQL databases and tables in server-automatically generated and displayed interactive related electronic templates, HTML related Web pages and on interactive and related 2-dimensional and 3-dimensional, human figurines and images, graphics, charts, videos and as dynamic data, transactional data and streaming data and any combinations thereof and the like and derivatives on said viewing screens of said devices being used by said patients and physicians.

Third, farther and consequent to supra, the present invention provides a servers-computers vigilant and surveillance system and method for server-automatically, repetitively, continually, repetitively, constantly on 24/7 basis—without or with requests from said physicians and patients using said devices—and perpetually managing and monitoring, preventing, managing and warning the predispositions and risks of diseases and disorders and racial, ethnic, genetic, phenotypic and regional variations, consensuses, quality, quantity and continuity of health, health-care and health-care services, being provided and to be provided by said individual physicians, said physicians and among physicians and/or health-care providers in said individual groups of physicians and health-care providers to said individual patients and patients related to said diagnoses, syndromes or individual diagnoses in individual groups of related diagnoses, for said physicians and patients comprise: i) said process for server-automatically and continually guiding, assisting and adapting decision makings, judgements, determinations and executions impacting on the health, health-care and health-care services, related to individual diagnoses, individual syndromes or individual diagnoses in individual groups of related diagnoses, being provided or to be provided to patients or individual patients by individual physicians or physicians in individual groups of physicians and health-care providers and the generations and inputs of information and data on said decision makings, judgements, determinations and executions into said SQL databases and tables; ii) a process for individual physicians or physicians in individual groups of physicians repetitively generating and composing adaptable and expanding SQL relations of individual relational SQL units related to individual diagnoses or individual diagnoses in individual groups of related diagnoses and related categories and individual physicians or physicians in individual groups of physicians and health-care providers related to individual patients related to individual SQL keys in said SQL databases and tables; iii) a process for individual physicians or physicians in individual groups of physicians to repetitively relate individual diagnoses, individual syndromes or diagnoses in individual groups of diagnoses and individual patients to individual physicians or physicians in individual groups of physicians and health-care providers related to individual SQL keys in said SQL databases and tables and viewable and useable by and interactive with said individual physicians and physicians in individual groups of physicians and health-care providers; iv) a process for server-automatically, repetitively and continually relating individual diagnoses, individual syndromes or diagnoses in individual groups of diagnoses and individual patients to individual physicians or physicians in individual groups of physicians and health-care providers related to individual SQL keys in said SQL databases and tables and continually viewable and useable by and interactive with said individual physicians and physicians in individual groups of physicians and health-care providers; v) a process for individual physicians or physicians in individual groups of physicians to repetitively compose and relate individual diagnoses, individual syndromes or diagnoses in individual groups of diagnoses and related any and all categories to individual patients or patients related to said individual SQL keys in said SQL databases and tables viewable and useable by and interactive with said individual patients or patients; vi) a process for server-automatically, repetitively and continually composing and relating individual diagnoses, individual syndromes or diagnoses in individual groups of diagnoses and related any and all categories to individual patients or patients related to said individual SQL keys in said SQL databases and tables and continually viewable and useable by and interactive with said individual patients, patients or people; vii) a process for server-automatically and repetitively selecting, retrieving and displaying adaptable and expanding compositions of said SQL relations of individual relational SQL units related to individual diagnoses or diagnoses in individual groups of related diagnoses and related differential diagnoses and related categories and individual physicians or physicians in said individual groups of physicians and health-care providers and individual patients related to said individual SQL keys in and among said SQL databases and tables; and viii) a process for server-automatically, repetitively and continually expressing and displaying said adaptable and expanding individual relations of said individual unique relational SQL units in and among said SQL databases and tables in server-automatically generated and displayed interactive related electronic templates, HTML related Web pages and on interactive and related 2-dimensional and 3-dimensional, human figurines and images, graphics, charts, videos and as dynamic data, transactional data and streaming data and any combinations thereof and the like and derivatives on said viewing screens of said devices, enabled by said Internet Explorer and browsers and Web server devices and servers in said network or networks, being used by said patients and physicians using said devices in said settings and circumstances.

Further to supra, said system and method for server-automatically and continually managing and monitoring diseases and disorders and quality, quantity and continuity of health, health-care and health-care services, being provided and to be provided by said individual physicians and said physicians in said individual groups of physicians and health-care providers to said individual patients and patients related to said diagnoses, syndromes or individual diagnoses in individual groups of related diagnoses, for said physicians and patients, for server-automatically and repetitively expressing and displaying said individual computer-generated results and outcomes of said scans, matches, correlations, collaborations and comparisons of said information and data in said processor units and memories for server-automatically and continually managing and monitoring diseases and disorders and quality, quantity and continuity of health, health-care and health-care services, being provided and to be provided by physicians, said individual physicians and among physicians and health-care providers in said individual groups of physicians and health-care providers to said individual patients and patients related to said diagnoses, syndromes or individual diagnoses or individual syndromes in individual groups of related diagnoses and/or syndromes, for and interactive with and said physicians and patients on said viewing screens of said devices comprise: i) a process for server-automatically, instantly and repetitively scanning, matching correlating, collaborating and comparing individual words and terms in any or all said categories in individual inputs or queries repetitively generated and submitted to said processor units and memories by said individual physicians, physicians or said physicians in individual groups of physicians and health-care providers or said individual patients using said devices, with said individual unique relational SQL units in said individual relations of said individual unique relational SQL units in and among said SQL databases and tables, or vice versa; and, consequently, ii) a process for said individual physicians or physicians in individual groups of physicians to repetitively relate individual patients or patients related to individual diagnoses, individual syndromes or diagnoses in individual groups of diagnoses and related said categories related to individual SQL keys to individual SQL keys related to individual physicians, physicians, health-care providers, or physicians in individual groups of physicians and health-care providers in said SQL databases and tables using said devices and said relations of physicians, patients and diagnoses related to said individual SQL keys are server-automatically, repetitively and continually retrieved and displayed on said viewing screens of said physicians and patients who viewed, interactive with, use and select said interactive displays on said viewing screens of said devices; iii) a process for server-automatically, instantly and repetitively scanning, matching, correlating, collaborating and comparing individual words and terms in any or all said categories related to individual diagnoses and individual patients in individual inputs repetitively generated and submitted to said processor units and memories by said individual physicians, physicians or said physicians in individual groups of physicians and health-care providers or individual patients using said devices, with said individual unique relational SQL units in said individual relations of said individual unique relational SQL units in and among said SQL databases and tables, or vice versa; iv) a process for server-automatically, instantly and repetitively scanning, matching, correlating, collaborating and comparing individual words and terms in any or all said categories related to individual diagnoses, individual patients and individual physicians, physicians or said physicians in individual groups of physicians and health-care providers in individual inputs repetitively generated and submitted to said processor units and memories by said individual physicians or said physicians and health-care providers or said individual patients using said devices, with said individual unique relational SQL units in said individual relations of said individual unique relational SQL units in and among said SQL databases and tables, or vice versa; and, consequently, v) a process for server-automatically, repetitively and continually relating individual diagnoses, individual syndromes or diagnoses in individual groups of diagnoses and related individual patients to individual physicians, physicians, health-care providers or physicians in individual groups of physicians and health-care providers related to said diagnoses related to individual SQL keys in said SQL databases and tables which are server-automatically, repetitively and continually retrieved and displayed on said viewing screens of said physicians and patients who viewed, interactive with, use and select said interactive displays on said viewing screens, vi) a process for individual physicians, individual health-care providers or physicians and health-care providers in individual groups of physicians and health-care providers to repetitively relate and compose individual diagnoses, individual syndromes or diagnoses and/or syndromes in individual groups of related diagnoses and/or syndromes and related individual patients or patients to individual physicians or physicians and health-care providers in individual groups of physicians and health-care providers related to said individual diagnoses, individual syndromes or diagnoses and/or syndromes in individual groups of related diagnoses and/or syndromes related to individual SQL keys in and among said SQL databases and tables which are continually retrievable, viewable and useable by and interactive with said individual physicians, health-care providers and patients who viewed, interactive with, use and select said interactive displays in interactive related electronic templates, HTML related Web pages and on interactive and related 2-dimensional and 3-dimensional, human figurines and images, graphics, charts, videos and as dynamic data, transactional data and streaming data and any combinations thereof and the like and derivatives on said viewing screens of said devices being used by said patients and physicians in diverse and different settings, practices, localities, regions, states and nations.

The present invention provides said system and method for server-automatically, repetitively, continually, constantly on 24/7 basis, perpetually and repetitively—without or with requests from said physicians and patients using said devices to access said system in said network or networks of computer servers and devices—selecting, retrieving, expressing and displaying adaptable and expanding compositions of said SQL databases and tables, individual groups of individual unique relational SQL units and relations of individual relational SQL units, related to individual diagnoses or diagnoses in individual groups of related diagnoses and related differential diagnoses and related categories and individual physicians or physicians in said individual groups of physicians and health-care providers and individual patients in and among said SQL databases and tables comprises: i) a process for said individual physicians or physicians in individual groups of physicians to repetitively generate, relate and compile individual patients or patients related to said words and terms and related any or all said categories related to individual diagnoses, individual syndromes or diagnoses in individual groups of related diagnoses and related to individual SQL keys in and among said SQL databases and tables to individual SQL keys related to individual physicians, physicians, health-care providers or physicians in individual groups of physicians and health-care providers in and among said SQL databases and tables using said viewing screens in said devices; ii) a process for server-automatically, repetitively and continually expanding said relations of said physicians, patients, words and terms, categories and diagnoses, syndromes or diagnoses in individual groups of diagnoses related to said individual SQL keys in and among said SQL databases and tables; and iii) a process for server-automatically and continually retrieving and displaying adaptable and expanding compositions of said SQL relations of individual relational SQL units in server-automatically generated and displayed interactive related electronic templates, HTML related Web pages and on interactive and related 2-dimensional and 3-dimensional, human figurines and images, graphics, charts, videos and as dynamic data, transactional data and streaming data and any combinations thereof and the like and derivatives on said viewing screens of said devices, enabled by said Internet Explorer and browsers and Web server devices and servers in said network or networks, being used by said patients and physicians using said devices in diverse and different settings, practices, localities, regions, states and nations.

Consequent and related to all supra and refined and advanced herein to those taught in said pending patent applications, the present invention provides a system and method for computer server-automatically, repetitively, constantly and continually qualifying and regulating payments for health-care and health-care services to individual physicians and proportional payments, distributions, adjustments, debits, redistributions and readjustments of payments in and among individual adaptable and expanding compositions of adaptable accounts of individual patients and individual physicians in individual groups of physicians related to individual diagnoses or individual diagnoses in individual groups of related diagnoses and related health, health-care and health-care services provided to said individual patients by said individual physicians or individual groups of physicians and related individual disbursements relating and corresponding to said payments in individual adaptable and expanding compositions of adaptable accounts of said individual patients in the SQL databases and tables in and manage by a SQL server coupled to and enabled by said innovative computer programs and software in said computer server or servers.

Further to the teaching of said pending patent applications, in particular, Ser. No. 12/592,714 entitled the Healthcare Exchange IV filed Dec. 2, 2009, as server-automatically, repetitively, continually, constantly on 24/7 basis, perpetually and repetitively managing and monitoring—and guiding and assisting—said diseases and disorders and quality, quantity and continuity of health, health-care and health-care services, the speed and accuracy of achieving or attaining said preliminary and individual definitive diagnoses by said individual physicians or said physicians in individual groups of physicians and health-care providers and related said quality, quantity and continuity of health, health-care and health-care services being achieved and delivered by said individual physicians or said physicians in individual groups of physicians and health-care providers can and will server-automatically effect, regulate and manage said compensations system. This is one of the most vital component of the most efficient and optimal health-care system provided by the present invention.

Said system and method for compensations and disbursements in said individual adaptable and expanding compositions of adaptable accounts comprise: i) a process for generating, relating and compiling individual words, terms, phrases, sentences, texts, synonyms, acronyms, numbers, data, graphics and any combinations thereof and related adjectives and variables henceforth words and terms in any and all said categories representing information and data on health, health-care and health-care services on or related to individual diagnoses, individual syndromes or individual diagnoses in individual groups of related diagnoses of diseases and disorders and related individual prices, monetary values or costs related to said health-care and health-care services and related to individual physicians and individual SQL keys and compiled in said SQL databases and tables in and manage by said SQL Server coupled to said processor units, memories and said innovative computer programs and software; ii) a process for generating, relating and compiling individual unique relational SQL units comprising related said words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to said diagnoses and/or syndromes related to individual SQL keys in said SQL databases and tables; iii) a process for generating, relating and compiling adaptable and expanding individual relations of said individual unique relational SQL units in and among said SQL databases and tables in and manage by said SQL Server, according to said innovative computer programs and software; iv) a process for repetitively creating and generating related words and terms in said categories related to individual diagnoses using said interactive electronic templates viewable and interactive with said physicians and patients on said viewing screens in said devices for accessing said computer servers; v) said process for server-automatically and continually guiding, assisting and adapting decision makings, judgements, determinations and executions impacting on the health, health-care and health-care services, related to individual diagnoses, individual syndromes or individual diagnoses in individual groups of related diagnoses, being provided or to be provided to patients or individual patients by individual physicians or physicians in individual groups of physicians and health-care providers and the generations and inputs of information and data on said decision makings, judgements, determinations and executions into said SQL databases and tables; vi) said process for server-automatically, repetitively and continually patterning and standardizing said decision makings, judgements, determinations and executions on the productions and executions of said quality, quantity and continuity of health, health-care and health-care services, related to individual diagnoses, individual syndromes or individual diagnoses in individual groups of related diagnoses, being provided or to be provided to patients or individual patients by individual physicians or physicians in individual groups of physicians and health-care providers; vii) said process for server-automatically and continually managing and monitoring diseases and disorders and quality, quantity and continuity of health, health-care and health-care services, being provided and to be provided by said individual physicians and said physicians in said individual groups of physicians and health-care providers to said individual patients and patients related to said diagnoses, syndromes or individual diagnoses in individual groups of related diagnoses, for said physicians and patients; viii) a process for repetitively generating, modifying and editing said words and terms and information and data on and related to said health, health-care and health-care services related to individual diagnoses related to individual patients continually and perpetually generated and submitted to said process units, memories and SQL databases and tables by said individual physicians, physicians, or physicians and health-care related to individual diagnoses or diagnoses in individual groups of related diagnoses; ix) a process for server-automatically and repetitively scanning and matching said individual words and terms with same, equivalent or similar individual words, and terms, compiled and related to individual prices, monetary values or costs in said SQL databases and tables, in said processor units and memories and inputting said scanned and matched words and terms from said processor units and memories into, related to said individual prices, monetary values or costs and relate and compiled in said SQL databases and tables; x) a process for server-automatically adapting and expanding compositions of said scanned and matched words and terms related to said scanned and matched words and terms and individual prices, monetary values or costs in related said adaptable and expanding compositions of accounts of said individual physicians and individual patients related and compiled in said SQL databases and tables; xi) a process for computer-automatically and repetitively generating and managing the relations of said adaptable and expanding individual compositions of said scanned and matched said words and terms and related computer-automatically generated, modified, edited and managed said adaptable and expanding relational individual compositions of adaptable and expanding accounts of said individual physicians and individual physicians in individual groups of physicians related to individual patients and relating and corresponding individual disbursements relating and corresponding to said payments in said individual adaptable and expanding compositions of adaptable accounts of said individual patients in said SQL databases and tables in and manage by said SQL Server; xii) a process for computer-automatically and repetitively adapting, compiling and expanding said relational compositions of computer-generated scanned and matched said individual words and terms and related payments to individual physicians and proportional payments, distributions, adjustments, debits, redistributions and readjustments of payments in and among individual adaptable and expanding compositions of adaptable accounts of said individual physicians in individual groups of physicians related to individual diagnoses or individual diagnoses in individual groups of related diagnoses and related health-care and health-care services provided to said individual patients and related individual disbursements relating and corresponding to said payments in individual adaptable and expanding compositions of adaptable accounts of said individual patients in the SQL databases and tables; xiii) a process for accounting and tallies of adaptable revenues and earnings of said individual physicians and said individual physicians in individual groups of physicians comprising said payments to individual physicians and said proportional payments, distributions, adjustments, debits, redistributions and readjustments of payments in and among said individual adaptable and expanding compositions of adaptable accounts of individual physicians in individual groups of physicians, and said related individual disbursements relating and corresponding to said payments and related refunds or reimbursements relating or corresponding to deductions from said payments in said individual adaptable and expanding compositions of adaptable accounts of said individual patients according to the instructions and commands of said innovative computer programs and software for repetitively paying, proportionally paying, distributing, adjusting, debiting, readjusting and redistributing said proportional payments, calculating, tallying and accounting said revenues, earnings, disbursements, refunds, reimbursements in and among said individual adaptable and expanding compositions of adaptable accounts in said databases and tables; and xiv) a process for repetitively retrieving and displaying on said viewing screens, in server-automatically generated and displayed interactive related electronic templates, HTML related Web pages and on interactive and related 2-dimensional and 3-dimensional, human figurines and images, graphics, charts, videos and as dynamic data, transactional data and streaming data and any combinations thereof and the like and derivatives, said adaptable and expanding relational compositions of said computer-automatically scanned and matched words and terms related to said individual prices, monetary values or costs in computer-automatically generated, modified, edited and managed adaptable and expanding relational individual compositions of said adaptable and expanding accounts on revenues and earnings comprising said adaptable payments and proportional payments, distributions, adjustments, debits, readjustments and redistributions of proportional payments in and among said individual adaptable and expanding relational compositions of adaptable accounts of said individual physicians and said individual physicians in individual groups of physicians and related and corresponding expenses, deductions and disbursements relating or corresponding to said payments, and refunds or reimbursements relating or corresponding to deductions from said payments in said adaptable and expanding compositions of accounts of said individual patients in said SQL databases and tables and said innovative computer programs and software coupled to said processor units and memories, upon the Web browser-generate requests from said devices to said Web server in said computer servers in said network or networks, by said individual physicians and individual patients using said devices for accessing said computer servers in said network or networks.

One of the numerous possible representations of said server-automatically approved and regulated and compensations system of payments to individual physicians and proportional payments, distributions, adjustments, debits, redistributions and readjustments of payments in and among individual adaptable and expanding compositions of adaptable accounts of individual patients and individual physicians in individual groups of physicians related to individual diagnoses or individual diagnoses in individual groups of related diagnoses and related health, health-care and health-care services based on the results and outcomes of said system and method for guiding, assisting and adapting decision makings, judgements, determinations and executions, said patterning and standardizing said decision makings, judgements, determinations and executions and said quality, quantity and continuity of health, health-care and health-care services being achieved and delivered by said individual physicians or said physicians in individual groups of physicians and health-care providers.

Said consequent and related to all supra comprising said system and methods for compensations are enabled and effected by said system and method for server-automatically and server-automatically, repetitively, continually, constantly on 24/7 basis and perpetually guiding, assisting and adapting said decision makings, judgements, determinations and executions, for server-automatically, repetitively and continually patterning, standardizing and tuning said decision makings, judgements, determinations and executions, and for server-automatically, repetitively, continually, constantly on 24/7 basis, repetitively—without or with requests from said physicians and patients using said devices to access said system in said network or networks of computer servers and devices—and perpetually managing and monitoring diseases and disorders and quality, quantity and continuity of said health, health-care and health-care services, for said physicians and patients in diverse and different localities, regions, states and nations to patients and individual patients.

Said consequent and related to all supra encompass all results and outcomes and derivatives of said system and methods. In other words, briefly, one of the preferred embodiments of the present invention provides for various permutations and productions of any and all relations of individual prices, monetary values or costs and related any and all words and terms and relations and combinations of said words and terms representing various relations and combinations of health-care and health-care services effected and rendered by said individual physicians, individual health-care providers individual physicians, individual health-care providers in individual groups of individual physicians, individual health-care providers related to individual diagnoses or individual diagnoses in individual groups of related diagnoses and/or syndromes and related said individual payments and proportional payments, distributions, adjustments, debits, redistributions and readjustments of payments and related individual disbursements in said individual adaptable and expanding compositions of adaptable accounts in said SQL databases and tables in and manage by said SQL server according to the innovative computer programs and software and computer server-executable algorithms for achieving the goals and objectives of the present invention.

To achieve and fulfill said objectives and goals, the present invention provides said operating and functioning computer servers comprising said central processing units (CPU) or said processor units and memories, server operating systems, a Windows Server, Unix, Apache, VMware, said SQL Server, a Visual Studio and .Net, JavaScript, AJAX, HTML, XHTML, a Microsoft IIS, a Web server, computer scripting languages, PHP and the innovative computer programs and software for communicating with and commanding and instructing and coupled to said processor units, memories, SQL Server, said Web server, Web browsers, routers and modems, and teleconference-enabling, stream media-enabling and dynamic data-enabling programs and software programs and software in a network or networks of said computer servers and devices and said devices comprising computers, laptops, wireless, mobile communication devices including smartphones possessing processor units, memories, keyboards for repetitively viewing, managing, expanding and inputting said information and data and for repetitively generating, manipulating, relating, updating, expanding and controlling said adaptable and expandable information and data in said SQL databases and tables, application software and said viewing screens including touch-sensitive or touch screens enabled by Web browsers, routers and modems for accessing said computer servers and application software for accessing applications and said system in said computer server or servers henceforth devices for accessing said computer servers in a network or networks of said devices and computer servers by said devices in said extensive, national and global network or networks of said devices and computer servers.

The present invention created and applies said innovative computer programs and software for i) commanding, instructing, enabling and effecting said computer server or servers to repetitively create, effect and enable said system and processes infra and for commanding, instructing, enabling and effecting said computer server or servers to repetitively and continually creating, generating, apply, adapting, expanding and improving the results and outcomes in said system and of processes infra; ii) providing, commanding and instructing computer server or servers to execute and apply said computer server-executable algorithms for creating said system and the methods supra and infra in said processor units and memories coupled to said SQL Server; iii) creating, generating and displaying a plurality of individual interactive and adaptable related electronic templates, a plurality of interactive pop-up and/or drop-down lists and/or menus of interactive words and terms, and word and term headers or headings comprising information and data on and related to said diagnoses on diseases, disorders, health, health-care and health-care services and related categories of chief complaints, signs and symptoms, reviews of systems, physical examinations or findings, laboratory results, anatomical locations, anatomical sites and organ systems, diagnoses, syndromes, related diagnoses and/or syndromes, differential diagnoses, genetics, family histories, travel histories, treatments, surgeries, procedures, assessments and plans, recommendations, advices, referrals and follow-ups and related adjectives and variables henceforth information and data used and being used by physicians of about 85 medical and surgical specialties and practices, and said SQL databases and tables, individual relational SQL units and relations of said individual relational SQL units in and among said SQL databases and tables; iv) managing related and related adjectives and variables in all categories related to individual diagnoses used and use by physicians of all and diverse medical and surgical practices or specialties for and in the communications of said information and data among and between physicians and between and among physicians and patients and are integral components of electronic information and data on health, health-care and health-care-services in individual electronic medical records on or relating to said individual patients, generated and submitted to said processor units and memories and SQL Server comprising SQL databases and tables of said related words and terms in all categories related to individual diagnoses without redundant duplicates, repeats or doubles in said individual categories related to said individual diagnoses related to individual SQL keys in said SQL databases and tables; v) managing related words and terms in all categories related to individual diagnoses generated and submitted to said processor units and memories and SQL Server comprising SQL databases and tables of said related words and terms in all categories related to individual diagnoses without redundant duplicates, repeats or doubles in said individual categories related to said individual diagnoses in individual groups of related diagnoses and differential diagnoses related to individual SQL keys in said SQL databases and tables; vi) managing said individual words and terms representing information and data on health, health-care and health-care services and related said individual diagnoses or said individual diagnoses in individual groups of related diagnoses continually and perpetually generated and submitted by said physicians and between and among said individual physicians in individual groups of physicians and adaptable and expanding editions of versions of said information and data on individual diagnoses or individual diagnoses in individual groups of related diagnoses of diseases and disorders and editions of related versions of information and data on related health-care and health-care services and editions of related versions of compositions of accounts and successive editions of related versions of information and data on individual diagnoses or individual diagnoses in individual groups of related diagnoses of diseases and disorders and successive editions of related versions of information and data on health, health-care and health-care services relating to said versions of diagnoses and successive editions of compositions of accounts by physicians and said computer, computer server or servers and manage by said SQL server; vii) repetitively scanning and checking for redundant duplicates or repeats, doubles in individual physicians' submissions related to individual diagnoses, individual syndromes or diagnoses in individual groups of diagnoses and related said categories in said processor units and memories and outputting said scans and matches to, related to individual SQL keys and compiled in said SQL databases and tables, for removing said redundant duplicates or repeats, doubles from said individual unique relational SQL units in said SQL databases and tables, for not inserting said redundant duplicates or repeats, doubles into said individual unique relational SQL units, for creating, generating, adapting and maintaining for repetitively creating, generating, relating, compiling and applying said SQL databases and tables, relational SQL units and relations of said relational SQL units in and among said SQL databases and tables; viii) creating, generating, expanding and improving SQL databases and tables comprising relational SQL keys related to said words and terms, said headers and categories, physicians and patients in individual relational SQL units in said SQL databases and tables; ix) creating, generating, adapting, relating, compiling and maintaining adaptable and expanding SQL relations comprising said individual unique relational SQL units in and among said SQL databases and tables; x) scanning and matching said individual words and terms in said processor units and memories and inputting into, relating said scanned and matched said individual words and terms and individual prices, monetary values or costs and compiled in said SQL databases and tables; xi) generating said adaptable and expanding compositions of said scanned and matched words and terms related to said individual prices, monetary values or costs in related said adaptable and expanding compositions of said accounts in said SQL databases and tables ; xii) repetitively displaying, manipulating, modifying and editing said adaptable and expanding relational compositions of said individual scanned and matched words and terms and related individual prices, monetary values or costs in said SQL databases and tables by said individual physicians and by and among said individual physicians in individual groups of physicians and individual patients; xiii) repetitively enabling and effecting computer-automatically and repetitively adjusting said relations of said scanned and matched words and terms words and terms and related individual prices, monetary values or costs for calculating, accounting and adjusting said payments to individual physicians and said proportional payments, distributions, adjustments, redistributions and readjustments of payments and debits in and among individual adaptable and expanding compositions of accounts of said individual physicians in individual groups of physicians; and related individual adaptable and expanding compositions of accounts of said individual patients comprising disbursements, relating and corresponding to said payments, and refunds or reimbursements relating or corresponding to deductions from said payments in said individual patients' accounts; and for repetitively composing said adaptable and expanding related accounts in said processor units and memories and outputted to said SQL databases and tables; xiv) repetitively enabling and effecting computer-automatically and repetitively generating relations of said adaptable and expanding compositions on said relational words and terms and said adaptable and expanding compositions of accounts on said payments, proportional payments, distributions and redistributions, adjustments and readjustments of payments in and among said individual adaptable and expanding accounts of said individual physicians relating and corresponding to expenses, deductions, disbursements, refunds and reimbursements in said adaptable and expanding compositions of accounts of said individual patients in said SQL databases and tables in and manage by said SQL Server; xv) repetitively enabling and effecting computer-automatically and repetitively modifying, editing, relations of said adaptable and expanding compositions of said words and terms and said adaptable and expanding compositions of said accounts in said SQL databases and tables; xvi) repetitively enabling and effecting computer-automatically and repetitively generating adapting and expanding said SQL units, SQL relations of said SQL units in and among said SQL databases and tables; xvii) server-automatically and continually guiding, assisting and adapting decision makings, judgements, determinations and executions of said individual physicians and among physicians in said individual groups of physicians and individual patients impacting on the health, health-care and health-care services related to individual diagnoses, individual syndromes or individual diagnoses in individual groups of related diagnoses being provided or to be provided to patients or individual patients by individual physicians or physicians in individual groups of physicians and health-care providers and on the inputs of said decision makings, judgements, determinations and executions into said SQL databases and tables; xviii) server-automatically and repetitively and continually patterning and standardizing said decision makings, judgements, determinations and executions on the productions and executions of said quality, quantity and continuity of health, health-care and health-care services, related to individual diagnoses, individual syndromes or individual diagnoses in individual groups of related diagnoses, being provided or to be provided to patients or individual patients by individual physicians or physicians in individual groups of physicians and health-care providers; xix) server-automatically and continually managing and monitoring diseases and disorders and quality, quantity and continuity of health, health-care and health-care services, being provided and to be provided by physicians, said individual physicians, physicians in said individual groups of physicians and health-care providers to said individual patients and patients related to said diagnoses or individual diagnoses in individual groups of related diagnoses; xx) server-automatically and repetitively expressing and displaying said individual computer-generated results and outcomes of said scans, matches, correlations, collaborations and comparisons of said information and data in said processor units and memories for server-automatically and continually managing and monitoring diseases and disorders and quality, quantity and continuity of health, health-care and health-care services, being provided and to be provided by physicians, said individual physicians, physicians in said individual groups of physicians and health-care providers to said individual patients and patients related to said diagnoses or individual diagnoses in individual groups of related diagnoses, for and interactive with and said physicians and patients on said viewing screens of said devices; xxi) server-automatically and continually qualifying and regulating payments for health-care and health-care services to individual physicians and proportional payments, distributions, adjustments, debits, redistributions and readjustments of payments in and among individual adaptable and expanding compositions of adaptable accounts of individual physicians in individual groups of physicians related to individual diagnoses or individual diagnoses in individual groups of related diagnoses and related health, health-care and health-care services provided to said individual patients by said individual groups of physicians and related individual disbursements relating and corresponding to said payments in individual adaptable and expanding compositions of adaptable accounts of said individual patients in the SQL databases and tables in and manage by a SQL server coupled to and enabled by said innovative computer programs and software in said computer server or servers viewable, manageable, adjustable and used by and interactive with said individual physicians and individual patients using said devices; xxii) server-automatically, repetitively and continually expressions and displays of said adaptable and expanding individual relations of said individual unique relational SQL units in and among said SQL databases and tables in server-automatically generated and displayed interactive related electronic templates, HTML related Web pages and on interactive and related 2-dimensional and 3-dimensional, human figurines and images, graphics, charts, videos and as dynamic data, transactional data and streaming data and any combinations thereof and the like and derivatives on said viewing screens of said devices, enabled by said Internet Explorer and browsers and Web server devices and servers in said network or networks, being used by said patients and physicians; and xxiii) server-automatically, repetitively and continually enabling and effecting the repetitive retrievals and uses of said relations of said adaptable and expanding compositions of said scanned and matched words and terms related to said individual prices, monetary values or costs in related said adaptable and expanding compositions of said accounts of said individual physicians and individual patients as revenues and earnings of said individual physicians and said individual physicians in individual groups of physicians representing said adaptable payments and proportional payments, distributions, adjustments, debits, readjustments and redistributions of proportional payments in and among said individual adaptable and expanding compositions of adaptable accounts of said individual physicians in individual groups of physicians and related and corresponding expenses, deductions, disbursements relating or corresponding to said payments, and refunds and reimbursements in said adaptable and expanding compositions of accounts of said individual patients in said SQL databases and tables on server-automatically generated and displayed interactive related electronic templates, HTML related Web pages and on interactive and related 2-dimensional and 3-dimensional, human figurines and images, graphics, charts, videos and as dynamic data, transactional data and streaming data and any combinations thereof and the like and derivatives on said viewing screens, by individual requests from said devices enabled by said Web browsers and Web server, by said individual physicians and individual patients.

Further to supra, said innovative computer programs and software for generating and applying stored procedures and SQL in said SQL Server, coupled to said innovative computer programs and software and said processor units and memories and said computer scripting language, created by said innovative computer programs and software for configuring, creating, generating, expanding and adapting said SQL databases and tables, generating and creating individual unique relational SQL units and adaptable and expanding relations individual unique relational SQL units in and among said SQL databases and tables.

The present invention enabled and effected by said innovative computer programs and software coupled to said SQL Server, processor units and memories provides said SQL databases and tables comprise i) a process for generating and compiling individual words, terms, phrases, sentences, texts, synonyms, acronyms, numbers, data, graphics and any combinations thereof and related adjectives and variables henceforth words and terms in any and all said categories representing information and data on health, health-care and health-care services on or related to individual diagnoses, individual syndromes or individual diagnoses in individual groups of related diagnoses of diseases and disorders and related individual prices, monetary values or costs in said processor units and memories and related to individual physicians and individual SQL keys and compiled in said SQL databases and tables in and manage by said SQL Server coupled to said processor units, memories and said innovative computer programs and software; ii) adaptable and expanding compositions of said relational words and terms related to said individual diagnoses or individual diagnoses in individual groups related diagnoses, health, health-care and health-care services and individual physicians related to individual SQL keys in said SQL databases and tables; iii) adaptable and expanding compositions of said scanned and matched words and terms related to said scanned and matched words and terms and individual prices, monetary values or costs in related said adaptable and expanding compositions of accounts of said individual physicians and individual patients related and compiled in said SQL databases and tables in and manage by said SQL server; iv) individual unique relational SQL units comprising related said words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to individual SQL keys in said SQL databases and tables in and manage by said SQL Server; v) adaptable and expanding individual relations of said individual unique relational SQL units in and among said SQL databases and tables in and manage by said SQL Server, according to said innovative computer programs and software; and vi) adaptable and expanding accounting and tallies of adaptable revenues and earnings of said individual physicians and said individual physicians in individual groups of physicians comprising said payments to individual physicians and said proportional payments, distributions, adjustments, debits, redistributions and readjustments of payments in and among said individual adaptable and expanding compositions of adaptable accounts of individual physicians in individual groups of physicians, and said related individual disbursements relating and corresponding to said payments and related refunds or reimbursements relating or corresponding to deductions from said payments in said individual adaptable and expanding compositions of adaptable accounts of said individual patients according to the instructions and commands of said innovative computer programs and software for repetitively paying, proportionally paying, distributing, adjusting, debiting, readjusting and redistributing said proportional payments, calculating, tallying and accounting said revenues, earnings, disbursements, refunds, reimbursements in and among said individual adaptable and expanding compositions of adaptable accounts in said databases and tables.

The present invention also provides and applies a plurality of computer server-executable algorithms for creating said system and the methods supra in said processor units, memories and said SQL Server, according to said innovative computer programs and software, comprise at least: i) a computer server-executable algorithm for server-automatically generating individual unique relational SQL units comprising related said words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to individual SQL keys in said SQL databases and tables in and manage by said SQL Server; ii) a computer server-executable algorithm for server-automatically, instantly and repetitively scanning, matching correlating, collaborating and comparing individual words and terms in any or all said categories in individual inputs or queries repetitively generated and submitted to said processor units and memories by said individual physicians, physicians or said physicians in individual groups of physicians and health-care providers or said individual patients using said devices, with said individual unique relational SQL units in said individual relations of said individual unique relational SQL units in and among said SQL databases and tables, or vice versa; iii) a computer server-executable algorithm for server-automatically, instantly and repetitively scanning, matching correlating, collaborating and comparing individual words and terms in any or all said categories related to individual diagnoses and individual patients in individual inputs or queries repetitively generated and submitted to said processor units and memories by said individual physicians, physicians or said physicians in individual groups of physicians and health-care providers or individual patients using said devices, with said individual unique relational SQL units in said individual relations of said individual unique relational SQL units in and among said SQL databases and tables, or vice versa; iv) a computer server-executable algorithm for server-automatically, instantly and repetitively scanning, matching correlating, collaborating and comparing individual words and terms in any or all said categories related to individual diagnoses, individual patients and individual physicians, physicians or said physicians in individual groups of physicians and health-care providers in individual inputs or queries repetitively generated and submitted to said processor units and memories by said individual physicians or said physicians and health-care providers or said individual patients using said devices, with said individual unique relational SQL units in said individual relations of said individual unique relational SQL units in and among said SQL databases and tables, or vice versa; v) a computer server-executable algorithm for repetitively scanning and checking for redundant duplicates or repeats, doubles in individual physicians' submissions related to individual diagnoses, individual syndromes or diagnoses in individual groups of diagnoses and related said categories in said processor units and memories and outputting said scans and matches to, related to individual SQL keys and compiled in said SQL databases and tables, for removing said redundant duplicates or repeats, doubles from said individual unique relational SQL units in said SQL databases and table, for not inserting said redundant duplicates or repeats, doubles into said individual unique relational SQL units; vi) a computer server-executable algorithm for server-automatically creating and repetitively generating and expanding individual unique relational SQL units comprising related said words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to individual SQL keys in said SQL databases and tables in and manage by said SQL Server; vii) a computer server-executable algorithm for server-automatically creating and repetitively generating and expanding adaptable and expanding individual relations of said individual unique relational SQL units in and among said SQL databases and tables in and manage by said SQL Server; viii) a computer server-executable algorithm for server-automatically and repetitively and continually patterning and standardizing said decision makings, judgements, determinations and executions on the productions and executions of said quality, quantity and continuity of health, health-care and health-care services, related to individual diagnoses, individual syndromes or individual diagnoses in individual groups of related diagnoses, being provided or to be provided to patients or individual patients by individual physicians or physicians in individual groups of physicians and health-care providers; ix) a computer server-executable algorithm for server-automatically identifying, determining and displaying and warning of individual deficiencies, inconsistencies, faults and misses in said decision makings, judgements, determinations and executions of said health, health-care and health-care services related to any or all categories and related definitive or preliminary diagnoses represented by individual deficiencies, inconsistencies, faults and misses in said individual selections and keyboarded words and terms in said templates on said viewing screens referencing to and scanning, matching, correlating, collaborating and comparing with the pooled and compiled decision makings, judgements, determinations and executions on said health, health-care and health-care services related to individual diagnoses, individual syndromes or individual diagnoses in individual groups of related individual diagnoses or individual syndromes related to physicians related to SQL keys in said adaptable and expanding individual relations of said individual unique relational SQL units in and among said SQL databases and tables; x) a computer server-executable algorithm for server-automatically and continually guiding, assisting and adapting decision makings, judgements, determinations and executions of said individual physicians and among physicians in said individual groups of physicians and individual patients impacting on the health, health-care and health-care services related to individual diagnoses, individual syndromes or individual diagnoses in individual groups of related diagnoses being provided or to be provided to patients or individual patients by individual physicians or physicians in individual groups of physicians and health-care providers and on the inputs of said decision makings, judgements, determinations and executions into said SQL databases and tables; xi) a computer server-executable algorithm for server-automatically and continually managing and monitoring diseases and disorders and quality, quantity and continuity of health, health-care and health-care services, being provided and to be provided by physicians, said individual physicians, physicians in said individual groups of physicians and health-care providers to said individual patients and patients related to said diagnoses or individual diagnoses in individual groups of related diagnoses; xii) a computer server-executable algorithm for server-automatically, instantly and repetitively qualifying, regulating, generating, tallying and accounting individual payments for health-care and health-care services to individual physicians or health-care providers and proportional payments, distributions, adjustments, debits, redistributions and readjustments of payments in and among individual adaptable and expanding compositions of adaptable accounts of individual physicians in individual groups of physicians and health-care providers related to individual diagnoses or individual diagnoses in individual groups of related diagnoses and related health, health-care and health-care services in said categories provided to said individual patients by said individual groups of physicians and related individual disbursements relating and corresponding to said payments in individual adaptable and expanding compositions of adaptable accounts of said individual patients in the SQL databases and tables in and manage by a SQL server coupled to and enabled by said innovative computer programs and software in said computer server or servers viewable, manageable, adjustable and used by and interactive with said individual physicians and individual patients using said devices; and xiii) computer server-executable algorithmic relations or links of said computer server-executable algorithms.

It is the objective and goal of the present invention, using one of said algorithms for for enabling and effecting, by said innovative computer programs and software coupled to said SQL Server comprising said SQL databases and tables, processor units and memories, to provide the server-creations of individual unique relational SQL units comprising related said words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to individual SQL keys in said SQL databases and tables in and manage by said SQL Server. Further to supra, according to said innovative computer programs and software, redundant duplicates or repeats, doubles in individual physicians' submissions related to individual diagnoses, individual syndromes or diagnoses in individual groups of diagnoses and related said categories are scanned, checked and removed in said processor units and memories and outputting said scans and matches to, related to individual SQL keys and compiled in said SQL databases and tables. In other words, said individual unique relational SQL units in said SQL databases and tables comprise no redundant duplicates or repeats, doubles as redundant duplicates or repeats, doubles which are server-automatically removed and not inserted into said individual unique relational SQL units.

The present invention provides a method for server-automatically creating and generating individual unique relational SQL units comprising related said words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to individual SQL keys in said SQL databases and tables in and manage by said SQL Server according to said innovative computer programs and software by enabling and effecting: i) a process for creating and generating individual electronic files comprising said words and terms in any and all said categories or headings related to individual diagnoses, syndromes or individual diagnoses and/or syndromes in individual groups of related diagnoses and/or syndromes in all medical and surgical specialties, which are found in numerous medical dictionaries such as, but not limited to, Stedman's Medical Dictionary, medical and surgical text books, journals, publications, literature and encyclopedias in said all medical and surgical specialties generated by physicians including the present patent applicant; and by ii) a process for repetitively pointing with mice and/or fingers, clicking and selecting said interactive words and terms in any or all categories related to individual diagnoses in said related templates on said viewing screens by said physicians or patients using said devices; iii) a process for keyboarding words and terms in any or all categories related to individual diagnoses into said related templates by said physicians or patients using said devices; iv) a process for repetitively creating and generating said words and terms in said categories related to individual diagnoses v) a process for server-automatically, instantly and repetitively scanning, matching correlating, collaborating and comparing said selections, keyboarded and submitted words and terms with same, similar, synonymous or equivalent words and terms in any and all categories related to individual diagnoses in said adaptable and expanding individual relations of said individual unique relational SQL units in and among said SQL databases and tables in and manage by said SQL Server in said processor units and memories from which, consequently, outputting said scanned words and terms in all categories comprising no redundant duplicates, repeats or doubles in said categories related to individual diagnoses into, related to individual SQL keys compiled in said SQL databases and tables in and manage by said SQL Server; and vi) a process for server-automatically, instantly and repetitively scanning, matching correlating, collaborating and comparing said selections, keyboarded and submitted words and terms with same, similar, synonymous or equivalent words and terms in any and all categories related to individual diagnoses in said adaptable and expanding individual relations of said individual unique relational SQL units in and among said SQL databases and tables in and manage by said SQL Server in said processor units and memories from which, consequently, for removing said redundant duplicates or repeats, doubles from said individual unique relational SQL units in said SQL databases and tables or for not inserting said redundant duplicates or repeats, doubles into said individual unique relational SQL units, for creating, generating, adapting and maintaining relational SQL units in said SQL databases and tables in and manage by said SQL Server.

The present invention achieves the objectives and goals of the present invention by using one of said algorithms for enabling and effecting according to said innovative computer programs and software coupled to said SQL Server comprising said SQL databases and tables, processor units and memories, created and applies said individual unique relational SQL units comprising related said words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to individual SQL keys in said SQL databases and tables in and manage by said SQL Server comprises: i) at least one of the anatomical sites tables, plurality of adjectives and variables tables, at least one past medical histories tables, plurality of diagnoses and syndromes tables, plurality of physicians and physicians' identities, practices and specialties tables and plurality of patients' identities tables; ii) at least one of the anatomical sites tables, plurality of adjectives and variables tables, at least one past surgical histories tables, plurality of diagnoses and syndromes tables, plurality of physicians and physicians' identities, practices and specialties tables and plurality of patients' identities tables; iii) at least one of the anatomical sites tables, plurality of adjectives and variables tables, at least one chief complaint table, causes, provocative, palliative, quality, quantity, duration tables, plurality of diagnoses and syndromes tables, plurality of physicians and physicians' identities, practices and specialties tables and plurality of patients' identities tables; iv) at least one of the anatomical sites tables, plurality of adjectives and variables tables, at least one signs and symptoms table, causes, provocative, palliative, quality, quantity, duration tables, plurality of diagnoses and syndromes tables, plurality of physicians and physicians' identities, practices and specialties tables and plurality of patients' identities tables; v) at least one of said anatomical sites tables, said plurality of adjectives and variables tables, plurality of allergies, food and chemical sensitivities tables, said plurality of diagnoses tables, said plurality of physicians and physicians' identities, practices and specialties tables and plurality of patients' identities tables; vi) at least one of said anatomical sites tables, said plurality of adjectives and variables tables, plurality of family histories and genetics tables, said plurality of diagnoses tables, said plurality of physicians and physicians' identities, practices and specialties tables and plurality of patients' identities tables; vii) at least one of said anatomical sites tables, said plurality of adjectives and variables tables, plurality of reviews of systems tables, said plurality of diagnoses tables, said plurality of physicians and physicians' identities, practices and specialties tables and plurality of patients' identities tables; viii) at least one of said anatomical sites tables, said plurality of adjectives and variables tables, plurality of physical examinations tables, said plurality of diagnoses tables, said plurality of physicians and physicians' identities, practices and specialties tables and plurality of patients' identities tables; ix) at least one of said anatomical sites tables, said plurality of adjectives and variables tables, plurality of laboratories and tests tables, said plurality of diagnoses tables, said plurality of physicians and physicians' identities, practices and specialties tables and plurality of patients' identities tables; x) at least one of said anatomical sites tables, said plurality of adjectives and variables tables, plurality of medications, toxicology, pharmacology and pharmacokinetics including combined drug uses, drug side effects and interactions and managements and treatments tables, said plurality of diagnoses tables, said plurality of physicians and physicians' identities, practices and specialties tables and plurality of patients' identities tables; xi) at least one of said anatomical sites tables, said plurality of adjectives and variables tables, said plurality diagnoses tables, said plurality of physicians and physicians' identities, practices and specialties tables and plurality of patients' identities tables; xii) at least one of said anatomical sites tables, said plurality of adjectives and variables tables, said plurality diagnoses tables, plurality of differential diagnoses tables, said plurality of physicians and physicians' identities, practices and specialties tables and plurality of patients' identities tables; xiii) at least one of said anatomical sites tables, said plurality of adjectives and variables tables, plurality infectious diseases tables, plurality of regions, localities, geography states and nations tables, a plurality of animals, insects, pests, vectors and reservoirs tables, travel histories tables, said plurality diagnoses tables, said plurality of differential diagnoses tables, said plurality of physicians and physicians' identities, practices and specialties tables and plurality of patients' identities tables; xiv) at least one of said anatomical sites tables, said plurality of adjectives and variables tables, plurality infectious diseases tables, said plurality diagnoses tables, said plurality of differential diagnoses tables, said plurality of physicians and physicians' identities, practices and specialties tables and plurality of patients' identities tables; xv) at least one of said anatomical sites tables, said plurality of adjectives and variables tables, plurality of assessments and plans tables, said plurality diagnoses tables, said plurality of differential diagnoses tables, said plurality of physicians and physicians' identities, practices and specialties tables and plurality of patients' identities tables; xvi) at least one of said anatomical sites tables, said plurality of adjectives and variables tables, plurality of treatments tables, said plurality diagnoses tables, said plurality of differential diagnoses tables, said plurality of physicians and physicians' identities, practices and specialties tables and plurality of patients' identities tables; xvi) at least one of said anatomical sites tables, said plurality of adjectives and variables tables, plurality of surgeries and procedures tables, said plurality diagnoses tables, said plurality of differential diagnoses tables, said plurality of physicians and physicians' identities, practices and specialties tables and plurality of patients' identities tables; xvii) at least one of said anatomical sites tables, said plurality of adjectives and variables tables, plurality of recommendations tables, said plurality diagnoses tables, said plurality of differential diagnoses tables, said plurality of physicians and physicians' identities, practices and specialties tables and plurality of patients' identities tables; xviii) at least one of said anatomical sites tables, said plurality of adjectives and variables tables, plurality of referrals tables, said plurality diagnoses tables, said plurality of differential diagnoses tables, said plurality of physicians and physicians' identities, practices and specialties tables and plurality of patients' identities tables; xix) at least one of said anatomical sites tables, said plurality of adjectives and variables tables, plurality of follow-ups tables, said plurality diagnoses tables, said plurality of differential diagnoses tables, said plurality of physicians and physicians' identities, practices and specialties tables and plurality of patients' identities tables; and xx) at least one of said anatomical sites tables, said plurality of adjectives and variables tables, at least one evaluations table, said plurality diagnoses tables, said plurality of differential diagnoses tables, said plurality of physicians and physicians' identities, practices and specialties tables and plurality of patients' identities tables.

Similarly, the present invention achieves the objectives and goals of the present invention by using one of said algorithms for enabling and effecting according to said innovative computer programs and software coupled to said SQL Server comprising said SQL databases and tables, processor units and memories, created and applies said using one of said algorithms for enabling and effecting, by said innovative computer programs and software coupled to said SQL Server comprising said SQL databases and tables, processor units and memories, to server-repetitively create, generate and compile adaptable and expanding individual relations of said individual unique relational SQL units in and among said SQL databases and tables in and manage by said SQL Server, according to said innovative computer programs and software comprise: i) said individual unique relational SQL units comprising related said words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to individual SQL keys in said SQL databases and tables in and manage by said SQL Server; and ii) individual results and outcomes of said server-automatic and repetitive scans and matches, correlations, collaborations and comparisons of said individual words, terms, phrases, sentences, texts, synonyms, acronyms, numbers, data, graphics and any combinations thereof and related adjectives and variables henceforth words and terms in any and all said categories related to individual diagnoses or diagnoses in individual groups of related diagnoses related to individual physicians or physicians in individual groups of physicians and patients in individual inputs or queries repetitively generated and submitted to said processor units and memories by said physicians using said devices with said words and terms of said individual unique relational SQL units, or vice versa, in said processor units and memories and outputted to, related and compiled with said relational SQL units in said SQL databases and tables in and manage by said SQL Server, according to said innovative computer programs and software for commanding and instructing processor units and memories for processing said scans and matches of said words and terms and said scanned and matched words and terms in said relational SQL units in said SQL databases and tables according to said computer-executable algorithms.

Said adaptable and expanding individual relations of said individual unique relational SQL units in and among said SQL databases and tables in and manage by said SQL Server to physicians and patients using said devices, said server-automatic and repetitive expressions and displays on said viewing screens according to said innovative computer programs and software, comprise: i) anatomical sites, plurality of adjectives and variables, past medical histories, plurality of diagnoses, plurality of physicians and physicians' identities, practices and specialties and plurality of patients' identities; ii) anatomical sites, plurality of adjectives and variables, past surgical histories, plurality of diagnoses, plurality of physicians and physicians' identities, practices and specialties and plurality of patients' identities; iii) anatomical sites, plurality of adjectives and variables, chief complaint table, causes, provocative, palliative, quality, quantity, duration, plurality of diagnoses, plurality of physicians and physicians' identities, practices and specialties and plurality of patients' identities; iv) anatomical sites, plurality of adjectives and variables, chief complaints, signs and symptoms table, causes, provocative, palliative, quality, quantity, duration, plurality of diagnoses, plurality of physicians and physicians' identities, practices and specialties and plurality of patients' identities; v) said anatomical sites, said plurality of adjectives and variables, plurality of allergies, food and chemical sensitivities, said plurality of diagnoses, said plurality of physicians and physicians' identities, practices and specialties and plurality of patients' identities; vi) said anatomical sites, said plurality of adjectives and variables, plurality of family histories and genetics, said plurality of diagnoses, said plurality of physicians and physicians' identities, practices and specialties and plurality of patients' identities; vii) said anatomical sites, said plurality of adjectives and variables, plurality of reviews of systems, said plurality of diagnoses, said plurality of physicians and physicians' identities, practices and specialties and plurality of patients' identities; viii) said anatomical sites, said plurality of adjectives and variables, plurality of physical examinations, said plurality of diagnoses, said plurality of physicians and physicians' identities, practices and specialties and plurality of patients' identities; ix) said anatomical sites, said plurality of adjectives and variables, plurality of laboratories and tests, said plurality of diagnoses, said plurality of physicians and physicians' identities, practices and specialties and plurality of patients' identities; x) said anatomical sites, said plurality of adjectives and variables, plurality of medications, toxicology, pharmacology and pharmacokinetics including combined drug uses, drug side effects and interactions and managements and treatments, said plurality of diagnoses, said plurality of physicians and physicians' identities, practices and specialties and plurality of patients' identities; xi) said anatomical sites, said plurality of adjectives and variables, said plurality diagnoses, said plurality of physicians and physicians' identities, practices and specialties and plurality of patients' identities; xii) said anatomical sites, said plurality of adjectives and variables, said plurality diagnoses, plurality of differential diagnoses, said plurality of physicians and physicians' identities, practices and specialties and plurality of patients' identities; xiii) said anatomical sites, said plurality of adjectives and variables, plurality infectious diseases, plurality of regions, localities, geography states and nations, a plurality of animals, insects, pests, vectors and reservoirs, travel histories, said plurality diagnoses, said plurality of differential diagnoses, said plurality of physicians and physicians' identities, practices and specialties and plurality of patients' identities; xiv) said anatomical sites, said plurality of adjectives and variables, plurality infectious diseases, said plurality diagnoses, said plurality of differential diagnoses, said plurality of physicians and physicians' identities, practices and specialties and plurality of patients' identities; xv) said anatomical sites, said plurality of adjectives and variables, plurality of assessments and plans, said plurality diagnoses, said plurality of differential diagnoses, said plurality of physicians and physicians' identities, practices and specialties and plurality of patients' identities; xvi) said anatomical sites, said plurality of adjectives and variables, plurality of treatments, said plurality diagnoses, said plurality of differential diagnoses, said plurality of physicians and physicians' identities, practices and specialties and plurality of patients' identities; xvi) said anatomical sites, said plurality of adjectives and variables, plurality of surgeries and procedures, said plurality diagnoses, said plurality of differential diagnoses, said plurality of physicians and physicians' identities, practices and specialties and plurality of patients' identities; xvii) said anatomical sites, said plurality of adjectives and variables, plurality of recommendations, said plurality diagnoses, said plurality of differential diagnoses, said plurality of physicians and physicians' identities, practices and specialties and plurality of patients' identities; xviii) said anatomical sites, said plurality of adjectives and variables, plurality of referrals, said plurality diagnoses, said plurality of differential diagnoses, said plurality of physicians and physicians' identities, practices and specialties and plurality of patients' identities; xix) said anatomical sites, said plurality of adjectives and variables, plurality of follow-ups, said plurality diagnoses, said plurality of differential diagnoses, said plurality of physicians and physicians' identities, practices and specialties and plurality of patients' identities; and xx) said anatomical sites, said plurality of adjectives and variables, evaluations, said plurality diagnoses, said plurality of differential diagnoses, said plurality of physicians and physicians' identities, practices and specialties and plurality of patients' identities.

The computer-server system according to claim 1 wherein said computer server-executable algorithm for server-automatically, instantly and repetitively scanning, matching correlating, collaborating and comparing individual words, terms, phrases, sentences, texts, synonyms, acronyms, numbers, data, graphics and any combinations thereof and related adjectives and variables henceforth words and terms in any or all said categories, repetitively generated and submitted to said processor units and memories by said individual physicians, physicians or said physicians in individual groups of physicians and health-care providers using said devices, with said individual unique relational SQL units in said individual relations of said individual unique relational SQL units in and among said SQL databases and tables, or vice versa, comprises one of the following representations: i) computer server-automatic and sequential scans and matches words and terms representing signs and symptoms and causes, provocatives, palliatives, severity of signs and symptoms and temporal factors of said signs and symptoms, anatomical locations, anatomical sites in said individual inputs or queries with same, similar, equivalent or synonymous words and terms related to individual diagnoses, related to first individual groups of individual SQL keys in said individual relational SQL units in said SQL databases and tables, representing first information on individual diagnoses in said processor units and memories; ii) computer server-automatic selections of matches of said words and terms in said individual inputs or queries and said words and terms in said individual relational SQL units and related to first individual SQL keys and words and terms representing a first information on individual diagnoses in said individual relational SQL units to be a first individual groups of words and terms and individual SQL keys representing said first information on individual diagnoses in said SQL diagnoses tables; iii) computer server-automatic stores of said selections of said first individual groups of words and terms and said related individual SQL keys in said memories of said computer server or servers and said SQL databases and tables in said SQL Server; iv) computer server-automatic first sequential scans and matches of said first individual groups of words and terms with second words and terms representing a second information on individual diagnoses in said relational SQL units comprising said second words and terms representing said second information on individual diagnoses in said diagnoses tables related to reviews of systems, anatomical locations, anatomical sites in said relational SQL units and in related reviews of systems, anatomical locations, anatomical sites tables and second sequential scans and matches of first words and terms in said individual relational SQL units representing anatomical sites, reviews of systems and anatomical locations with second words and terms representing reviews of systems, anatomical locations and anatomical sites in said individual inputs or queries of individuals or individual groups of people; v) computer server-automatic selections of said matches of said first individual groups of words and terms and said second words and terms representing information on individual diagnoses represented by SQL keys in said relational SQL units related to said matches of said first and second words and terms representing reviews of systems, anatomical locations and anatomical sites; vi) computer server-automatic stores of said matches of said first individual group of words and terms and said second individual group of words and terms representing information on individual diagnoses represented by SQL keys in said relational SQL units related to said matches of said first and second words and terms representing reviews of systems, anatomical locations and anatomical sites comprising a third individual group of words and terms and third group of individual SQL keys representing third information on individual diagnoses in said relational SQL units in said SQL databases and tables in said SQL Server; vii) computer server-automatic first sequential scans and matches of said third individual groups of words and terms with fourth words and terms representing a fourth information on individual diagnoses in said relational SQL units comprising said fourth words and terms representing said fourth information on individual diagnoses in said diagnoses tables related to anatomical sites, physical examinations or findings and anatomical locations in said relational SQL units and in related physical examinations or findings, anatomical locations, anatomical sites tables and second sequential scans and matches of first words and terms in said individual relational SQL units representing anatomical sites, physical examinations or findings and anatomical locations with second words and terms representing anatomical sites, physical examinations or findings and anatomical locations in said individual inputs or queries of individuals or individual groups of people; viii) computer server-automatic selections of said matches of said third individual groups of words and terms and said fourth individual groups of words and terms representing information on individual diagnoses represented by SQL keys in said relational SQL units related to said matches of said first and second words and terms representing physical examinations or findings, anatomical locations and anatomical sites; ix) computer server-automatic stores of said matches of said third individual group of words and terms and said fourth individual group of words and terms representing information on individual diagnoses represented by SQL keys in said relational SQL units related to said matches of said first and second words and terms representing physical examinations or findings, anatomical locations and anatomical sites comprising a fourth individual group of words and terms and fourth group of individual SQL keys representing fourth information on individual diagnoses in said relational SQL units in said SQL databases and tables in said SQL Server; x) computer server-automatic first sequential scans and matches of said fourth individual groups of words and terms with fifth words and terms representing a fifth information on individual diagnoses in said relational SQL units comprising said fifth words and terms representing said fifth information on individual diagnoses in said diagnoses tables related to anatomical sites or organ systems, laboratory results and anatomical locations in said relational SQL units and in related laboratory results, anatomical locations, anatomical sites and organ systems tables and second sequential scans and matches of first words and terms in said individual relational SQL units representing anatomical sites or organ systems, laboratory results and anatomical locations with second words and terms representing anatomical sites or organ systems, laboratory results and anatomical locations in said individual inputs or queries of individuals or individual groups of people; xi) computer server-automatic selections of said matches of said fourth individual groups of words and terms and said fifth individual groups of words and terms representing information on individual diagnoses represented by SQL keys in said relational SQL units related to said matches of said first and second words and terms representing anatomical sites or organ systems, laboratory results and anatomical locations; and xii) computer server-automatic stores of said matches of said fourth individual group of words and terms and said fifth individual group of words and terms representing information on individual diagnoses represented by SQL keys in said relational SQL units related to said matches of said first and second words and terms representing physical examinations or findings, anatomical locations and anatomical sites comprising a fifth individual group of words and terms and fifth group of individual SQL keys representing fifth information on individual diagnoses in said relational SQL units and represented by SQL keys in said SQL databases and tables in and manage by said SQL Server.

In other words, serving yet as another example among numerous examples, using one of said computer server-executable algorithms according to said innovative computer programs and software, the present invention provides said system and method for server-automatically and continually managing and monitoring diseases and disorders and quality, quantity and continuity of health, health-care and health-care services, being provided and to be provided by said individual physicians and said physicians in said individual groups of physicians and health-care providers to said individual patients and patients related to said diagnoses, syndromes or individual diagnoses in individual groups f related diagnoses, for said physicians and patients by providing a process for server-automatically, instantly and repetitively scanning, matching correlating, collaborating and comparing individual words and terms in any or all said categories in individual inputs or queries repetitively generated and submitted to said processor units and memories by said individual physicians, physicians or said physicians in individual groups of physicians and health-care providers or said individual patients using said devices, with said individual unique relational SQL units in said individual relations of said individual unique relational SQL units in and among said SQL databases and tables, or vice versa comprises i) a process for computer server-automatically and sequentially scanning and matching, collaborating, correlating and comparing individual words and terms representing chief complaints, signs and symptoms and causes, provocatives, palliatives, quality and severity of signs and symptoms and temporal factors of said signs and symptoms, and related anatomical locations and anatomical sites and related adjectives and variables in said individual inputs or queries submitted to said processor units and memories by said physicians with same, similar, equivalent or synonymous words and terms related to individual diagnoses and/or individual syndromes, which are related to first individual group of individual diagnoses related to individual SQL keys in said individual unique relational SQL units in said relations of said individual unique relational SQL units in and among said SQL databases and tables. Said computer server-automatic scans and matches in processor units and memories resulted in the server-automatic selections of said matches of said words and terms related to said first group of individual diagnoses and/or individual syndromes—number from 1-approximately less than 100—related to first group of individual SQL keys in said individual unique relational SQL units in said relations of said individual unique relational SQL units in and among said SQL databases and tables, in said processor units and memories coupled to said SQL Server and, consequently, if said number of diagnosis=1, said process is computer server-automatically terminated; however, if said number of preliminary diagnoses>1, consequently and next, ii) a process for said computer server-automatically selecting said matches of said words and terms and related said first group of individual diagnoses and/or syndromes, related to said first group of individual SQL keys, in said processor units and memories and computer server-automatically and sequentially scanning and matching, collaborating, correlating and comparing said first group of individual diagnoses related to first group individual SQL keys with second group of individual diagnoses and/or individual syndromes related to second individual SQL keys related to anatomical locations, anatomical sites and related reviews of systems and related adjectives and variables in said relations of said individual SQL units in said individual unique relational SQL units in said relations of said individual unique relational SQL units in and among said SQL databases and tables in said processor units and memories coupled to said SQL Server and, consequently, if said number of diagnosis=1, said process is computer server-automatically terminated; however, if said number of preliminary diagnoses>1, consequently and next, iii) a process for said computer server-automatically selecting said matches of said words and terms and related said second group of individual diagnoses and/or syndromes, related to said second group of individual SQL keys, in said processor units and memories and computer server-automatically and sequentially scanning and matching, collaborating, correlating and comparing said second group of individual diagnoses related to second group individual SQL keys with third group of individual diagnoses and/or individual syndromes related to third individual SQL keys related to anatomical locations, anatomical sites and related physical examinations or findings and related adjectives and variables in said relations of said individual SQL units in said individual unique relational SQL units in said relations of said individual unique relational SQL units in and among said SQL databases and tables in said processor units and memories coupled to said SQL Server and, consequently, if said number of diagnosis=1, said process is computer server-automatically terminated; however, if said number of preliminary diagnoses>1, consequently and next, iv) a process for said computer server-automatically selecting said matches of said words and terms and related said third group of individual diagnoses and/or syndromes, related to said third group of individual SQL keys, in said processor units and memories and computer server-automatically and sequentially scanning and matching, collaborating, correlating and comparing said third group of individual diagnoses related to third group individual SQL keys with fourth group of individual diagnoses and/or individual syndromes related to fourth individual SQL keys related to anatomical locations, anatomical sites, organ systems and related laboratory tests, imaging, tissues examinations and results and related adjectives and variables in said relations of said individual SQL units in said individual unique relational SQL units in said relations of said individual unique relational SQL units in and among said SQL databases and tables in said processor units and memories coupled to said SQL Server and, consequently, if said number of diagnosis=1, said process is computer server-automatically terminated; however, if said number of preliminary diagnoses>1, consequently and next, v) a process for said computer server-automatically selecting said matches of said words and terms and related said fourth group of individual diagnoses and/or syndromes, related to said fourth group of individual SQL keys, in said processor units and memories and computer server-automatically and sequentially scanning and matching, collaborating, correlating and comparing said fourth group of individual diagnoses related to fourth group individual SQL keys with fifth group of individual diagnoses and/or individual syndromes related to fifth individual SQL keys related to anatomical locations, anatomical sites, organ systems and related medications and drugs and related adjectives and variables in said relations of said individual SQL units in said individual unique relational SQL units in said relations of said individual unique relational SQL units in and among said SQL databases and tables in said processor units and memories coupled to said SQL Server and, consequently, if said number of diagnosis=1, said process is computer server-automatically terminated; however, if said number of preliminary diagnoses>1, consequently and next, vi) a process for said computer server-automatically selecting said matches of said words and terms and related said fifth group of individual diagnoses and/or syndromes, related to said fifth group of individual SQL keys, in said processor units and memories and computer server-automatically and sequentially scanning and matching, collaborating, correlating and comparing said fourth group of individual diagnoses related to fifth group individual SQL keys with sixth group of individual diagnoses and/or individual syndromes related to sixth individual SQL keys related to anatomical locations, anatomical sites, organ systems and related treatments and procedures and related adjectives and variables in said relations of said individual SQL units in said individual unique relational SQL units in said relations of said individual unique relational SQL units in and among said SQL databases and tables in said processor units and memories coupled to said SQL Server and, consequently, if said number of diagnosis=1, said process is computer server-automatically terminated; however, if said number of preliminary diagnoses>1, consequently and next, vii) a process for said computer server-automatically selecting said matches of said words and terms and related said sixth group of individual diagnoses and/or syndromes, related to said sixth group of individual SQL keys, in said processor units and memories and computer server-automatically and sequentially scanning and matching, collaborating, correlating and comparing said sixth group of individual diagnoses related to sixth group individual SQL keys with seventh group of individual diagnoses and/or individual syndromes related to seventh individual SQL keys related to anatomical locations, anatomical sites, organ systems and related surgeries and related adjectives and variables in said relations of said individual SQL units in said individual unique relational SQL units in said relations of said individual unique relational SQL units in and among said SQL databases and tables in said processor units and memories coupled to said SQL Server.

It is understood that said algorithm can and does include family histories, genetics, immunizations, medications, drugs and therapeutics effects and side-effects on human organs and bodies of said medications, drugs and therapeutics, guidelines, protocols, referrals, recommendations and related physicians' specialties and practices.

It is to be understood that said successive group of diagnoses is in the domain of said previous group of diagnoses and the number of diagnoses in said previous group of diagnoses is always larger than the number of diagnoses in said successive group of diagnoses in said processor units and memories.

It is the objective and goal of the present invention, according to said innovative computer programs and software coupled to said processor units, memories and SQL Server comprising said SQL databases and tables and said individual SQL units in said individual unique relational SQL units in said relations of said individual unique relational SQL units in and among said SQL databases and tables, using said one algorithm to generate the final and definitive diagnosis=1 and retrieve relate said diagnosis to individual diagnoses in individual groups of related diagnoses, differential diagnoses, said categories and health, health-care and health-care services and to individual physicians, physicians, individual physicians or health-care providers in individual groups of physicians and health-care providers and their identities, practices and specialties and, in certain settings and circumstances as described herein, said patients' identities.

In other words, the present invention provides an innovative computer server intelligent system and method for providing individual preliminary diagnoses and individual definitive diagnoses and related information and data—supra—from said queries or inputs by said physicians or patients and said SQL databases and tables and said individual SQL units in said individual unique relational SQL units in said relations of said individual unique relational SQL units in and among said SQL databases and tables.

Said relational information and data in said SQL databases and tables, individual unique relational SQL units, and said adaptable and expanding individual relations of said individual unique relational SQL units in and among said SQL databases and tables, and said qualifications and regulations of payments for health-care and health-care services to individual physicians and proportional payments, distributions, adjustments, debits, redistributions and readjustments of payments in and among individual adaptable and expanding compositions of adaptable accounts of individual physicians in individual groups of physicians related to individual diagnoses or individual diagnoses in individual groups of related diagnoses and related health, health-care and health-care services provided to said individual patients by said individual groups of physicians and related individual disbursements relating and corresponding to said payments in individual adaptable and expanding compositions of adaptable accounts of said individual patients in the SQL databases and tables in and manage by a SQL server coupled to and enabled by said innovative computer programs and software in said computer server or servers viewable, manageable, adjustable and used by and interactive with said individual physicians and individual patients using said devices, and adaptable and expanding accounting and tallies of adaptable revenues and earnings of said individual physicians and said individual physicians in individual groups of physicians comprising said payments to individual physicians and said proportional payments, distributions, adjustments, debits, redistributions and readjustments of payments in and among said individual adaptable and expanding compositions of adaptable accounts of individual physicians in individual groups of physicians, and said related individual disbursements relating and corresponding to said payments and related refunds or reimbursements relating or corresponding to deductions from said payments in said individual adaptable and expanding compositions of adaptable accounts of said individual patients according to the instructions and commands of said innovative computer programs and software for repetitively paying, proportionally paying, distributing, adjusting, debiting, readjusting and redistributing said proportional payments, calculating, tallying and accounting said revenues, earnings, disbursements, refunds, reimbursements in and among said individual adaptable and expanding compositions of adaptable accounts in said databases and tables are server-automatically, repetitively and continually and constantly generated, expressed, retrieved and displayed and used by said processor units, memories, SQL Server and said physicians and patients in numerous interactive related electronic templates, HTML related Web pages and on interactive and related 2-dimensional and 3-dimensional, human figurines and images such as, but not limited, those taught by U.S. Pat. No. 6,132,218 and its derivatives, graphics, charts, videos and as dynamic data, transactional data and streaming data and any combinations thereof and the like and derivatives on said viewing screens of said devices, enabled by said Internet Explorer and browsers and Web server devices and servers in said network or networks, being used by said patients and physicians using said devices to fulfill the objectives and goals of the present invention.

Taught and used extensively in said pending patent applications, said innovative computer programs and software for communicating with and commanding and instructing and coupled to said processor units, memories, SQL Server, said Web server, Web browsers also provides the repetitive generations, displays, views and uses of server-generated electronic related templates of numerous related Web pages on said viewing screens comprising said numerous interactive electronic templates repetitive use by said physicians and patients for: i) generating individual words, terms, phrases, sentences, texts, synonyms, acronyms, numbers, data, graphics and any combinations thereof and related adjectives and variables henceforth words and terms in any and all said categories representing information and data on health, health-care and health-care services on or relating to individual diagnoses, individual syndromes or individual diagnoses in individual groups of related diagnoses of diseases and disorders and related individual prices, monetary values or costs in said processor units and relating and compiling in said SQL databases and tables in and manage by said SQL Server; ii) repetitively generating, displaying, manipulating, modifying and editing said words and terms relating to diagnoses continually and perpetually generated and submitted to said process units, memories and SQL databases and tables by said individual physicians, said individual physicians in individual groups of physicians and said individual patients related to individual diagnoses or individual diagnoses in individual groups of related diagnoses and related health, health-care and health-care services; iii) repetitively managing said individual words and terms and related said individual diagnoses or said individual diagnoses in individual groups of related diagnoses continually and perpetually generated and submitted by said physicians and between and among said individual physicians in individual groups of physicians and adaptable and expanding editions of versions of said information and data on individual diagnoses or individual diagnoses in individual groups of related diagnoses of diseases and disorders and editions of related versions of information and data on related health-care and health-care services and editions of related versions of compositions of accounts and successive editions of related versions of information and data on individual diagnoses or individual diagnoses in individual groups of related diagnoses of diseases and disorders and successive editions of related versions of information and data on health, health-care and health-care services relating to said versions of diagnoses and successive editions of compositions of accounts by physicians and said computer, computer server or servers and manage by said SQL server; iv) repetitively generating said individual words and terms representing information and data on health, health-care and health-care services and related said individual diagnoses or said individual diagnoses in individual groups of related diagnoses continually and perpetually generated and submitted by said physicians and between and among said individual physicians in individual groups of physicians and adaptable and expanding editions of versions of said information and data on individual diagnoses or individual diagnoses in individual groups of related diagnoses of diseases and disorders and editions of related versions of information and data on related health-care and health-care services and editions of related versions of compositions of accounts and successive editions of related versions of information and data on individual diagnoses or individual diagnoses in individual groups of related diagnoses of diseases and disorders and successive editions of related versions of information and data on health, health-care and health-care services relating to said versions of diagnoses and successive editions of compositions of accounts by physicians and said computer, computer server or servers and manage by said SQL server; v) server-automatically and continually guiding, assisting and adapting decision makings, judgements, determinations and executions impacting on the health, health-care and health-care services, related to individual diagnoses, individual syndromes or individual diagnoses in individual groups of related diagnoses, being provided or to be provided to patients or individual patients by individual physicians or physicians in individual groups of physicians and health-care providers and the generations and inputs of information and data on said decision makings, judgements, determinations and executions into said SQL databases and tables; vi) server-automatically and instantly identifying, determining and displaying and warning of individual deficiencies, inconsistencies, faults and misses in said decision makings, judgements, determinations and executions of said health, health-care and health-care services related to any or all categories and related definitive or preliminary diagnoses represented by individual deficiencies, inconsistencies, faults and misses in said individual selections and keyboarded words and terms in said templates on said viewing screens referencing to and scanning, matching, correlating, collaborating and comparing with the pooled and compiled decision makings, judgements, determinations and executions on said health, health-care and health-care services related to individual diagnoses, individual syndromes or individual diagnoses in individual groups of related individual diagnoses or individual syndromes related to physicians related to SQL keys in said adaptable and expanding individual relations of said individual unique relational SQL units in and among said SQL databases and tables; vii) server-automatically, instantly and concomitantly compensating or correcting for or advising and providing options and alternatives to said individual deficiencies, inconsistencies, faults and misses, prior to the inputs of said selections or keyboarded words and terms, by retrieving from and displaying interactive words and terms in said adaptable and expanding individual relations of said individual unique relational SQL units in and among said SQL databases and tables on said viewing screens for said physicians or patients; viii) submitting said selections, keyboarded words and terms and corrections and editions to said processor units, memories from which server-automatically and repetitively outputting said words and terms in any or all categories related to individual diagnoses, individual syndromes or diagnoses in individual groups of related diagnoses related to individual physicians and patients to relate and compile in said relational individual SQL units in said adaptable and expanding relations of SQL units in said SQL databases and tables in and manage by said SQL in said computer server or servers; ix) server-automatically, repetitively and continually patterning and standardizing said decision makings, judgements, determinations and executions on the productions and executions of said quality, quantity and continuity of health, health-care and health-care services, related to individual diagnoses, individual syndromes or individual diagnoses in individual groups of related diagnoses, being provided or to be provided to patients or individual patients by individual physicians or physicians in individual groups of physicians and health-care providers; x) said individual physicians or physicians in individual groups of physicians to repetitively relate individual patients or patients related to individual diagnoses, individual syndromes or diagnoses in individual groups of diagnoses and related said categories related to individual SQL keys to individual SQL keys related to individual physicians, physicians, health-care providers, or physicians in individual groups of physicians and health-care providers in said SQL databases and tables using said devices and said relations of physicians, patients and diagnoses related to said individual SQL keys are server-automatically, repetitively and continually retrieved and displayed on said viewing screens of said physicians and patients who viewed, interactive with, use and select said interactive displays on said viewing screens of said devices; xi) server-automatically, repetitively and continually relating individual diagnoses, individual syndromes or diagnoses in individual groups of diagnoses and individual patients to individual physicians, physicians, health-care providers or physicians in individual groups of physicians and health-care providers related to said diagnoses related to individual SQL keys in said SQL databases and tables which are server-automatically, repetitively and continually retrieved and displayed on said viewing screens of said physicians and patients who viewed, interactive with, use and select said interactive displays on said viewing screens of said devices; xii) server-automatically and repetitively selecting, retrieving and displaying adaptable and expanding compositions of said SQL relations of individual relational SQL units related to individual diagnoses, individual syndromes or diagnoses in individual groups of related diagnoses and related differential diagnoses and related categories and individual physicians or physicians in said individual groups of physicians and health-care providers related to said individual SQL keys in said SQL databases and tables on said viewing screens of said devices to individual patients and people; xiii) repetitively displaying, manipulating, modifying and editing said adaptable and expanding relational compositions of said individual scanned and matched words and terms and related individual prices, monetary values or costs in said SQL databases and tables by said individual physicians and by and among said individual physicians in individual groups of physicians and individual patients; xiv) repetitively enabling and effecting computer-automatically and repetitively generating relations of said adaptable and expanding compositions on said relational words and terms and said adaptable and expanding compositions of accounts on said payments, proportional payments, distributions and redistributions, adjustments and readjustments of payments in and among said individual adaptable and expanding accounts of said individual physicians relating and corresponding to expenses, deductions, disbursements, refunds and reimbursements in said adaptable and expanding compositions of accounts of said individual patients in said SQL databases and tables in and manage by said SQL Server; xv) repetitively enabling and effecting computer-automatically and repetitively modifying, editing, relations of said adaptable and expanding compositions of said words and terms and said adaptable and expanding compositions of said accounts in said SQL databases and tables in and manage by said SQL server; xvi) repetitively enabling and effecting computer-automatically and repetitively generating and expanding said SQL databases and tables, individual SQL units and relations of said SQL units in and among said SQL databases and tables in and manage by said SQL Server; and xvii) server-automatically and repetitively expressing and displaying said individual computer-generated results and outcomes of said scans, matches, correlations, collaborations and comparisons of said information and data in said processor units and memories and in said SQL units and relations of said SQL units in and among said SQL databases and tables for server-automatically and continually managing and monitoring diseases and disorders and quality, quantity and continuity of health, health-care and health-care services, being provided and to be provided by physicians, said individual physicians, physicians in said individual groups of physicians and health-care providers to said individual patients and patients related to said diagnoses or individual diagnoses in individual groups of related diagnoses, for and interactive with and said physicians and patients on said viewing screens of said devices.

Said words and terms representing said individual diagnoses, individual syndromes and diagnoses or syndromes in individual groups of related diagnoses or syndromes affecting organs, parts and anatomical sites of humans and related diseases, disorders, chief complaints, signs and symptoms, differential diagnoses, reviews of systems, physical examinations, laboratories, imaging, body fluid tests and tissues examinations, organs and anatomical sites and parts of human, family histories, genetics, immunizations, treatments, surgeries, procedures, medications, drugs and therapeutics and effects and side-effects on human organs and bodies of said medications, drugs and therapeutics, guidelines, protocols, referrals, recommendations and physicians' specialties and/or practices and related adjectives and variables are represented by individual keys such as, but not limited to primary keys, foreign keys and surrogate keys in said SQL databases and tables.

Said words, terms, phrases, sentences, texts, synonyms, acronyms, numbers, data, graphics and any combinations thereof and related adjectives and variables henceforth words and terms in any and all said categories representing information and data on health, health-care and health-care services, individual diagnoses, individual syndromes and diagnoses or syndromes in individual groups of related diagnoses or syndromes affecting organs, parts and anatomical sites of humans and related diseases, disorders, chief complaints, signs and symptoms, differential diagnoses, reviews of systems, physical examinations, laboratories, imaging, body fluid tests and tissues examinations, organs and anatomical sites and parts of human, family histories, genetics, immunizations, treatments, surgeries, procedures, medications, drugs and therapeutics and effects and side-effects on human organs and bodies of said medications, drugs and therapeutics, guidelines, protocols, referrals, recommendations and physicians' specialties and/or practices are represented by individual keys such as, but not limited to primary keys, foreign keys and surrogate keys also known as SQL keys in said SQL databases and tables.

Said words and terms in any and all said categories representing information and data on health, health-care and health-care services on or relating to individual diagnoses, individual syndromes or individual diagnoses in individual groups of related diagnoses of diseases and disorders. Said information and data are found in numerous medical dictionaries such as, but not limited to, Stedman's Medical Dictionary, medical and surgical text books, journals, publications, literature and encyclopedias said all medical and surgical specialties. For example, in the Evaluation heading, said words and terms number about 20-40 or more and are such as, but not limited to, consultation, brief consultation, intermediate consultation, comprehensive consultation, office visit, brief office visit, intermediate office visit, examination, reexamination, follow-up, etc.; in the heading of Laboratory comprises imaging, blood and tissue tests, analyses and examinations, electro-diagnosis, said words and terms number approximately many hundreds such as, but not limited to, x-rays, MRI's, CTScan's, PET Scans of various parts of the body, various types of blood tests, urinalyses, pathological analyses which are used by physicians in about 85 medical and surgical specialties or practices.

In the epidemiology, statistical and bio-statical analyses, deductions, revelations and reports—using common statistical and bio-statical methods and programs commonly being used in medicine, health-care and sciences—on the accuracies on said outcomes of said processes and selections relating to said inputs or queries of information and data by said people and computer-generations and computer-displays of said interactive and adaptable pooled consensuses, guidelines, protocols and derivatives and outcomes on and relating to individual diagnoses, individual syndromes and diagnoses or syndromes and said derivatives of successive and extensive computer-deductions on and related to individual groups of diagnoses or syndromes in about 85 medical and surgical specialties and practices by said computer server or servers are also provided by the present invention.

Said methods, processes, system, results and outcomes and related and derivatives of the present invention are implemented and effected by said unique and innovative computer programs and software invented and developed by the present patent applicant which were filed with and are stored in the Library of Congress in Washington, D.C. The present invention uses also the commercially available computer software (plural), programs and computer languages such as, but not limited to, those made and sold by Microsoft Corporation such as, but not limited to, Microsoft Windows Server operating system, Microsoft Windows Server 2008, Chrome operating system, Linux, SQL such as, but not limited to Microsoft SQL Server 2008, MySQL and the like, Internet Explorer, various other Web browsers such as, but not limited to Firefox browser by Mozilla Foundation, Chrome Web browser, Safari, Opera and the like and derivatives, Web server, Unix, Apache, Microsoft IIS, Visual Studio and .Net, Microsoft software including Notepad, Wordpad and .txt programs and their derivatives and the like and related and their databases and derivatives, other computer corporations' and companies' programs, languages, codes and databases and their derivatives which are commonly and routinely used by computer engineers and programmers such as, but not limited to, PHP, PERL, C languages, such as, but not limited to, C, C+, C++, C#, JAVA, JavaScript, AJAX, HTML, XHTML and the like and related and their derivatives. Other computer programs and software also include application software (plural) also known as Applications or Apps for manipulating, texting, numbering, graphics, or any combinations of these elements for uses and applications with iPhone and iPad of Apple, Inc. and Google's Android software and the like and their derivatives. Flash technology and the like and related and derivatives of Adobe Systems, Inc. and programs and software for creating and generating streaming media, dynamic data or transactional data and the like and derivatives are incorporated into the preferred embodiments of the present invention. As taught by said and earlier several patent applications of the present patent applicants, speech recognition software such as, but not limited to, those manufactured by Microsoft and Nuance such as Microsoft Speech Server and Dragon and their derivatives, are also incorporated and used in said servers for speech recognizing digital voice data originated in said devices by said physicians.

Other security software are such as, but not limited to, encryption-decryption of the information and data infra and their derivatives and products, processes and software, Firewall, anti-viral and related, Secure Sockets Layer (SSL) or Transport Layer Security (TLS) and related and the like and their derivatives.

The standard commercial hardware and equipment being used in the TCP/IP networks and the like or equivalence such as, but not limited to, the Internet commerce are implemented and deployed per standard industrial practices and use hardware and equipment such as, but not limited to, computer servers and computers such as numerous HP, Dell and IBM servers, HP and Dell computers, Cisco routers, VMware virtual servers—see www.hp.com, www.dell.com, www.VMWare.com and www.Cisco.com for details of the server hardware, internal and designs and configurations of server hardware—used by the present patent applicant as the hardware wherein the computer programs and software(s) mentioned herein operate in said network or networks. Other related equipment, include modems sold, lease, own and operate by cable companies such as, but not limited to, Time Warner and Optimum Online in New York, etc. Currently, said server blades and virtual servers—an improvement of the earlier version of connected servers, for example, HP ProLiant ML350 and ML110 Generation 4p Servers—of the present invention incorporates various servers and related commercial programs and software and hardware and equipment being sold by VMware, Inc., Hewlett-Packard Co., Dell, Inc., International Business Machines Corporation and Cisco Systems, Inc. and the like and their derivatives which are being used by many large American corporations are used and will be further expanded in the implementations, updates and expansions of the preferred embodiments of the present invention in the telecommunications system.

Said preferred embodiments—a unique and innovative computing in health-care—of the present invention are applicable to and used by individual physicians, individual patients, individual groups of physicians and individual groups of physicians and individual patients in same and diverse and different settings and locations by teleconferencing—live teleconferences or teleseminars comprising live and mass articulations, exchanges and improvements of communications of said information and data among said individual physicians, individual patients, individual groups of physicians and individual groups of physicians and individual patients using said computer servers and devices in said network or networks of telecommunications system in America and among all nations on earth and places remote and away from earth. The preferred embodiments of the present invention are enabled by current and popular commercial technologies represented at www.webex.com by Cisco Systems, Inc. and www2.gotomeeting.com by Citrix Online, L.L.C., and others such as, but not limited to, ACT Conferencing, Adobe Acrobat Connect, Glance, InterCall, Microsoft Office Live Meeting, WebEx and Premiere Global Services and the like commercially available from and provided by other companies or corporations for enabling individual persons in various and different settings and locations to conference or use said embodiments as individual groups of people being in said diverse or different settings and locations using said network or networks and the Internet to achieve the goals and objectives of the present invention.

Said system can and will incorporate one of the preferred embodiments -server-automatic and repetitive expressions and displays of said adaptable and expanding individual relations of said individual unique relational SQL units in and among said SQL databases and tables in server-automatically generated and displayed interactive related electronic templates, HTML related Web pages and on interactive and related 2-dimensional and 3-dimensional, human figurines and images, graphics, charts, videos and as dynamic data, transactional data, streaming data, live streaming and any combinations thereof and the like and derivatives on said viewing screens of said devices, enabled by said Internet Explorer and browsers and Web server devices and servers in said network or networks, being used by said patients and physicians using said devices.

Said computers, laptops and mobile wireless communication devices including smartphones possessing processor units, memories, keyboards for repetitively viewing, managing, expanding and inputting said information and data and for repetitively generating, manipulating, relating, updating, expanding and controlling said adaptable and expandable information and data in said SQL databases and tables, application software and said viewing screens including touch-sensitive or touch screens enabled by Web browsers, routers and modems for accessing said computer servers and application software for accessing applications and said system in said computer server or servers henceforth devices for accessing said computer servers in a network or networks of said devices and computer servers by said devices in said network or networks of said devices and computer servers.

Furthermore, on said viewing and interactive touchscreens or touch-enabled screens of said devices, a process for locating or positioning—wherever feasible, achievable, workable or practicable—interactive functions, panels and tools and information and data health, health-care, health-care services and communications in said consensuses, guidelines and protocols and interactive and adaptable electronic templates to physicians and patients in the right half or area of said viewing screens including touch-enabled screens or touchscreens of said devices.

Although sequences of applications of individual interactive words and terms representing diagnoses, syndromes and diagnoses or syndromes in individual groups of diagnoses or syndromes and compiled, related or pooled relational information and data on and related to diagnoses, syndromes and diagnoses or syndromes in individual groups of diagnoses or syndromes and related chief complaints, symptoms and signs, differential diagnoses, reviews of systems, physical examinations, family histories, genetics, immunizations, laboratories, imaging, body fluid tests and tissues examinations, assessments and plans, medications, treatments, procedures, surgeries, recommendations, guidelines, referrals, follow-ups, organs and anatomical sites and parts of humans and physicians' practices related to said diagnoses or said individual groups of diagnoses as one of the preferred embodiments of the present invention have been described, it is to be appreciated and understood by those skilled in the art that various combinations, permutations and orders of sequences of applications of said words and terms are some of the preferred embodiments of the present invention and are made, used and achieved without departing from the spirit and the scope of the claims of the present invention.

It is to be understood that a computer server, computer servers and/or virtual serves capable of computer-creating and -generating said consensuses, guidelines and protocol and computer-deducing diagnoses, syndromes and diagnoses or syndromes in individual groups of diagnoses or syndromes of the present invention also embody any and all computers and mobile computers such as, but not limited to, and server blades and various hardware and equipment configurations, virtual servers such as those sold by VMware, HP and IBM, and their derivatives being used by many large American corporations can and will be used to implement the present invention. Furthermore, it is to be understood that computer, computers, server in the claims infra also implied computer server, computer servers, virtual server, virtual servers so that, for example, computer-created, computer-generated, computer-automatically and computational processes, etc., infra are synonymous with or embody computer server-created, computer server-generated and computer server-automatically, virtual server-created, virtual server-generated and virtual server-automatically, server-computational processes and virtual server-computational processes, etc.

It is to be understood that the present invention provides a vast network or networks of computer servers and computers, laptops, televisions and mobile wireless communication devices for physicians and people in America and all nations on earth and in space to use the system and methods of the present invention to achieve the goals and objectives enabled and effected by the present invention. Compensations among said people—patients, physicians, companies and corporations, institutions and governments can be achieved in various and all international currencies a such as, but not limited to, American and Canadian dollars, Chinese Yuans, European euros, Japanese yens, Thai bahts, etc. and numerous systems of barters and exchanges of goods and services as commonly practices in international, national, global and Internet commerce.

Although various preferred embodiments and representations of the present invention have been described, it will be appreciated by those skilled in the art that adaptations, variations, derivatives and improvements of the present invention may be made including applications to other species, animals, biological entities or structures, infectious particles or structures, and machines without departing from the spirit of the invention and the scope of the claims.

1. A computer-server system for computer server-automatically, instantly and continually managing and monitoring diseases and disorders and quality, quantity and continuity of health, health-care and health-care services being provided and to be provided by individual physicians and physicians in individual groups of physicians and health-care providers to patients and individual patients related to individual diagnoses, individual syndromes or individual diagnoses in individual groups of related diagnoses in the SQL databases and tables in and manage by a SQL Server in a functioning and operating computer server or servers for said physicians and patients using computers, laptops and mobile wireless communication devices for accessing said servers in a network or networks of said servers and devices comprises:
said functioning and operating computer servers comprising said central processing units (CPU) or said processor units and memories, server operating systems, a Windows Server, Unix, Apache, VMware, said SQL Server, a Visual Studio and .Net, JavaScript, AJAX, HTML, XHTML, a Microsoft IIS, a Web server, computer scripting languages, PHP and the innovative computer programs and software for communicating with and commanding and instructing and coupled to said processor units, memories, SQL Server, said Web server, Web browsers, routers and modems, and teleconference-enabling, stream media-enabling and dynamic data-enabling programs and software programs and software in a network or networks of said computer servers and devices;
said devices comprising computers, laptops, wireless, mobile communication devices including smartphones possessing processor units, memories, keyboards for repetitively viewing, managing, expanding and inputting said information and data and for repetitively generating, manipulating, relating, updating, expanding and controlling said adaptable and expandable information and data in said SQL databases and tables, application software and said viewing screens including touch-sensitive or touch screens enabled by Web browsers, routers and modems for accessing said computer servers and application software for accessing applications and said system in said computer server or servers and teleconference-enabling, stream media-enabling and dynamic data-enabling programs and software henceforth devices for accessing said computer servers in a network or networks of said devices and computer servers by said devices in said network or networks of said devices and computer servers;
stored procedures and SQL in said SQL Server, coupled to said innovative computer programs and software and said processor units and memories and said computer scripting language, created by said innovative computer programs and software for configuring, creating, generating, expanding and adapting said SQL databases and tables, generating and creating individual unique relational SQL units and adaptable and expanding relations individual unique relational SQL units in and among said SQL databases and tables;
a plurality of computer server-executable algorithms for creating said system and the methods infra in said processor units and memories coupled to said SQL Server, according to said innovative computer programs and software, comprise at least:
i) a computer server-executable algorithm for server-automatically, instantly and repetitively scanning, matching correlating, collaborating and comparing individual words, terms, phrases, sentences, texts, synonyms, acronyms, numbers, data, graphics and any combinations thereof and related adjectives and variables henceforth words and terms in any or all said categories in individual inputs or queries repetitively generated and submitted to said processor units and memories by said individual physicians, physicians or said physicians in individual groups of physicians and health-care providers or said individual patients using said devices, with said individual unique relational SQL units in said individual relations of said individual unique relational SQL units in and among said SQL databases and tables, or vice versa;
ii) a computer server-executable algorithm for server-automatically, instantly and repetitively scanning, matching correlating, collaborating and comparing individual words and terms in any or all said categories related to individual diagnoses and individual patients in individual inputs repetitively generated and submitted to said processor units and memories by said individual physicians, physicians or said physicians in individual groups of physicians and health-care providers or individual patients using said devices, with said individual unique relational SQL units in said individual relations of said individual unique relational SQL units in and among said SQL databases and tables, or vice versa;
iii) a computer server-executable algorithm for server-automatically generating individual unique relational SQL units comprising related said words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to individual SQL keys in said SQL databases and tables in and manage by said SQL Server according to said innovative computer programs and software;
iv) a computer server-executable algorithm for server-automatically generating and expanding adaptable and expanding individual relations of said individual unique relational SQL units in and among said SQL databases and tables in and manage by said SQL Server, according to said innovative computer programs and software;
v) a computer server-executable algorithm for server-automatically, instantly and repetitively scanning, matching correlating, collaborating and comparing individual words and terms in any or all said categories related to individual diagnoses, individual patients and individual physicians, physicians or said physicians in individual groups of physicians and health-care providers in individual inputs repetitively generated and submitted to said processor units and memories by said individual physicians or said physicians and health-care providers or said individual patients using said devices, with said individual unique relational SQL units in said individual relations of said individual unique relational SQL units in and among said SQL databases and tables, or vice versa;
vi) a computer server-executable algorithm for repetitively scanning and checking for redundant duplicates or repeats, doubles in individual physicians' submissions related to individual diagnoses, individual syndromes or diagnoses in individual groups of diagnoses and related said categories in said processor units and memories and outputting said scans and matches to, related to individual SQL keys and compiled in said SQL databases and tables, for removing said redundant duplicates or repeats, doubles from said individual unique relational SQL units in said SQL databases and tables, for not inserting said redundant duplicates or repeats, doubles into said individual unique relational SQL units;
vii) a computer server-executable algorithm for server-automatically creating and repetitively generating and expanding individual unique relational SQL units comprising related said words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to individual SQL keys in said SQL databases and tables in and manage by said SQL Server;
viii) a computer server-executable algorithm for server-automatically creating and repetitively generating and expanding adaptable and expanding individual relations of said individual unique relational SQL units in and among said SQL databases and tables in and manage by said SQL Server;
ix) a computer server-executable algorithm for server-automatically and repetitively and continually patterning and standardizing said decision makings, judgements, determinations and executions on the productions and executions of said quality, quantity and continuity of health, health-care and health-care services, related to individual diagnoses, individual syndromes or individual diagnoses in individual groups of related diagnoses, being provided or to be provided to patients or individual patients by individual physicians or physicians in individual groups of physicians and health-care providers;
x) a computer server-executable algorithm for server-automatically and continually guiding, assisting and adapting decision makings, judgements, determinations and executions of said individual physicians and among physicians in said individual groups of physicians and individual patients impacting on the health, health-care and health-care services related to individual diagnoses, individual syndromes or individual diagnoses in individual groups of related diagnoses being provided or to be provided to patients or individual patients by individual physicians or physicians in individual groups of physicians and health-care providers and on the inputs of said decision makings, judgements, determinations and executions into said SQL databases and tables;
xi) a computer server-executable algorithm for server-automatically identifying, determining and displaying and warning of individual deficiencies, inconsistencies, faults and misses in said decision makings, judgements, determinations and executions of said health, health-care and health-care services related to any or all categories and related definitive or preliminary diagnoses represented by individual deficiencies, inconsistencies, faults and misses in said individual selections and keyboarded words and terms in said templates on said viewing screens referencing to and scanning, matching, correlating, collaborating and comparing with the pooled and compiled decision makings, judgements, determinations and executions on said health, health-care and health-care services related to individual diagnoses, individual syndromes or individual diagnoses in individual groups of related individual diagnoses or individual syndromes related to physicians related to SQL keys in said adaptable and expanding individual relations of said individual unique relational SQL units in and among said SQL databases and tables;
xii) a computer server-executable algorithm for server-automatically and continually managing and monitoring diseases and disorders and quality, quantity and continuity of health, health-care and health-care services, being provided and to be provided by physicians, said individual physicians, physicians in said individual groups of physicians and health-care providers to said individual patients and patients related to said diagnoses or individual diagnoses in individual groups of related diagnoses;
xiii) a computer server-executable algorithm for server-automatically, instantly and repetitively qualifying, regulating, generating, tallying and accounting individual payments for health-care and health-care services to individual physicians or health-care providers and proportional payments, distributions, adjustments, debits, redistributions and readjustments of payments in and among individual adaptable and expanding compositions of adaptable accounts of individual physicians in individual groups of physicians and health-care providers related to individual diagnoses or individual diagnoses in individual groups of related diagnoses and related health, health-care and health-care services in said categories provided to said individual patients by said individual groups of physicians and related individual disbursements relating and corresponding to said payments in individual adaptable and expanding compositions of adaptable accounts of said individual patients in the SQL databases and tables in and manage by a SQL server coupled to and enabled by said innovative computer programs and software in said computer server or servers viewable, manageable, adjustable and used by and interactive with said individual physicians and individual patients using said devices; and
xiv) computer server-executable algorithmic relations of said computer server-executable algorithms;
said innovative computer programs and software for:
i) commanding, instructing, enabling and effecting said computer server or servers to repetitively create, effect and enable said system and processes infra and for commanding, instructing, enabling and effecting said computer server or servers to repetitively and continually creating, generating, apply, adapting, expanding and improving the results and outcomes in said system and of processes infra;
ii) providing, commanding and instructing computer server or servers to execute and apply said computer server-executable algorithms for creating said system and the methods supra and infra in said processor units and memories coupled to said SQL Serve;
iii) creating, generating and displaying a plurality of individual interactive and adaptable related electronic templates, a plurality of interactive pop-up and/or drop-down lists and/or menus of interactive words and terms, and word and term headers or headings comprising information and data on and related to said diagnoses on diseases, disorders, health, health-care and health-care services and related categories of chief complaints, signs and symptoms, reviews of systems, physical examinations or findings, laboratory results, anatomical locations, anatomical sites and organ systems, diagnoses, differential diagnoses, treatments, assessments and plans, recommendations, advices, referrals and follow-ups henceforth information and data use by physicians of about 85 medical and surgical specialties and practices;
iv) managing related words and terms in all categories related to individual diagnoses used and use by physicians of all and diverse medical and surgical practices or specialties for and in the communications of said information and data among and between physicians and between and among physicians and patients and are integral components of electronic information and data on health, health-care and health-care-services in individual electronic medical records on or relating to said individual patients, generated and submitted to said processor units and memories and SQL Server comprising SQL databases and tables of said related words and terms in all categories related to individual diagnoses without redundant duplicates, repeats or doubles in said individual categories related to said individual diagnoses related to individual SQL keys in said SQL databases and tables;
v) managing related words and terms in all categories related to individual diagnoses, used and use by physicians of all and diverse medical and surgical practices or specialties for and in the communications of said information and data among and between physicians and between and among physicians and patients and are integral components of electronic information and data on health, health-care and health-care-services in individual electronic medical records on or relating to said individual patients, generated and submitted to said processor units and memories and SQL Server comprising SQL databases and tables of said related words and terms in all categories related to individual diagnoses without redundant duplicates, repeats or doubles in said individual categories related to said individual diagnoses in individual groups of related diagnoses and differential diagnoses related to individual SQL keys in said SQL databases and tables;
vi) managing said individual words and terms representing information and data on health, health-care and health-care services and related said individual diagnoses or said individual diagnoses in individual groups of related diagnoses continually and perpetually generated and submitted by said physicians and between and among said individual physicians in individual groups of physicians and adaptable and expanding editions of versions of said information and data on individual diagnoses or individual diagnoses in individual groups of related diagnoses of diseases and disorders and editions of related versions of information and data on related health-care and health-care services and editions of related versions of compositions of accounts and successive editions of related versions of information and data on individual diagnoses or individual diagnoses in individual groups of related diagnoses of diseases and disorders and successive editions of related versions of information and data on health, health-care and health-care services relating to said versions of diagnoses and successive editions of compositions of accounts by physicians and said computer, computer server or servers and manage by said SQL server;
vii) repetitively scanning and checking for redundant duplicates or repeats, doubles in individual physicians' submissions related to individual diagnoses, individual syndromes or diagnoses in individual groups of diagnoses and related said categories in said processor units and memories and outputting said scans and matches to, related to individual SQL keys and compiled in said SQL databases and tables, for removing said redundant duplicates or repeats, doubles from said individual unique relational SQL units in said SQL databases and tables, for not inserting said redundant duplicates or repeats, doubles into said individual unique relational SQL units, for creating, generating, adapting and maintaining for repetitively creating, generating, relating, compiling and applying said SQL databases and tables, relational SQL units and relations of said relational SQL units in and among said SQL databases and tables;
viii) creating, generating, expanding and improving SQL databases and tables comprising relational SQL keys related to said words and terms, headers and categories, physicians and patients in individual relational SQL units in said SQL databases and tables;
ix) creating, generating, adapting, relating, compiling and maintaining adaptable and expanding SQL relations comprising said individual unique relational SQL units in and among said SQL databases and tables in and manage by said SQL Server;
x) scanning and matching said individual words and terms in said processor units and memories and inputting into, relating said scanned and matched said individual words and terms and individual prices, monetary values or costs and compiled in said SQL databases and tables;
xi) generating said adaptable and expanding compositions of said scanned and matched words and terms related to said individual prices, monetary values or costs in related said adaptable and expanding compositions of said accounts in said SQL databases and tables in and manage by said SQL server;
xii) repetitively displaying, manipulating, modifying and editing said adaptable and expanding relational compositions of said individual scanned and matched words and terms and related individual prices, monetary values or costs in said SQL databases and tables by said individual physicians and by and among said individual physicians in individual groups of physicians and individual patients;
xiii) repetitively enabling and effecting computer-automatically and repetitively adjusting said relations of said scanned and matched words and terms words and terms and related individual prices, monetary values or costs for calculating, accounting and adjusting said payments to individual physicians and said proportional payments, distributions, adjustments, redistributions and readjustments of payments and debits in and among individual adaptable and expanding compositions of accounts of said individual physicians in individual groups of physicians; and related individual adaptable and expanding compositions of accounts of said individual patients comprising disbursements, relating and corresponding to said payments, and refunds or reimbursements relating or corresponding to deductions from said payments in said individual patients' accounts; and for repetitively composing said adaptable and expanding related accounts in said processor units and memories and outputted to said SQL databases and tables in and manage by said SQL server;
xiv) repetitively enabling and effecting computer-automatically and repetitively generating relations of said adaptable and expanding compositions on said relational words and terms and said adaptable and expanding compositions of accounts on said payments, proportional payments, distributions and redistributions, adjustments and readjustments of payments in and among said individual adaptable and expanding accounts of said individual physicians relating and corresponding to expenses, deductions, disbursements, refunds and reimbursements in said adaptable and expanding compositions of accounts of said individual patients in said SQL databases and tables in and manage by said SQL Server;
xv) repetitively enabling and effecting computer-automatically and repetitively modifying, editing, relations of said adaptable and expanding compositions of said words and terms and said adaptable and expanding compositions of said accounts in said SQL databases and tables in and manage by said SQL server;
xvi) repetitively enabling and effecting computer-automatically and repetitively generating adapting and expanding said SQL units, SQL relations of said SQL units in and among said SQL databases and tables, in and manage by said SQL Server;
xvii) server-automatically and continually guiding, assisting and adapting decision makings, judgements, determinations and executions of said individual physicians and among physicians in said individual groups of physicians and individual patients impacting on the health, health-care and health-care services related to individual diagnoses, individual syndromes or individual diagnoses in individual groups of related diagnoses being provided or to be provided to patients or individual patients by individual physicians or physicians in individual groups of physicians and health-care providers and on the inputs of said decision makings, judgements, determinations and executions into said SQL databases and tables;
xviii) server-automatically and repetitively and continually patterning and standardizing said decision makings, judgements, determinations and executions on the productions and executions of said quality, quantity and continuity of health, health-care and health-care services, related to individual diagnoses, individual syndromes or individual diagnoses in individual groups of related diagnoses, being provided or to be provided to patients or individual patients by individual physicians or physicians in individual groups of physicians and health-care providers;
xix) server-automatically and continually managing and monitoring diseases and disorders and quality, quantity and continuity of health, health-care and health-care services, being provided and to be provided by physicians, said individual physicians, physicians in said individual groups of physicians and health-care providers to said individual patients and patients related to said diagnoses or individual diagnoses in individual groups of related diagnoses;
xx) server-automatically and repetitively expressing and displaying said individual computer-generated results and outcomes of said scans, matches, correlations, collaborations and comparisons of said information and data in said processor units and memories for server-automatically and continually managing and monitoring diseases and disorders and quality, quantity and continuity of health, health-care and health-care services, being provided and to be provided by physicians, said individual physicians, physicians in said individual groups of physicians and health-care providers to said individual patients and patients related to said diagnoses or individual diagnoses in individual groups of related diagnoses, for and interactive with and said physicians and patients on said viewing screens of said devices;
xxi) server-automatically and continually qualifying and regulating payments for health-care and health-care services to individual physicians and proportional payments, distributions, adjustments, debits, redistributions and readjustments of payments in and among individual adaptable and expanding compositions of adaptable accounts of individual physicians in individual groups of physicians related to individual diagnoses or individual diagnoses in individual groups of related diagnoses and related health, health-care and health-care services provided to said individual patients by said individual groups of physicians and related individual disbursements relating and corresponding to said payments in individual adaptable and expanding compositions of adaptable accounts of said individual patients in the SQL databases and tables in and manage by a SQL server coupled to and enabled by said innovative computer programs and software in said computer server or servers viewable, manageable, adjustable and used by and interactive with said individual physicians and individual patients using said devices;
xxii) server-automatically, repetitively and continually expressions and displays of said adaptable and expanding individual relations of said individual unique relational SQL units in and among said SQL databases and tables in server-automatically generated and displayed interactive related electronic templates, HTML related Web pages and on interactive and related 2-dimensional and 3-dimensional, human figurines and images, graphics, charts, videos and as dynamic data, transactional data and streaming data and any combinations thereof and the like and derivatives on said viewing screens of said devices, enabled by said Internet Explorer and browsers and Web server devices and servers in said network or networks, being used by said patients and physicians; and
xxiii) server-automatically, repetitively and continually enabling and effecting the repetitive retrievals and uses of said relations of said adaptable and expanding compositions of said scanned and matched words and terms related to said individual prices, monetary values or costs in related said adaptable and expanding compositions of said accounts of said individual physicians and individual patients as revenues and earnings of said individual physicians and said individual physicians in individual groups of physicians representing said adaptable payments and proportional payments, distributions, adjustments, debits, readjustments and redistributions of proportional payments in and among said individual adaptable and expanding compositions of adaptable accounts of said individual physicians in individual groups of physicians and related and corresponding expenses, deductions, disbursements relating or corresponding to said payments, and refunds and reimbursements in said adaptable and expanding compositions of accounts of said individual patients in said SQL databases and tables on server-automatically generated and displayed interactive related electronic templates, HTML related Web pages and on interactive and related 2-dimensional and 3-dimensional, human figurines and images, graphics, charts, videos and as dynamic data, transactional data and streaming data and any combinations thereof and the like and derivatives on said viewing screens, by individual requests from said devices enabled by said Web browsers and Web server, by said individual physicians and individual patients;
said numerous interactive electronic templates for:
i) generating individual words and terms in any and all said categories representing information and data on health, health-care and health-care services on or relating to individual diagnoses, individual syndromes or individual diagnoses in individual groups of related diagnoses of diseases and disorders which are integral components of said health, health-care and health-care-service information and data on or relating to diseases and disorders and patients used and use by physicians of all and diverse medical and surgical practices or specialties for and in the communications of said information and data among and between physicians and between physicians and patients and related individual prices, monetary values or costs in said processor units and relating and compiling in said SQL databases and tables in and manage by said SQL Server;
ii) repetitively generating, displaying, manipulating, modifying and editing said words and terms relating to diagnoses continually and perpetually generated and submitted to said process units, memories and SQL databases and tables by said individual physicians, said individual physicians in individual groups of physicians and said individual patients related to individual diagnoses or individual diagnoses in individual groups of related diagnoses and related health, health-care and health-care services;
iii) repetitively managing said individual words and terms and related said individual diagnoses or said individual diagnoses in individual groups of related diagnoses continually and perpetually generated and submitted by said physicians and between and among said individual physicians in individual groups of physicians and adaptable and expanding editions of versions of said information and data on individual diagnoses or individual diagnoses in individual groups of related diagnoses of diseases and disorders and editions of related versions of information and data on related health-care and health-care services and editions of related versions of compositions of accounts and successive editions of related versions of information and data on individual diagnoses or individual diagnoses in individual groups of related diagnoses of diseases and disorders and successive editions of related versions of information and data on health, health-care and health-care services relating to said versions of diagnoses and successive editions of compositions of accounts by physicians and said computer, computer server or servers and manage by said SQL server;
iv) repetitively generating said individual words and terms representing information and data on health, health-care and health-care services and related said individual diagnoses or said individual diagnoses in individual groups of related diagnoses continually and perpetually generated and submitted by said physicians and between and among said individual physicians in individual groups of physicians and adaptable and expanding editions of versions of said information and data on individual diagnoses or individual diagnoses in individual groups of related diagnoses of diseases and disorders and editions of related versions of information and data on related health-care and health-care services and editions of related versions of compositions of accounts and successive editions of related versions of information and data on individual diagnoses or individual diagnoses in individual groups of related diagnoses of diseases and disorders and successive editions of related versions of information and data on health, health-care and health-care services relating to said versions of diagnoses and successive editions of compositions of accounts by physicians and said computer, computer server or servers and manage by said SQL server;
v) server-automatically and continually guiding, assisting and adapting decision makings, judgements, determinations and executions impacting on the health, health-care and health-care services, related to individual diagnoses, individual syndromes or individual diagnoses in individual groups of related diagnoses, being provided or to be provided to patients or individual patients by individual physicians or physicians in individual groups of physicians and health-care providers and the generations and inputs of information and data on said decision makings, judgements, determinations and executions into said SQL databases and tables;
vi) server-automatically and instantly identifying, determining and displaying and warning of individual deficiencies, inconsistencies, faults and misses in said decision makings, judgements, determinations and executions of said health, health-care and health-care services related to any or all categories and related definitive or preliminary diagnoses represented by individual deficiencies, inconsistencies, faults and misses in said individual selections and keyboarded words and terms in said templates on said viewing screens referencing to and scanning, matching, correlating, collaborating and comparing with the pooled and compiled decision makings, judgements, determinations and executions on said health, health-care and health-care services related to individual diagnoses, individual syndromes or individual diagnoses in individual groups of related individual diagnoses or individual syndromes related to physicians related to SQL keys in said adaptable and expanding individual relations of said individual unique relational SQL units in and among said SQL databases and tables;
vii) server-automatically, instantly and concomitantly compensating or correcting for or advising and providing options and alternatives to said individual deficiencies, inconsistencies, faults and misses, prior to the inputs of said selections or keyboarded words and terms, by retrieving from and displaying interactive words and terms in said adaptable and expanding individual relations of said individual unique relational SQL units in and among said SQL databases and tables on said viewing screens for said physicians or patients;
viii) submitting said selections, keyboarded words and terms and corrections and editions to said processor units, memories from which server-automatically and repetitively outputting said words and terms in any or all categories related to individual diagnoses, individual syndromes or diagnoses in individual groups of related diagnoses related to individual physicians and patients to relate and compile in said relational individual SQL units in said adaptable and expanding relations of SQL units in said SQL databases and tables in and manage by said SQL Server in said computer server or servers;
ix) server-automatically, repetitively and continually patterning and standardizing said decision makings, judgements, determinations and executions on the productions and executions of said quality, quantity and continuity of health, health-care and health-care services, related to individual diagnoses, individual syndromes or individual diagnoses in individual groups of related diagnoses, being provided or to be provided to patients or individual patients by individual physicians or physicians in individual groups of physicians and health-care providers;
x) said individual physicians or physicians in individual groups of physicians to repetitively relate individual patients or patients related to individual diagnoses, individual syndromes or diagnoses in individual groups of diagnoses and related said categories related to individual SQL keys to individual SQL keys related to individual physicians, physicians, health-care providers, or physicians in individual groups of physicians and health-care providers in said SQL databases and tables using said devices and said relations of physicians, patients and diagnoses related to said individual SQL keys are server-automatically, repetitively and continually retrieved and displayed on said viewing screens of said physicians and patients who viewed, interactive with, use and select said interactive displays on said viewing screens of said devices;
xi) server-automatically, repetitively and continually relating individual diagnoses, individual syndromes or diagnoses in individual groups of diagnoses and individual patients to individual physicians, physicians, health-care providers or physicians in individual groups of physicians and health-care providers related to said diagnoses related to individual SQL keys in said SQL databases and tables which are server-automatically, repetitively and continually retrieved and displayed on said viewing screens of said physicians and patients who viewed, interactive with, use and select said interactive displays on said viewing screens of said devices;
xii) server-automatically and repetitively selecting, retrieving and displaying adaptable and expanding compositions of said SQL relations of individual relational SQL units related to individual diagnoses, individual syndromes or diagnoses in individual groups of related diagnoses and related differential diagnoses and related categories and individual physicians or physicians in said individual groups of physicians and health-care providers related to said individual SQL keys in said SQL databases and tables on said viewing screens of said devices to individual patients and people;
xiii) repetitively displaying, manipulating, modifying and editing said adaptable and expanding relational compositions of said individual scanned and matched words and terms and related individual prices, monetary values or costs in said SQL databases and tables by said individual physicians and by and among said individual physicians in individual groups of physicians and individual patients;
xiv) repetitively enabling and effecting computer-automatically and repetitively generating relations of said adaptable and expanding compositions on said relational words and terms and said adaptable and expanding compositions of accounts on said payments, proportional payments, distributions and redistributions, adjustments and readjustments of payments in and among said individual adaptable and expanding accounts of said individual physicians relating and corresponding to expenses, deductions, disbursements, refunds and reimbursements in said adaptable and expanding compositions of accounts of said individual patients in said SQL databases and tables in and manage by said SQL Server;
xv) repetitively enabling and effecting computer-automatically and repetitively modifying, editing, relations of said adaptable and expanding compositions of said words and terms and said adaptable and expanding compositions of said accounts in said SQL databases and tables in and manage by said SQL server;
xvi) repetitively enabling and effecting computer-automatically and repetitively generating and expanding said SQL databases and tables, individual SQL units and relations of said SQL units in and among said SQL databases and tables in and manage by said SQL Server; and
xvii) server-automatically and repetitively expressing and displaying said individual computer-generated results and outcomes of said scans, matches, correlations, collaborations and comparisons of said information and data in said processor units and memories and in said SQL units and relations of said SQL units in and among said SQL databases and tables for server-automatically and continually managing and monitoring diseases and disorders and quality, quantity and continuity of health, health-care and health-care services, being provided and to be provided by physicians, said individual physicians, physicians in said individual groups of physicians and health-care providers to said individual patients and patients related to said diagnoses or individual diagnoses in individual groups of related diagnoses, for and interactive with and said physicians and patients on said viewing screens of said devices;
said SQL databases and tables comprise:
i) a process for generating and compiling individual words and terms in any and all said categories representing information and data on health, health-care and health-care services on or related to individual diagnoses, individual syndromes or individual diagnoses in individual groups of related diagnoses of diseases and disorders which are integral components of said health, health-care and health-care-service information and data on or related to diseases and disorders and patients used and use by physicians of all and diverse medical and surgical practices or specialties for and in the communications of said information and data among and between physicians and between physicians and patients and related individual prices, monetary values or costs in said processor units and memories and related to individual physicians and individual SQL keys and compiled in said SQL databases and tables in and manage by said SQL Server coupled to said processor units, memories and said innovative computer programs and software;
ii) adaptable and expanding compositions of said relational words and terms related to said individual diagnoses or individual diagnoses in individual groups related diagnoses, health, health-care and health-care services and individual physicians related to individual SQL keys in said SQL databases and tables;
iii) adaptable and expanding compositions of said scanned and matched words and terms related to said scanned and matched words and terms and individual prices, monetary values or costs in related said adaptable and expanding compositions of accounts of said individual physicians and individual patients related and compiled in said SQL databases and tables in and manage by said SQL server;
iv) individual unique relational SQL units comprising related said words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to individual SQL keys in said SQL databases and tables in and manage by said SQL Server;
v) adaptable and expanding individual relations of said individual unique relational SQL units in and among said SQL databases and tables in and manage by said SQL Server, according to said innovative computer programs and software; and
vi) adaptable and expanding accounting and tallies of adaptable revenues and earnings of said individual physicians and said individual physicians in individual groups of physicians comprising said payments to individual physicians and said proportional payments, distributions, adjustments, debits, redistributions and readjustments of payments in and among said individual adaptable and expanding compositions of adaptable accounts of individual physicians in individual groups of physicians, and said related individual disbursements relating and corresponding to said payments and related refunds or reimbursements relating or corresponding to deductions from said payments in said individual adaptable and expanding compositions of adaptable accounts of said individual patients according to the instructions and commands of said innovative computer programs and software for repetitively paying, proportionally paying, distributing, adjusting, debiting, readjusting and redistributing said proportional payments, calculating, tallying and accounting said revenues, earnings, disbursements, refunds, reimbursements in and among said individual adaptable and expanding compositions of adaptable accounts in said databases and tables;
individual unique relational SQL units comprising related said words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to individual SQL keys in said SQL databases and tables in and manage by said SQL Server;
adaptable and expanding individual relations of said individual unique relational SQL units in and among said SQL databases and tables in and manage by said SQL Server, according to said innovative computer programs and software;
computer server-generated correlations, collaborations and comparisons, scans and matches of information and data on health, health-care and health-care services related to individual diagnoses, individual syndromes or diagnoses in individual groups of relating diagnoses on and related to patients, physicians or individual patients related to physicians generated and inputted into the processor units and memories and SQL databases and tables in and manage by a SQL Server coupled to the innovative computer programs and software in a functioning and operating computer server or servers by individual physicians, physicians in individual groups of physicians and said individual patients using computers, laptops and mobile wireless communication devices for generating and inputting said information and data with individual groups of individual relational SQL units in said adaptable and expanding individual relations of said individual unique relational SQL units in and among said SQL databases and tables;
server-automatic qualifications and regulations of individual payments for health-care and health-care services to individual physicians and proportional payments, distributions, adjustments, debits, redistributions and readjustments of payments in and among individual adaptable and expanding compositions of adaptable accounts of individual physicians in individual groups of physicians and health-care providers related to individual diagnoses or individual diagnoses in individual groups of related diagnoses and related health, health-care and health-care services provided to said individual patients by said individual groups of physicians and related individual disbursements relating and corresponding to said payments in individual adaptable and expanding compositions of adaptable accounts of said individual patients in the SQL databases and tables in and manage by a SQL server coupled to and enabled by said innovative computer programs and software in said computer server or servers viewable, manageable, adjustable and used by and interactive with said individual physicians and individual patients using said devices;
server-automatic and repetitive expressions and displays of said individual computer-generated results and outcomes of said scans, matches, correlations, collaborations and comparisons of said information and data in said processor units and memories for server-automatically and continually managing and monitoring diseases and disorders and quality, quantity and continuity of health, health-care and health-care services, being provided and to be provided by physicians, said individual physicians, physicians in said individual groups of physicians and health-care providers to said individual patients and patients related to said diagnoses or individual diagnoses in individual groups of related diagnoses, for and interactive with and said physicians and patients on said viewing screens of said devices comprise server-automatic and repetitive expressions and displays of individual SQL relations of said individual SQL keys to physicians and patients; and
server-automatic and repetitive expressions and displays of said adaptable and expanding individual relations of said individual unique relational SQL units in and among said SQL databases and tables in server-automatically generated and displayed interactive related electronic templates, HTML related Web pages and on interactive and related 2-dimensional and 3-dimensional, human figurines and images, graphics, charts, videos and as dynamic data, transactional data and streaming data and any combinations thereof and the like and derivatives on said viewing screens of said devices, enabled by said Internet Explorer and browsers and Web server devices and servers in said network or networks, being used by said patients and physicians using said devices.

2. The computer-server system according to claim 1 wherein said individual unique relational SQL units comprising related said words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to individual SQL keys in said SQL databases and tables in and manage by said SQL Server comprises:
i) at least one of the anatomical sites tables, plurality of adjectives and variables tables, at least one past medical histories tables, plurality of diagnoses and syndromes tables, plurality of physicians and physicians' identities, practices and specialties tables and plurality of patients' identities tables;
ii) at least one of the anatomical sites tables, plurality of adjectives and variables tables, at least one past surgical histories tables, plurality of diagnoses and syndromes tables, plurality of physicians and physicians' identities, practices and specialties tables and plurality of patients' identities tables;
iii) at least one of the anatomical sites tables, plurality of adjectives and variables tables, at least one chief complaint table, causes, provocative, palliative, quality, quantity, duration tables, plurality of diagnoses and syndromes tables, plurality of physicians and physicians' identities, practices and specialties tables and plurality of patients' identities tables;
iv) at least one of the anatomical sites tables, plurality of adjectives and variables tables, at least one signs and symptoms table, causes, provocative, palliative, quality, quantity, duration tables, plurality of diagnoses and syndromes tables, plurality of physicians and physicians' identities, practices and specialties tables and plurality of patients' identities tables;
v) at least one of said anatomical sites tables, said plurality of adjectives and variables tables, plurality of allergies, food and chemical sensitivities tables, said plurality of diagnoses tables, said plurality of physicians and physicians' identities, practices and specialties tables and plurality of patients' identities tables;
vi) at least one of said anatomical sites tables, said plurality of adjectives and variables tables, plurality of family histories and genetics tables, said plurality of diagnoses tables, said plurality of physicians and physicians' identities, practices and specialties tables and plurality of patients' identities tables;
vii) at least one of said anatomical sites tables, said plurality of adjectives and variables tables, plurality of reviews of systems tables, said plurality of diagnoses tables, said plurality of physicians and physicians' identities, practices and specialties tables and plurality of patients' identities tables;
viii) at least one of said anatomical sites tables, said plurality of adjectives and variables tables, plurality of physical examinations tables, said plurality of diagnoses tables, said plurality of physicians and physicians' identities, practices and specialties tables and plurality of patients' identities tables;
ix) at least one of said anatomical sites tables, said plurality of adjectives and variables tables, plurality of laboratories and tests tables, said plurality of diagnoses tables, said plurality of physicians and physicians' identities, practices and specialties tables and plurality of patients' identities tables;
x) at least one of said anatomical sites tables, said plurality of adjectives and variables tables, plurality of medications, toxicology, pharmacology and pharmacokinetics including combined drug uses, drug side effects and interactions and managements and treatments tables, said plurality of diagnoses tables, said plurality of physicians and physicians' identities, practices and specialties tables and plurality of patients' identities tables;
xi) at least one of said anatomical sites tables, said plurality of adjectives and variables tables, said plurality diagnoses tables, said plurality of physicians and physicians' identities, practices and specialties tables and plurality of patients' identities tables;
xii) at least one of said anatomical sites tables, said plurality of adjectives and variables tables, said plurality diagnoses tables, plurality of differential diagnoses tables, said plurality of physicians and physicians' identities, practices and specialties tables and plurality of patients' identities tables;
xiii) at least one of said anatomical sites tables, said plurality of adjectives and variables tables, plurality infectious diseases tables, plurality of regions, localities, geography states and nations tables, a plurality of animals, insects, pests, vectors and reservoirs tables, travel histories tables, said plurality diagnoses tables, said plurality of differential diagnoses tables, said plurality of physicians and physicians' identities, practices and specialties tables and plurality of patients' identities tables;
xiv) at least one of said anatomical sites tables, said plurality of adjectives and variables tables, plurality infectious diseases tables, said plurality diagnoses tables, said plurality of differential diagnoses tables, said plurality of physicians and physicians' identities, practices and specialties tables and plurality of patients' identities tables;
xv) at least one of said anatomical sites tables, said plurality of adjectives and variables tables, plurality of assessments and plans tables, said plurality diagnoses tables, said plurality of differential diagnoses tables, said plurality of physicians and physicians' identities, practices and specialties tables and plurality of patients' identities tables;
xvi) at least one of said anatomical sites tables, said plurality of adjectives and variables tables, plurality of treatments tables, said plurality diagnoses tables, said plurality of differential diagnoses tables, said plurality of physicians and physicians' identities, practices and specialties tables and plurality of patients' identities tables;
xvi) at least one of said anatomical sites tables, said plurality of adjectives and variables tables, plurality of surgeries and procedures tables, said plurality diagnoses tables, said plurality of differential diagnoses tables, said plurality of physicians and physicians' identities, practices and specialties tables and plurality of patients' identities tables;
xvii) at least one of said anatomical sites tables, said plurality of adjectives and variables tables, plurality of recommendations tables, said plurality diagnoses tables, said plurality of differential diagnoses tables, said plurality of physicians and physicians' identities, practices and specialties tables and plurality of patients' identities tables;
xviii) at least one of said anatomical sites tables, said plurality of adjectives and variables tables, plurality of referrals tables, said plurality diagnoses tables, said plurality of differential diagnoses tables, said plurality of physicians and physicians' identities, practices and specialties tables and plurality of patients' identities tables;
xix) at least one of said anatomical sites tables, said plurality of adjectives and variables tables, plurality of follow-ups tables, said plurality diagnoses tables, said plurality of differential diagnoses tables, said plurality of physicians and physicians' identities, practices and specialties tables and plurality of patients' identities tables; and
xx) at least one of said anatomical sites tables, said plurality of adjectives and variables tables, at least one evaluations table, said plurality diagnoses tables, said plurality of differential diagnoses tables, said plurality of physicians and physicians' identities, practices and specialties tables and plurality of patients' identities tables.

3. The computer-server system according to claim 1 wherein said computer server-executable algorithm for server-automatically, instantly and repetitively scanning, matching correlating, collaborating and comparing individual words and terms in any or all said categories, repetitively generated and submitted to said processor units and memories by said individual physicians, physicians or said physicians in individual groups of physicians and health-care providers using said devices, with said individual unique relational SQL units in said individual relations of said individual unique relational SQL units in and among said SQL databases and tables, or vice versa, comprises one of the following representations:
i) computer server-automatic and sequential scans and matches words and terms representing signs and symptoms and causes, provocatives, palliatives, severity of signs and symptoms and temporal factors of said signs and symptoms, anatomical locations, anatomical sites in said individual inputs or queries with same, similar, equivalent or synonymous words and terms related to individual diagnoses, related to first individual groups of individual SQL keys in said individual relational SQL units in said SQL databases and tables, representing first information on individual diagnoses in said processor units and memories;
ii) computer server-automatic selections of matches of said words and terms in said individual inputs or queries and said words and terms in said individual relational SQL units and related to first individual SQL keys and words and terms representing a first information on individual diagnoses in said individual relational SQL units to be a first individual groups of words and terms and individual SQL keys representing said first information on individual diagnoses in said SQL diagnoses tables;
iii) computer server-automatic stores of said selections of said first individual groups of words and terms and said related individual SQL keys in said memories of said computer server or servers and said SQL databases and tables in said SQL Server;
iv) computer server-automatic first sequential scans and matches of said first individual groups of words and terms with second words and terms representing a second information on individual diagnoses in said relational SQL units comprising said second words and terms representing said second information on individual diagnoses in said diagnoses tables related to reviews of systems, anatomical locations, anatomical sites in said relational SQL units and in related reviews of systems, anatomical locations, anatomical sites tables and second sequential scans and matches of first words and terms in said individual relational SQL units representing anatomical sites, reviews of systems and anatomical locations with second words and terms representing reviews of systems, anatomical locations and anatomical sites in said individual inputs or queries of individuals or individual groups of people;
v) computer server-automatic selections of said matches of said first individual groups of words and terms and said second words and terms representing information on individual diagnoses represented by SQL keys in said relational SQL units related to said matches of said first and second words and terms representing reviews of systems, anatomical locations and anatomical sites;
vi) computer server-automatic stores of said matches of said first individual group of words and terms and said second individual group of words and terms representing information on individual diagnoses represented by SQL keys in said relational SQL units related to said matches of said first and second words and terms representing reviews of systems, anatomical locations and anatomical sites comprising a third individual group of words and terms and third group of individual SQL keys representing third information on individual diagnoses in said relational SQL units in said SQL databases and tables in said SQL Server;
vii) computer server-automatic first sequential scans and matches of said third individual groups of words and terms with fourth words and terms representing a fourth information on individual diagnoses in said relational SQL units comprising said fourth words and terms representing said fourth information on individual diagnoses in said diagnoses tables related to anatomical sites, physical examinations or findings and anatomical locations in said relational SQL units and in related physical examinations or findings, anatomical locations, anatomical sites tables and second sequential scans and matches of first words and terms in said individual relational SQL units representing anatomical sites, physical examinations or findings and anatomical locations with second words and terms representing anatomical sites, physical examinations or findings and anatomical locations in said individual inputs or queries of individuals or individual groups of people;
viii) computer server-automatic selections of said matches of said third individual groups of words and terms and said fourth individual groups of words and terms representing information on individual diagnoses represented by SQL keys in said relational SQL units related to said matches of said first and second words and terms representing physical examinations or findings, anatomical locations and anatomical sites;
ix) computer server-automatic stores of said matches of said third individual group of words and terms and said fourth individual group of words and terms representing information on individual diagnoses represented by SQL keys in said relational SQL units related to said matches of said first and second words and terms representing physical examinations or findings, anatomical locations and anatomical sites comprising a fourth individual group of words and terms and fourth group of individual SQL keys representing fourth information on individual diagnoses in said relational SQL units in said SQL databases and tables in said SQL Server;
x) computer server-automatic first sequential scans and matches of said fourth individual groups of words and terms with fifth words and terms representing a fifth information on individual diagnoses in said relational SQL units comprising said fifth words and terms representing said fifth information on individual diagnoses in said diagnoses tables related to anatomical sites or organ systems, laboratory results and anatomical locations in said relational SQL units and in related laboratory results, anatomical locations, anatomical sites and organ systems tables and second sequential scans and matches of first words and terms in said individual relational SQL units representing anatomical sites or organ systems, laboratory results and anatomical locations with second words and terms representing anatomical sites or organ systems, laboratory results and anatomical locations in said individual inputs or queries of individuals or individual groups of people;
xi) computer server-automatic selections of said matches of said fourth individual groups of words and terms and said fifth individual groups of words and terms representing information on individual diagnoses represented by SQL keys in said relational SQL units related to said matches of said first and second words and terms representing anatomical sites or organ systems, laboratory results and anatomical locations; and
xii) computer server-automatic stores of said matches of said fourth individual group of words and terms and said fifth individual group of words and terms representing information on individual diagnoses represented by SQL keys in said relational SQL units related to said matches of said first and second words and terms representing physical examinations or findings, anatomical locations and anatomical sites comprising a fifth individual group of words and terms and fifth group of individual SQL keys representing fifth information on individual diagnoses in said relational SQL units and represented by SQL keys in said SQL databases and tables in and manage by said SQL Server.

4. The computer-server system according to claim 1 wherein said adaptable and expanding individual relations of said individual unique relational SQL units in and among said SQL databases and tables in and manage by said SQL Server, according to said innovative computer programs and software comprise:
i) individual unique relational SQL units comprising related said words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to individual SQL keys in said SQL databases and tables in and manage by said SQL Server; and
ii) individual results and outcomes of said server-automatic and repetitive scans and matches, correlations, collaborations and comparisons of said individual words and terms in any and all said categories related to individual diagnoses or diagnoses in individual groups of related diagnoses related to individual physicians or physicians in individual groups of physicians and patients in individual inputs or queries repetitively generated and submitted to said processor units and memories by said physicians using said devices with said words and terms of said individual unique relational SQL units, or vice versa, in said processor units and memories and outputted to, related and compiled with said relational SQL units in said SQL databases and tables in and manage by said SQL Server, according to said innovative computer programs and software for commanding and instructing processor units and memories for processing said scans and matches of said words and terms and said scanned and matched words and terms in said relational SQL units in said SQL databases and tables according to said computer-executable algorithms.

5. The computer-server system according to claim 1 wherein said server-automatic and repetitive expressions and displays of said individual computer-generated results and outcomes of said correlations, collaborations and comparisons of said information and data in said processor units and memories for server-automatically and continually managing and monitoring diseases and disorders and quality, quantity and continuity of health, health-care and health-care services, being provided and to be provided by physicians, said individual physicians, physicians in said individual groups of physicians and health-care providers to said individual patients and patients related to said diagnoses or individual diagnoses in individual groups of related diagnoses, for and interactive with and said physicians and patients on said viewing screens of said devices comprise server-automatic and repetitive expressions and displays of said adaptable and expanding individual relations of said individual unique relational SQL units in and among said SQL databases and tables in and manage by said SQL Server to physicians and patients using said devices, said server-automatic and repetitive expressions and displays on said viewing screens according to said innovative computer programs and software, comprise:
i) anatomical sites, plurality of adjectives and variables, past medical histories, plurality of diagnoses, plurality of physicians and physicians' identities, practices and specialties and plurality of patients' identities;
ii) anatomical sites, plurality of adjectives and variables, past surgical histories, plurality of diagnoses, plurality of physicians and physicians' identities, practices and specialties and plurality of patients' identities;
iii) anatomical sites, plurality of adjectives and variables, chief complaint table, causes, provocative, palliative, quality, quantity, duration, plurality of diagnoses, plurality of physicians and physicians' identities, practices and specialties and plurality of patients' identities;
iv) anatomical sites, plurality of adjectives and variables, signs and symptoms table, causes, provocative, palliative, quality, quantity, duration, plurality of diagnoses, plurality of physicians and physicians' identities, practices and specialties and plurality of patients' identities;
v) said anatomical sites, said plurality of adjectives and variables, plurality of allergies, food and chemical sensitivities, said plurality of diagnoses, said plurality of physicians and physicians' identities, practices and specialties and plurality of patients' identities;
vi) said anatomical sites, said plurality of adjectives and variables, plurality of family histories and genetics, said plurality of diagnoses, said plurality of physicians and physicians' identities, practices and specialties and plurality of patients' identities;
vii) said anatomical sites, said plurality of adjectives and variables, plurality of reviews of systems, said plurality of diagnoses, said plurality of physicians and physicians' identities, practices and specialties and plurality of patients' identities;
viii) said anatomical sites, said plurality of adjectives and variables, plurality of physical examinations, said plurality of diagnoses, said plurality of physicians and physicians' identities, practices and specialties and plurality of patients' identities;
ix) said anatomical sites, said plurality of adjectives and variables, plurality of laboratories and tests, said plurality of diagnoses, said plurality of physicians and physicians' identities, practices and specialties and plurality of patients' identities;
x) said anatomical sites, said plurality of adjectives and variables, plurality of medications, toxicology, pharmacology and pharmacokinetics including combined drug uses, drug side effects and interactions and managements and treatments, said plurality of diagnoses, said plurality of physicians and physicians' identities, practices and specialties and plurality of patients' identities;
xi) said anatomical sites, said plurality of adjectives and variables, said plurality diagnoses, said plurality of physicians and physicians' identities, practices and specialties and plurality of patients' identities;
xii) said anatomical sites, said plurality of adjectives and variables, said plurality diagnoses, plurality of differential diagnoses, said plurality of physicians and physicians' identities, practices and specialties and plurality of patients' identities;
xiii) said anatomical sites, said plurality of adjectives and variables, plurality infectious diseases, plurality of regions, localities, geography states and nations, a plurality of animals, insects, pests, vectors and reservoirs, travel histories, said plurality diagnoses, said plurality of differential diagnoses, said plurality of physicians and physicians' identities, practices and specialties and plurality of patients' identities;
xiv) said anatomical sites, said plurality of adjectives and variables, plurality infectious diseases, said plurality diagnoses, said plurality of differential diagnoses, said plurality of physicians and physicians' identities, practices and specialties and plurality of patients' identities;
xv) said anatomical sites, said plurality of adjectives and variables, plurality of assessments and plans, said plurality diagnoses, said plurality of differential diagnoses, said plurality of physicians and physicians' identities, practices and specialties and plurality of patients' identities;
xvi) said anatomical sites, said plurality of adjectives and variables, plurality of treatments, said plurality diagnoses, said plurality of differential diagnoses, said plurality of physicians and physicians' identities, practices and specialties and plurality of patients' identities;
xvi) said anatomical sites, said plurality of adjectives and variables, plurality of surgeries and procedures, said plurality diagnoses, said plurality of differential diagnoses, said plurality of physicians and physicians' identities, practices and specialties and plurality of patients' identities;
xvii) said anatomical sites, said plurality of adjectives and variables, plurality of recommendations, said plurality diagnoses, said plurality of differential diagnoses, said plurality of physicians and physicians' identities, practices and specialties and plurality of patients' identities;
xviii) said anatomical sites, said plurality of adjectives and variables, plurality of referrals, said plurality diagnoses, said plurality of differential diagnoses, said plurality of physicians and physicians' identities, practices and specialties and plurality of patients' identities;
xix) said anatomical sites, said plurality of adjectives and variables, plurality of follow-ups, said plurality diagnoses, said plurality of differential diagnoses, said plurality of physicians and physicians' identities, practices and specialties and plurality of patients' identities; and
xx) said anatomical sites, said plurality of adjectives and variables, evaluations, said plurality diagnoses, said plurality of differential diagnoses, said plurality of physicians and physicians' identities, practices and specialties and plurality of patients' identities.

6. In a computer-server system for computer server-automatically, instantly and repetitively correlating, collaborating and comparing information and data on health, health-care and health-care services related to individual diagnoses, individual syndromes or diagnoses in individual groups of related diagnoses on and related to patients, physicians or individual patients related to physicians generated and inputted into the processor units and memories and SQL databases and tables in and manage by a SQL Server coupled to the innovative computer programs and software in a functioning and operating computer server or servers by individual physicians, physicians and health-care providers in individual groups of physicians and health-care providers and said individual patients, using computers, laptops and mobile wireless communication devices for generating and inputting said information and data in a network or networks of said computer servers and computers, laptops and mobile wireless communication devices being used by said physicians and patients, with individual groups of individual relational SQL units in said SQL databases and tables, a method for server-automatically and continually managing and monitoring diseases and disorders and quality, quantity and continuity of health, health-care and health-care services, being provided and to be provided by said individual physicians and said physicians in said individual groups of physicians and health-care providers to said patients related to said diagnoses, syndromes or individual diagnoses in individual groups of related diagnoses, for said physicians and patients comprises:
a process for operating said functioning and operating computer servers comprising said central processing units (CPU) or said processor units and memories, server operating systems, a Windows Server, Unix, Apache, VMware, said SQL Server, a Visual Studio and .Net, JavaScript, AJAX, HTML, XHTML, a Microsoft IIS, a Web server, computer scripting languages, PHP and the innovative computer programs and software for communicating with and commanding and instructing and coupled to said processor units, memories, SQL Server, said Web server, Web browsers, routers and modems, and teleconference-enabling, stream media-enabling and dynamic data-enabling programs and software programs and software in a network or networks of said computer servers and devices;
a process for operating and using said devices comprising computers, laptops, wireless, mobile communication devices including smartphones possessing processor units, memories, keyboards for repetitively viewing, managing, expanding and inputting said information and data and for repetitively generating, manipulating, relating, updating, expanding and controlling said adaptable and expandable information and data in said SQL databases and tables, application software and said viewing screens including touch-sensitive or touch screens enabled by Web browers, routers and modems for accessing said computer servers and application software for accessing applications and said system in said computer server or servers henceforth devices for accessing said computer servers in a network or networks of said devices and computer servers by said devices in said network or networks of said devices and computer servers;
a process for creating and applying stored procedures and SQL in said SQL Server, coupled to said innovative computer programs and software and said processor units and memories and said computer scripting language, created by said innovative computer programs and software for configuring, creating, generating, expanding and adapting said SQL databases and tables, generating and creating individual unique relational SQL units and adaptable and expanding relations individual unique relational SQL units in and among said SQL databases and tables;
a process for creating and computer-automatically and repetitively applying a plurality of computer server-executable algorithms for creating said system and the methods supra in said processor units, memories and said SQL Server, according to said innovative computer programs and software, comprise at least:
i) a computer server-executable algorithm for server-automatically generating individual unique relational SQL units comprising related said henceforth words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to individual SQL keys in said SQL databases and tables in and manage by said SQL Server;
ii) a computer server-executable algorithm for server-automatically, instantly and repetitively scanning, matching correlating, collaborating and comparing individual words and terms in any or all said categories in individual inputs or queries repetitively generated and submitted to said processor units and memories by said individual physicians, physicians or said physicians in individual groups of physicians and health-care providers or said individual patients using said devices, with said individual unique relational SQL units in said individual relations of said individual unique relational SQL units in and among said SQL databases and tables, or vice versa;
iii) a computer server-executable algorithm for server-automatically, instantly and repetitively scanning, matching correlating, collaborating and comparing individual words and terms in any or all said categories related to individual diagnoses and individual patients in individual inputs or queries repetitively generated and submitted to said processor units and memories by said individual physicians, physicians or said physicians in individual groups of physicians and health-care providers or individual patients using said devices, with said individual unique relational SQL units in said individual relations of said individual unique relational SQL units in and among said SQL databases and tables, or vice versa;
iv) a computer server-executable algorithm for server-automatically, instantly and repetitively scanning, matching correlating, collaborating and comparing individual words and terms in any or all said categories related to individual diagnoses, individual patients and individual physicians, physicians or said physicians in individual groups of physicians and health-care providers in individual inputs or queries repetitively generated and submitted to said processor units and memories by said individual physicians or said physicians and health-care providers or said individual patients using said devices, with said individual unique relational SQL units in said individual relations of said individual unique relational SQL units in and among said SQL databases and tables, or vice versa;
v) a computer server-executable algorithm for repetitively scanning and checking for redundant duplicates or repeats, doubles in individual physicians' submissions related to individual diagnoses, individual syndromes or diagnoses in individual groups of diagnoses and related said categories in said processor units and memories and outputting said scans and matches to, related to individual SQL keys and compiled in said SQL databases and tables, for removing said redundant duplicates or repeats, doubles from said individual unique relational SQL units in said SQL databases and tables, for not inserting said redundant duplicates or repeats, doubles into said individual unique relational SQL units;
vi) a computer server-executable algorithm for server-automatically creating and repetitively generating and expanding individual unique relational SQL units comprising related said words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to individual SQL keys in said SQL databases and tables in and manage by said SQL Server;
vii) a computer server-executable algorithm for server-automatically creating and repetitively generating and expanding adaptable and expanding individual relations of said individual unique relational SQL units in and among said SQL databases and tables in and manage by said SQL Server;
viii) a computer server-executable algorithm for server-automatically and repetitively and continually patterning and standardizing said decision makings, judgements, determinations and executions on the productions and executions of said quality, quantity and continuity of health, health-care and health-care services, related to individual diagnoses, individual syndromes or individual diagnoses in individual groups of related diagnoses, being provided or to be provided to patients or individual patients by individual physicians or physicians in individual groups of physicians and health-care providers;
ix) a computer server-executable algorithm for server-automatically identifying, determining and displaying and warning of individual deficiencies, inconsistencies, faults and misses in said decision makings, judgements, determinations and executions of said health, health-care and health-care services related to any or all categories and related definitive or preliminary diagnoses represented by individual deficiencies, inconsistencies, faults and misses in said individual selections and keyboarded words and terms in said templates on said viewing screens referencing to and scanning, matching, correlating, collaborating and comparing with the pooled and compiled decision makings, judgements, determinations and executions on said health, health-care and health-care services related to individual diagnoses, individual syndromes or individual diagnoses in individual groups of related individual diagnoses or individual syndromes related to physicians related to SQL keys in said adaptable and expanding individual relations of said individual unique relational SQL units in and among said SQL databases and tables;
x) a computer server-executable algorithm for server-automatically and continually guiding, assisting and adapting decision makings, judgements, determinations and executions of said individual physicians and among physicians in said individual groups of physicians and individual patients impacting on the health, health-care and health-care services related to individual diagnoses, individual syndromes or individual diagnoses in individual groups of related diagnoses being provided or to be provided to patients or individual patients by individual physicians or physicians in individual groups of physicians and health-care providers and on the inputs of said decision makings, judgements, determinations and executions into said SQL databases and tables;
xi) a computer server-executable algorithm for server-automatically and continually managing and monitoring diseases and disorders and quality, quantity and continuity of health, health-care and health-care services, being provided and to be provided by physicians, said individual physicians, physicians in said individual groups of physicians and health-care providers to said individual patients and patients related to said diagnoses or individual diagnoses in individual groups of related diagnoses;
xii) a computer server-executable algorithm for server-automatically, instantly and repetitively qualifying, regulating, generating, tallying and accounting individual payments for health-care and health-care services to individual physicians or health-care providers and proportional payments, distributions, adjustments, debits, redistributions and readjustments of payments in and among individual adaptable and expanding compositions of adaptable accounts of individual physicians in individual groups of physicians and health-care providers related to individual diagnoses or individual diagnoses in individual groups of related diagnoses and related health, health-care and health-care services in said categories provided to said individual patients by said individual groups of physicians and related individual disbursements relating and corresponding to said payments in individual adaptable and expanding compositions of adaptable accounts of said individual patients in the SQL databases and tables in and manage by a SQL Server coupled to and enabled by said innovative computer programs and software in said computer server or servers viewable, manageable, adjustable and used by and interactive with said individual physicians and individual patients using said devices; and
xiii) computer server-executable algorithmic relations or links of said computer server-executable algorithms;
a process for creating and applying said innovative computer programs and software for:
i) commanding, instructing, enabling and effecting said computer server or servers to repetitively create, effect and enable said system and the methods infra and for commanding, instructing, enabling and effecting said computer server or servers to repetitively and continually creating, generating, apply, adapting, expanding and improving the results and outcomes in said system and of the methods infra;
ii) providing, commanding and instructing computer server or servers to execute and apply said computer server-executable algorithms for creating said system and the methods infra in said processor units, memories and SQL Server;
iii) creating, generating and displaying a plurality of individual interactive and adaptable related electronic templates, a plurality of interactive pop-up and/or drop-down lists and/or menus of interactive words and terms and word and term headers or headings related to categories of chief complaints, signs and symptoms, reviews of systems, physical examinations or findings, laboratory results, anatomical locations, anatomical sites and organ systems, diagnoses, syndromes, related diagnoses and/or syndromes, differential diagnoses, genetics, family histories, travel histories, treatments, surgeries, procedures, assessments and plans, recommendations, advices, referrals and follow-ups and related adjectives and variables henceforth information and data use by physicians of about 85 medical and surgical specialties and practices;
iv) managing related words and terms in all categories related to individual diagnoses used and use by physicians of all and diverse medical and surgical practices or specialties for and in the communications of said information and data among and between physicians and between and among physicians and patients and are integral components of electronic information and data on health, health-care and health-care-services in individual electronic medical records on or relating to said individual patients, generated and submitted to said processor units and memories and SQL Server comprising SQL databases and tables of said related words and terms in all categories related to individual diagnoses without redundant duplicates, repeats or doubles in said individual categories related to said individual diagnoses related to individual SQL keys in said SQL databases and tables;
v) managing related words and terms in all categories related to individual diagnoses, used and use by physicians of all and diverse medical and surgical practices or specialties for and in the communications of said information and data among and between physicians and between and among physicians and patients and are integral components of electronic information and data on health, health-care and health-care-services in individual electronic medical records on or relating to said individual patients, generated and submitted to said processor units and memories and SQL Server comprising SQL databases and tables of said related words and terms in all categories related to individual diagnoses without redundant duplicates, repeats or doubles in said individual categories related to said individual diagnoses in individual groups of related diagnoses and differential diagnoses related to individual SQL keys in said SQL databases and tables;
vi) managing said individual words and terms representing information and data on health, health-care and health-care services and related said individual diagnoses or said individual diagnoses in individual groups of related diagnoses continually and perpetually generated and submitted by said physicians and between and among said individual physicians in individual groups of physicians and adaptable and expanding editions of versions of said information and data on individual diagnoses or individual diagnoses in individual groups of related diagnoses of diseases and disorders and editions of related versions of information and data on related health-care and health-care services and editions of related versions of compositions of accounts and successive editions of related versions of information and data on individual diagnoses or individual diagnoses in individual groups of related diagnoses of diseases and disorders and successive editions of related versions of information and data on health, health-care and health-care services relating to said versions of diagnoses and successive editions of compositions of accounts by physicians and said computer, computer server or servers and manage by said SQL server;
vii) repetitively scanning and checking for redundant duplicates or repeats, doubles in individual physicians' submissions related to individual diagnoses, individual syndromes or diagnoses in individual groups of diagnoses and related said categories in said processor units and memories and outputting said scans and matches to, related to individual SQL keys and compiled in said SQL databases and tables, for removing said redundant duplicates or repeats, doubles from said individual unique relational SQL units in said SQL databases and tables, for not inserting said redundant duplicates or repeats, doubles into said individual unique relational SQL units, for creating, generating, adapting and maintaining for repetitively creating, generating, relating, compiling and applying said SQL databases and tables, relational SQL units and relations of said relational SQL units in and among said SQL databases and tables;
viii) creating, generating, expanding and improving SQL databases and tables comprising relational SQL keys related to said words and terms, headers and categories, physicians and patients in individual relational SQL units in said SQL databases and tables;
ix) creating, generating, adapting, relating, compiling and maintaining adaptable and expanding SQL relations comprising said individual unique relational SQL units in and among said SQL databases and tables in and manage by said SQL Server;
x) scanning and matching said individual words and terms in said processor units and memories and inputting into, relating said scanned and matched said individual words and terms and individual prices, monetary values or costs and compiled in said SQL databases and tables;
xi) generating said adaptable and expanding compositions of said scanned and matched words and terms related to said individual prices, monetary values or costs in related said adaptable and expanding compositions of said accounts in said SQL databases and tables in and manage by said SQL server;
xii) repetitively displaying, manipulating, modifying and editing said adaptable and expanding relational compositions of said individual scanned and matched words and terms and related individual prices, monetary values or costs in said SQL databases and tables by said individual physicians and by and among said individual physicians in individual groups of physicians and individual patients;
xiii) repetitively enabling and effecting computer-automatically and repetitively adjusting said relations of said scanned and matched words and terms words and terms and related individual prices, monetary values or costs for calculating, accounting and adjusting said payments to individual physicians and said proportional payments, distributions, adjustments, redistributions and readjustments of payments and debits in and among individual adaptable and expanding compositions of accounts of said individual physicians in individual groups of physicians; and related individual adaptable and expanding compositions of accounts of said individual patients comprising disbursements, relating and corresponding to said payments, and refunds or reimbursements relating or corresponding to deductions from said payments in said individual patients' accounts; and for repetitively composing said adaptable and expanding related accounts in said processor units and memories and outputted to said SQL databases and tables in and manage by said SQL server;
xiv) repetitively enabling and effecting computer-automatically and repetitively generating relations of said adaptable and expanding compositions on said relational words and terms and said adaptable and expanding compositions of accounts on said payments, proportional payments, distributions and redistributions, adjustments and readjustments of payments in and among said individual adaptable and expanding accounts of said individual physicians relating and corresponding to expenses, deductions, disbursements, refunds and reimbursements in said adaptable and expanding compositions of accounts of said individual patients in said SQL databases and tables in and manage by said SQL Server;
xv) repetitively enabling and effecting computer-automatically and repetitively modifying, editing, relations of said adaptable and expanding compositions of said words and terms and said adaptable and expanding compositions of said accounts in said SQL databases and tables in and manage by said SQL server;
xvi) repetitively enabling and effecting computer-automatically and repetitively generating adapting and expanding said SQL units, SQL relations of said SQL units in and among said SQL databases and tables, in and manage by said SQL Server;
xvii) server-automatically and continually guiding, assisting and adapting decision makings, judgements, determinations and executions of said individual physicians and among physicians in said individual groups of physicians and individual patients impacting on the health, health-care and health-care services related to individual diagnoses, individual syndromes or individual diagnoses in individual groups of related diagnoses being provided or to be provided to patients or individual patients by individual physicians or physicians in individual groups of physicians and health-care providers and on the inputs of said decision makings, judgements, determinations and executions into said SQL databases and tables;
xviii) server-automatically and repetitively and continually patterning and standardizing said decision makings, judgements, determinations and executions on the productions and executions of said quality, quantity and continuity of health, health-care and health-care services, related to individual diagnoses, individual syndromes or individual diagnoses in individual groups of related diagnoses, being provided or to be provided to patients or individual patients by individual physicians or physicians in individual groups of physicians and health-care providers;
xix) server-automatically and continually managing and monitoring diseases and disorders and quality, quantity and continuity of health, health-care and health-care services, being provided and to be provided by physicians, said individual physicians, physicians in said individual groups of physicians and health-care providers to said individual patients and patients related to said diagnoses or individual diagnoses in individual groups of related diagnoses;
xx) server-automatically and repetitively expressing and displaying said individual computer-generated results and outcomes of said scans, matches, correlations, collaborations and comparisons of said information and data in said processor units and memories for server-automatically and continually managing and monitoring diseases and disorders and quality, quantity and continuity of health, health-care and health-care services, being provided and to be provided by physicians, said individual physicians, physicians in said individual groups of physicians and health-care providers to said individual patients and patients related to said diagnoses or individual diagnoses in individual groups of related diagnoses, for and interactive with and said physicians and patients on said viewing screens of said devices;
xxi) server-automatically and continually qualifying and regulating payments for health-care and health-care services to individual physicians and proportional payments, distributions, adjustments, debits, redistributions and readjustments of payments in and among individual adaptable and expanding compositions of adaptable accounts of individual physicians in individual groups of physicians related to individual diagnoses or individual diagnoses in individual groups of related diagnoses and related health, health-care and health-care services provided to said individual patients by said individual groups of physicians and related individual disbursements relating and corresponding to said payments in individual adaptable and expanding compositions of adaptable accounts of said individual patients in the SQL databases and tables in and manage by a SQL server coupled to and enabled by said innovative computer programs and software in said computer server or servers viewable, manageable, adjustable and used by and interactive with said individual physicians and individual patients using said devices;
xxii) server-automatically, repetitively and continually expressions and displays of said adaptable and expanding individual relations of said individual unique relational SQL units in and among said SQL databases and tables in server-automatically generated and displayed interactive related electronic templates, HTML related Web pages and on interactive and related 2-dimensional and 3-dimensional, human figurines and images, graphics, charts, videos and as dynamic data, transactional data and streaming data and any combinations thereof and the like and derivatives on said viewing screens of said devices, enabled by said Internet Explorer and browsers and Web server devices and servers in said network or networks, being used by said patients and physicians; and
xxiii) server-automatically, repetitively and continually enabling and effecting the repetitive retrievals and uses of said relations of said adaptable and expanding compositions of said scanned and matched words and terms related to said individual prices, monetary values or costs in related said adaptable and expanding compositions of said accounts of said individual physicians and individual patients as revenues and earnings of said individual physicians and said individual physicians in individual groups of physicians representing said adaptable payments and proportional payments, distributions, adjustments, debits, readjustments and redistributions of proportional payments in and among said individual adaptable and expanding compositions of adaptable accounts of said individual physicians in individual groups of physicians and related and corresponding expenses, deductions, disbursements relating or corresponding to said payments, and refunds and reimbursements in said adaptable and expanding compositions of accounts of said individual patients in said SQL databases and tables on server-automatically generated and displayed interactive related electronic templates, HTML related Web pages and on interactive and related 2-dimensional and 3-dimensional, human figurines and images, graphics, charts, videos and as dynamic data, transactional data and streaming data and any combinations thereof and the like and derivatives on said viewing screens, by individual requests from said devices enabled by said Web browsers and Web server, by said individual physicians and individual patients;
a process for using said numerous interactive electronic templates for:
i) generating individual words, terms, phrases, sentences, texts, synonyms, acronyms, numbers, data, graphics and any combinations thereof and related adjectives and variables henceforth words and terms in any and all said categories representing information and data on health, health-care and health-care services on or relating to individual diagnoses, individual syndromes or individual diagnoses in individual groups of related diagnoses of diseases and disorders which are integral components of said health, health-care and health-care-service information and data on or relating to diseases and disorders and patients used and use by physicians of all and diverse medical and surgical practices or specialties for and in the communications of said information and data among and between physicians and between physicians and patients and related individual prices, monetary values or costs in said processor units and relating and compiling in said SQL databases and tables in and manage by said SQL Server;
ii) repetitively generating, displaying, manipulating, modifying and editing said words and terms relating to diagnoses continually and perpetually generated and submitted to said process units, memories and SQL databases and tables by said individual physicians, said individual physicians in individual groups of physicians and said individual patients related to individual diagnoses or individual diagnoses in individual groups of related diagnoses and related health, health-care and health-care services;
iii) repetitively managing said individual words and terms and related said individual diagnoses or said individual diagnoses in individual groups of related diagnoses continually and perpetually generated and submitted by said physicians and between and among said individual physicians in individual groups of physicians and adaptable and expanding editions of versions of said information and data on individual diagnoses or individual diagnoses in individual groups of related diagnoses of diseases and disorders and editions of related versions of information and data on related health-care and health-care services and editions of related versions of compositions of accounts and successive editions of related versions of information and data on individual diagnoses or individual diagnoses in individual groups of related diagnoses of diseases and disorders and successive editions of related versions of information and data on health, health-care and health-care services relating to said versions of diagnoses and successive editions of compositions of accounts by physicians and said computer, computer server or servers and manage by said SQL server;
iv) repetitively generating said individual words and terms representing information and data on health, health-care and health-care services and related said individual diagnoses or said individual diagnoses in individual groups of related diagnoses continually and perpetually generated and submitted by said physicians and between and among said individual physicians in individual groups of physicians and adaptable and expanding editions of versions of said information and data on individual diagnoses or individual diagnoses in individual groups of related diagnoses of diseases and disorders and editions of related versions of information and data on related health-care and health-care services and editions of related versions of compositions of accounts and successive editions of related versions of information and data on individual diagnoses or individual diagnoses in individual groups of related diagnoses of diseases and disorders and successive editions of related versions of information and data on health, health-care and health-care services relating to said versions of diagnoses and successive editions of compositions of accounts by physicians and said computer, computer server or servers and manage by said SQL server;
v) server-automatically and continually guiding, assisting and adapting decision makings, judgements, determinations and executions impacting on the health, health-care and health-care services, related to individual diagnoses, individual syndromes or individual diagnoses in individual groups of related diagnoses, being provided or to be provided to patients or individual patients by individual physicians or physicians in individual groups of physicians and health-care providers and the generations and inputs of information and data on said decision makings, judgements, determinations and executions into said SQL databases and tables;
vi) server-automatically and instantly identifying, determining and displaying and warning of individual deficiencies, inconsistencies, faults and misses in said decision makings, judgements, determinations and executions of said health, health-care and health-care services related to any or all categories and related definitive or preliminary diagnoses represented by individual deficiencies, inconsistencies, faults and misses in said individual selections and keyboarded words and terms in said templates on said viewing screens referencing to and scanning, matching, correlating, collaborating and comparing with the pooled and compiled decision makings, judgements, determinations and executions on said health, health-care and health-care services related to individual diagnoses, individual syndromes or individual diagnoses in individual groups of related individual diagnoses or individual syndromes related to physicians related to SQL keys in said adaptable and expanding individual relations of said individual unique relational SQL units in and among said SQL databases and tables;
vii) server-automatically, instantly and concomitantly compensating or correcting for or advising and providing options and alternatives to said individual deficiencies, inconsistencies, faults and misses, prior to the inputs of said selections or keyboarded words and terms, by retrieving from and displaying interactive words and terms in said adaptable and expanding individual relations of said individual unique relational SQL units in and among said SQL databases and tables on said viewing screens for said physicians or patients;
viii) submitting said selections, keyboarded words and terms and corrections and editions to said processor units, memories from which server-automatically and repetitively outputting said words and terms in any or all categories related to individual diagnoses, individual syndromes or diagnoses in individual groups of related diagnoses related to individual physicians and patients to relate and compile in said relational individual SQL units in said adaptable and expanding relations of SQL units in said SQL databases and tables in and manage by said SQL in said computer server or servers;
ix) server-automatically, repetitively and continually patterning and standardizing said decision makings, judgements, determinations and executions on the productions and executions of said quality, quantity and continuity of health, health-care and health-care services, related to individual diagnoses, individual syndromes or individual diagnoses in individual groups of related diagnoses, being provided or to be provided to patients or individual patients by individual physicians or physicians in individual groups of physicians and health-care providers;
x) said individual physicians or physicians in individual groups of physicians to repetitively relate individual patients or patients related to individual diagnoses, individual syndromes or diagnoses in individual groups of diagnoses and related said categories related to individual SQL keys to individual SQL keys related to individual physicians, physicians, health-care providers, or physicians in individual groups of physicians and health-care providers in said SQL databases and tables using said devices and said relations of physicians, patients and diagnoses related to said individual SQL keys are server-automatically, repetitively and continually retrieved and displayed on said viewing screens of said physicians and patients who viewed, interactive with, use and select said interactive displays on said viewing screens of said devices;
xi) server-automatically, repetitively and continually relating individual diagnoses, individual syndromes or diagnoses in individual groups of diagnoses and individual patients to individual physicians, physicians, health-care providers or physicians in individual groups of physicians and health-care providers related to said diagnoses related to individual SQL keys in said SQL databases and tables which are server-automatically, repetitively and continually retrieved and displayed on said viewing screens of said physicians and patients who viewed, interactive with, use and select said interactive displays on said viewing screens of said devices;
xii) server-automatically and repetitively selecting, retrieving and displaying adaptable and expanding compositions of said SQL relations of individual relational SQL units related to individual diagnoses, individual syndromes or diagnoses in individual groups of related diagnoses and related differential diagnoses and related categories and individual physicians or physicians in said individual groups of physicians and health-care providers related to said individual SQL keys in said SQL databases and tables on said viewing screens of said devices to individual patients and people;
xiii) repetitively displaying, manipulating, modifying and editing said adaptable and expanding relational compositions of said individual scanned and matched words and terms and related individual prices, monetary values or costs in said SQL databases and tables by said individual physicians and by and among said individual physicians in individual groups of physicians and individual patients;
xiv) repetitively enabling and effecting computer-automatically and repetitively generating relations of said adaptable and expanding compositions on said relational words and terms and said adaptable and expanding compositions of accounts on said payments, proportional payments, distributions and redistributions, adjustments and readjustments of payments in and among said individual adaptable and expanding accounts of said individual physicians relating and corresponding to expenses, deductions, disbursements, refunds and reimbursements in said adaptable and expanding compositions of accounts of said individual patients in said SQL databases and tables in and manage by said SQL Server;
xv) repetitively enabling and effecting computer-automatically and repetitively modifying, editing, relations of said adaptable and expanding compositions of said words and terms and said adaptable and expanding compositions of said accounts in said SQL databases and tables in and manage by said SQL server;
xvi) repetitively enabling and effecting computer-automatically and repetitively generating and expanding said SQL databases and tables, individual SQL units and relations of said SQL units in and among said SQL databases and tables in and manage by said SQL Server; and
xvii) server-automatically and repetitively expressing and displaying said individual computer-generated results and outcomes of said scans, matches, correlations, collaborations and comparisons of said information and data in said processor units and memories and in said SQL units and relations of said SQL units in and among said SQL databases and tables for server-automatically and continually managing and monitoring diseases and disorders and quality, quantity and continuity of health, health-care and health-care services, being provided and to be provided by physicians, said individual physicians, physicians in said individual groups of physicians and health-care providers to said individual patients and patients related to said diagnoses or individual diagnoses in individual groups of related diagnoses, for and interactive with and said physicians and patients on said viewing screens of said devices;
a process for using and applying said SQL databases and tables comprise:
i) individual words, terms, phrases, sentences, texts, synonyms, acronyms, numbers, data, graphics and any combinations thereof and related adjectives and variables henceforth words and terms in any and all said categories representing information and data on health, health-care and health-care services on or relating to individual diagnoses, individual syndromes or individual diagnoses in individual groups of related diagnoses of diseases and disorders which are integral components of said health, health-care and health-care-service information and data on or relating to diseases and disorders and patients used and use by physicians of all and diverse medical and surgical practices or specialties for and in the communications of said information and data among and between physicians and between physicians and patients and related individual prices, monetary values or costs in said processor units and memories and related to individual SQL keys and compiled in said SQL databases and tables in and manage by said SQL Server;
ii) adaptable and expanding compositions of said relational words and terms related to said individual diagnoses or individual diagnoses in individual groups related diagnoses and related health, health-care and health-care services in said SQL databases and tables in and manage by said SQL Server coupled to said processor units and memories and said innovative computer programs and software;
iii) adaptable and expanding compositions of said scanned and matched words and terms related to said individual prices, monetary values or costs in related said adaptable and expanding compositions of said accounts of said individual physicians and individual patients related and compiled in said SQL databases in and manage by said SQL server;
iv) individual unique relational SQL units comprising related said words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to individual SQL keys in said SQL databases and tables in and manage by said SQL Server;
v) adaptable and expanding individual relations of said individual unique relational SQL units in and among said SQL databases and tables in and manage by said SQL Server, according to said innovative computer programs and software; and
vi) adaptable and expanding accounting and tallies of adaptable revenues and earnings of said individual physicians and said individual physicians in individual groups of physicians comprising said payments to individual physicians and said proportional payments, distributions, adjustments, debits, redistributions and readjustments of payments in and among said individual adaptable and expanding compositions of adaptable accounts of individual physicians in individual groups of physicians, and said related individual disbursements relating and corresponding to said payments and related refunds or reimbursements relating or corresponding to deductions from said payments in said individual adaptable and expanding compositions of adaptable accounts of said individual patients according to the instructions and commands of said innovative computer programs and software for repetitively paying, proportionally paying, distributing, adjusting, debiting, readjusting and redistributing said proportional payments, calculating, tallying and accounting said revenues, earnings, disbursements, refunds, reimbursements in and among said individual adaptable and expanding compositions of adaptable accounts in said databases and tables;
a process for generating, displaying and using a plurality of computer-generated relating interactive electronic templates for generating, relating, expanding and precisely managing individual adaptable, interactive and expanding compositions of said SQL information and data comprising said categories and related medical and surgical words and terms in all categories related to individual diagnoses representing information and data on individual diagnoses and related diseases, illnesses, health, health-care and health-care services in said SQL and means for keyboarding said medical and surgical words and terms in all categories related to individual diagnoses by said physicians and individual patients, upon requests by said devices, retrievable, viewable and manipulated and used in said viewing screens of said devices effected and enabled by said JavaScript, HTML, PHP and Internet Explorer and Web browsers in said network or networks and by said physicians and individual patients;
a process for repetitively creating and generating related words and terms in said categories related to individual diagnoses which are integral components of electronic information and data on health, health-care and health-care-services in individual electronic medical records, on or relating to individual patients, generated and submitted to said processor units and memories by said physicians or physicians in individual groups of physicians or individual patients using said interactive electronic templates viewable and interactive with said physicians and patients on said viewing screens in said devices for accessing said computer servers;
a process for computer server-automatically creating, generating, compiling, expanding and managing individual unique relational SQL units comprising individual unique relational SQL units comprising related said related said words, terms, phrases, sentences, texts, synonyms, acronyms, texts, numbers, data, graphics and any combinations thereof and related adjectives and variables henceforth words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to individual SQL keys in said SQL databases and tables in and manage by said SQL Server;
a process for computer server-automatically creating, generating, expanding, managing and applying adaptable and expanding individual relations of said individual unique relational SQL units in and among said SQL databases and tables in and manage by said SQL Server, according to said innovative computer programs and software;
a process for submitting said selections, keyboarded words and terms and corrections and editions to said processor units, memories from which server-automatically and repetitively outputting said words and terms in any or all categories related to individual diagnoses or diagnoses in individual groups of related diagnoses related to individual physicians and patients to relate and compile in said relational individual SQL units in said adaptable and expanding relations of SQL units in said SQL databases and tables in and manage by said SQL in said computer server or servers;
a process for server-automatically and continually guiding, assisting and adapting decision makings, judgements, determinations and executions of said individual physicians and among physicians in said individual groups of physicians and individual patients impacting on the health, health-care and health-care services related to individual diagnoses, individual syndromes or individual diagnoses in individual groups of related diagnoses being provided or to be provided to patients or individual patients by individual physicians or physicians in individual groups of physicians and health-care providers and on the inputs of said decision makings, judgements, determinations and executions into said SQL databases and tables;
a process for server-automatically, repetitively and continually patterning and standardizing said decision makings, judgements, determinations and executions on the productions and executions of said quality, quantity and continuity of health, health-care and health-care services, related to individual diagnoses, individual syndromes or individual diagnoses in individual groups of related diagnoses, being provided or to be provided to patients or individual patients by individual physicians or physicians in individual groups of physicians and health-care providers;
a process for server-automatically and repetitively expressing and displaying said individual computer-generated results and outcomes of said scans, matches, correlations, collaborations and comparisons of said information and data in said processor units and memories for server-automatically and continually managing and monitoring diseases and disorders and quality, quantity and continuity of health, health-care and health-care services, being provided and to be provided by physicians, said individual physicians, physicians in said individual groups of physicians and health-care providers to said individual patients and patients related to said diagnoses or individual diagnoses in individual groups of related diagnoses, for and interactive with and said physicians and patients on said viewing screens of said devices;
a process for server-automatically and continually qualifying and regulating payments for health-care and health-care services to individual physicians and proportional payments, distributions, adjustments, debits, redistributions and readjustments of payments in and among individual adaptable and expanding compositions of adaptable accounts of individual physicians in individual groups of physicians related to individual diagnoses or individual diagnoses in individual groups of related diagnoses and related health, health-care and health-care services provided to said individual patients by said individual groups of physicians and related individual disbursements relating and corresponding to said payments in individual adaptable and expanding compositions of adaptable accounts of said individual patients in the SQL databases and tables in and manage by a SQL server coupled to and enabled by said innovative computer programs and software in said computer server or servers viewable, manageable, adjustable and used by and interactive with said individual physicians and individual patients using said devices; and
a process for server-automatically, repetitively and continually expressions and displays of said adaptable and expanding individual relations of said individual unique relational SQL units in and among said SQL databases and tables in server-automatically generated and displayed interactive related electronic templates, HTML related Web pages and on interactive and related 2-dimensional and 3-dimensional, human figurines and images, graphics, charts, videos and as dynamic data, transactional data and streaming data and any combinations thereof and the like and derivatives on said viewing screens of said devices, enabled by said Internet Explorer and browsers and Web server devices and servers in said network or networks, being used by said patients and physicians using said devices.

7. The method for server-automatically and continually managing and monitoring diseases and disorders and quality, quantity and continuity of health, health-care and health-care services according to claim 6 wherein said process for computer server-automatically creating, generating, compiling, expanding and managing individual unique relational SQL units comprising related said words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to individual SQL keys in said SQL databases and tables in and manage by said SQL Server according to said innovative computer programs and software comprises:
i) a process for creating and generating individual electronic files comprising said words and terms in any and all said categories or headings related to individual diagnoses or individual diagnoses in individual groups of related diagnoses generated by physicians;
ii) a process for repetitively pointing with mice and/or fingers, clicking and selecting said interactive words and terms in any or all categories related to individual diagnoses in said related templates on said viewing screens by said physicians or patients using said devices;
iii) a process for keyboarding words and terms in any or all categories related to individual diagnoses into said related templates by said physicians or patients using said devices;
iv) a process for repetitively creating and generating said words and terms in said categories related to individual diagnoses which are integral components of electronic information and data on health, health-care and health-care-services in individual electronic medical records, on or relating to individual patients, generated and submitted to said processor units and memories by said physicians using said devices; and
v) a process for server-automatically, instantly and repetitively scanning, matching correlating, collaborating and comparing said selections, keyboarded and submitted words and terms with same, similar, synonymous or equivalent words and terms in any and all categories related to individual diagnoses in said adaptable and expanding individual relations of said individual unique relational SQL units in and among said SQL databases and tables in and manage by said SQL Server in said processor units and memories from which, consequently, outputting said scanned words and terms in all categories comprising no redundant duplicates, repeats or doubles in said categories related to individual diagnoses into, related to individual SQL keys compiled in said SQL databases and tables in and manage by said SQL Server; and
vi) a process for server-automatically, instantly and repetitively scanning, matching correlating, collaborating and comparing said selections, keyboarded and submitted words and terms with same, similar, synonymous or equivalent words and terms in any and all categories related to individual diagnoses in said adaptable and expanding individual relations of said individual unique relational SQL units in and among said SQL databases and tables in and manage by said SQL Server in said processor units and memories from which, consequently, for removing said redundant duplicates or repeats, doubles from said individual unique relational SQL units in said SQL databases and tables or for not inserting said redundant duplicates or repeats, doubles into said individual unique relational SQL units, for creating, generating, adapting and maintaining relational SQL units in said SQL databases and tables in and manage by said SQL Server.

8. The method for server-automatically and continually managing and monitoring diseases and disorders and quality, quantity and continuity of health, health-care and health-care services, being provided and to be provided by said individual physicians and said physicians in said individual groups of physicians and health-care providers to said individual patients and patients related to said diagnoses, syndromes or individual diagnoses in individual groups of related diagnoses, for said physicians and patients according to claim 6 wherein said process for computer server-automatically creating, generating, expanding, managing and applying adaptable and expanding individual relations of said individual unique relational SQL units in and among said SQL databases and tables in and manage by said SQL Server, according to said innovative computer programs and software comprises:
i) a process for computer server-automatically creating, generating, compiling, expanding and managing individual unique relational SQL units comprising related said words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to individual SQL keys in said SQL databases and tables in and manage by said SQL Server; and
ii) a process for computer server-automatically creating, generating, compiling, expanding and managing individual results and outcomes of said server-automatic and repetitive scans and matches, correlations, collaborations and comparisons of said individual words and terms in any and all said categories related to individual diagnoses or diagnoses in individual groups of related diagnoses related to individual physicians or physicians in individual groups of physicians and patients in individual inputs or queries repetitively generated and submitted to said processor units and memories by said physicians using said devices with said words and terms of said individual unique relational SQL units, or vice versa, in said processor units and memories and outputted to, related and compiled with said relational SQL units in said SQL databases and tables in and manage by said SQL Server, according to said innovative computer programs and software for commanding and instructing processor units and memories for processing said scans and matches of said words and terms and said scanned and matched words and terms in said relational SQL units in said SQL databases and tables according to said computer-executable algorithms.

9. The method according to claim 6 wherein said server-automatically and repetitively selecting, retrieving and displaying adaptable and expanding compositions of said SQL relations of individual relational SQL units related to individual diagnoses, individual syndromes or diagnoses in individual groups of related diagnoses and related differential diagnoses and related categories and individual physicians or physicians in said individual groups of physicians and health-care providers related to said individual SQL keys in said SQL databases and tables on said viewing screens of said devices to individual patients and people comprises a process for server-automatically and repetitively expressing and displaying adaptable and expanding individual relations of said individual relational SQL units, related to said diagnoses or individual diagnoses in individual groups of related diagnoses and categories related to individual physicians, physicians in said individual groups of physicians and health-care providers related to individual SQL keys in said SQL databases and tables, on said viewing screens of said devices being used by and interactive with said individual physicians, physicians in individual groups of physicians, patients, individual patients and patients, comprising any, varying combinations or all of:
i) anatomical sites, plurality of adjectives and variables, past medical histories, plurality of diagnoses, plurality of physicians and physicians' identities, practices and specialties and plurality of patients' identities;
ii) anatomical sites, plurality of adjectives and variables, past surgical histories, plurality of diagnoses, plurality of physicians and physicians' identities, practices and specialties and plurality of patients' identities;
iii) anatomical sites, plurality of adjectives and variables, chief complaints, causes, provocative, palliative, quality, quantity, duration, plurality of diagnoses, plurality of physicians and physicians' identities, practices and specialties and plurality of patients' identities;
iv) anatomical sites, plurality of adjectives and variables, signs and symptoms, causes, provocative, palliative, quality, quantity, duration, plurality of diagnoses, plurality of physicians and physicians' identities, practices and specialties and plurality of patients' identities;
v) said anatomical sites, said plurality of adjectives and variables, plurality of allergies, food and chemical sensitivities, said plurality of diagnoses, said plurality of physicians and physicians' identities, practices and specialties and plurality of patients' identities;
vi) said anatomical sites, said plurality of adjectives and variables, plurality of family histories and genetics, said plurality of diagnoses, said plurality of physicians and physicians' identities, practices and specialties and plurality of patients' identities;
vii) said anatomical sites, said plurality of adjectives and variables, plurality of reviews of systems, said plurality of diagnoses, said plurality of physicians and physicians' identities, practices and specialties and plurality of patients' identities;
viii) said anatomical sites, said plurality of adjectives and variables, plurality of physical examinations, said plurality of diagnoses, said plurality of physicians and physicians' identities, practices and specialties and plurality of patients' identities;
ix) said anatomical sites, said plurality of adjectives and variables, plurality of laboratories and tests, said plurality of diagnoses, said plurality of physicians and physicians' identities, practices and specialties and plurality of patients' identities;
x) said anatomical sites, said plurality of adjectives and variables, plurality of medications, toxicology, pharmacology and pharmacokinetics including combined drug uses, drug side effects and interactions and managements and treatments, said plurality of diagnoses, said plurality of physicians and physicians' identities, practices and specialties and plurality of patients' identities;
xi) said anatomical sites, said plurality of adjectives and variables, said plurality diagnoses, said plurality of physicians and physicians' identities, practices and specialties and plurality of patients' identities;
xii) said anatomical sites, said plurality of adjectives and variables, said plurality diagnoses, plurality of differential diagnoses, said plurality of physicians and physicians' identities, practices and specialties and plurality of patients' identities;
xiii) said anatomical sites, said plurality of adjectives and variables, plurality infectious diseases, plurality of regions, localities, geography states and nations, a plurality of animals, insects, pests, vectors and reservoirs, travel histories, said plurality diagnoses, said plurality of differential diagnoses, said plurality of physicians and physicians' identities, practices and specialties and plurality of patients' identities;
xiv) said anatomical sites, said plurality of adjectives and variables, plurality infectious diseases, said plurality diagnoses, said plurality of differential diagnoses, said plurality of physicians and physicians' identities, practices and specialties and plurality of patients' identities;
xv) said anatomical sites, said plurality of adjectives and variables, plurality of assessments and plans, said plurality diagnoses, said plurality of differential diagnoses, said plurality of physicians and physicians' identities, practices and specialties and plurality of patients' identities;
xvi) said anatomical sites, said plurality of adjectives and variables, plurality of treatments, said plurality diagnoses, said plurality of differential diagnoses, said plurality of physicians and physicians' identities, practices and specialties and plurality of patients' identities;
xvi) said anatomical sites, said plurality of adjectives and variables, plurality of surgeries and procedures, said plurality diagnoses, said plurality of differential diagnoses, said plurality of physicians and physicians' identities, practices and specialties and plurality of patients' identities;
xvii) said anatomical sites, said plurality of adjectives and variables, plurality of recommendations, said plurality diagnoses, said plurality of differential diagnoses, said plurality of physicians and physicians' identities, practices and specialties and plurality of patients' identities;
xviii) said anatomical sites, said plurality of adjectives and variables, plurality of referrals, said plurality diagnoses, said plurality of differential diagnoses, said plurality of physicians and physicians' identities, practices and specialties and plurality of patients' identities;
xix) said anatomical sites, said plurality of adjectives and variables, plurality of follow-ups, said plurality diagnoses, said plurality of differential diagnoses, said plurality of physicians and physicians' identities, practices and specialties and plurality of patients' identities; and
xx) said anatomical sites, said plurality of adjectives and variables, evaluations, said plurality diagnoses, said plurality of differential diagnoses, said plurality of physicians and physicians' identities, practices and specialties and plurality of patients' identities.
xiv) a process for server-automatically guiding and adapting said decision makings, judgements, determinations and executions and impacting comprising said SQL databases and tables, said adaptable and expanding relations of SQL units in said SQL databases in and manage by said SQL in said computer server or servers.

10. The method according to claim 6 wherein said process for server-automatically and continually guiding, assisting and adapting decision makings, judgements, determinations and executions of said individual physicians and among physicians in said individual groups of physicians and individual patients impacting on the health, health-care and health-care services related to individual diagnoses, individual syndromes or individual diagnoses in individual groups of related diagnoses being provided or to be provided to patients or individual patients by individual physicians or physicians in individual groups of physicians and health-care providers and on the inputs of said decision makings, judgements, determinations and executions into said SQL databases and tables comprises:
i) a process for repetitively, displaying, viewing and using server-generated electronic related templates of numerous related Web pages on said viewing screens comprising drop-down or pop-up templates of lists of interactive related words, terms, phrases, sentences, texts, synonyms, acronyms, texts, numbers, data, graphics and any combinations thereof and related adjectives and variables henceforth words and terms in any or all categories and related individual diagnoses or individual syndromes in said adaptable and expanding individual relations of said individual unique relational SQL units in and among said SQL databases and tables in and manage by said SQL Server by said physicians or patients using said devices;
ii) a process for repetitively pointing with mice and/or fingers, clicking and selecting said interactive words and terms in any or all categories related to individual diagnoses or individual syndromes in said related templates on said viewing screens by said physicians or patients using said devices and/or a process for keyboarding words and terms in any or all categories related to individual diagnoses or individual syndromes into said related templates by said physicians or patients using said devices for repetitively creating and generating said individual words and representing information and data on health, health-care and health-care services on or relating to individual diagnoses or individual diagnoses in individual groups of related diagnoses of diseases and disorders and related health, health-care and health-care services which are integral components of said health, health-care and health-care-service information and data on or relating to diseases and disorders and patients used and use by physicians of all and diverse medical and surgical practices or specialties for and in the communications of said information and data among and between physicians and between physicians and patients and related to individual prices, monetary values or costs in said processor units and outputted, related and compiled in said SQL databases in and manage by said SQL Server;
iii) a process for repetitively pointing with mice and/or fingers, clicking and selecting said interactive words and terms in any or all categories related to individual diagnoses or individual syndromes in said related templates on said viewing screens by said physicians or patients using said devices and/or a process for keyboarding words and terms in any or all categories related to individual diagnoses or individual syndromes into said related templates by said physicians or patients using said devices for repetitively creating and generating words and terms in said categories related to individual diagnoses or individual syndromes which are integral components of electronic information and data on health, health-care and health-care-services in individual electronic medical records, on or relating to individual patients, generated and submitted to said processor units and memories by said physicians;
iv) a process for repetitively generating said individual words and terms representing information and data on health, health-care and health-care services and related said individual diagnoses or said individual diagnoses in individual groups of related diagnoses continually and perpetually generated and submitted by said physicians and between and among said individual physicians in individual groups of physicians and adaptable and expanding editions of versions of said information and data on individual diagnoses or individual diagnoses in individual groups of related diagnoses of diseases and disorders and editions of related versions of information and data on related health-care and health-care services and editions of related versions of compositions of accounts and successive editions of related versions of information and data on individual diagnoses or individual diagnoses in individual groups of related diagnoses of diseases and disorders and successive editions of related versions of information and data on health, health-care and health-care services relating to said versions of diagnoses and successive editions of compositions of accounts by physicians and said computer, computer server or servers and manage by said SQL server;
v) a process for server-automatically and instantly identifying, determining and displaying and warning of individual deficiencies, inconsistencies, faults and misses in said decision makings, judgements, determinations and executions of said health, health-care and health-care services related to any or all categories and related definitive or preliminary diagnoses represented by individual deficiencies, inconsistencies, faults and misses in said individual selections and keyboarded words and terms in said templates on said viewing screens referencing to and correlating, collaborating and comparing with the pooled and compiled decision makings, judgements, determinations and executions on said health, health-care and health-care services related to individual diagnoses, individual syndromes or individual diagnoses in individual groups of related individual diagnoses or individual syndromes related to physicians related to SQL keys in said adaptable and expanding individual relations of said individual unique relational SQL units in and among said SQL databases and tables;
vi) a process for server-automatically, instantly and concomitantly compensating or correcting for or advising and providing options and alternatives to said individual deficiencies, inconsistencies, faults and misses, prior to the inputs of said selections or keyboarded words and terms, by retrieving from and displaying interactive words and terms in said adaptable and expanding individual relations of said individual unique relational SQL units in and among said SQL databases and tables on said viewing screens for said physicians or patients;
vii) a process for submitting said selections, keyboarded words and terms and corrections and editions to said processor units, memories from which server-automatically and repetitively outputting said words and terms in any or all categories related to individual diagnoses, individual syndromes or diagnoses in individual groups of related diagnoses related to individual physicians and patients to relate and compile in said relational individual SQL units in said adaptable and expanding relations of SQL units in said SQL databases and tables in and manage by said SQL in said computer server or servers; and, consequently,
viii) a process for computer-automatically and repetitively applying said plurality of computer server-executable algorithms;
ix) a process for server-automatically, instantly and repetitively scanning, matching correlating, collaborating and comparing individual words and terms in any or all said categories in individual inputs or queries repetitively generated and submitted to said processor units and memories by said individual physicians, physicians or said physicians in individual groups of physicians and health-care providers or said individual patients using said devices, with same, similar, synonymous or equivalent words and terms in any or all categories related to individual diagnoses or individual syndromes in said individual unique relational SQL units in said individual relations of said individual unique relational SQL units in and among said SQL databases and tables, or vice versa; and, consequently,
x) a process for server-automatically, instantly and repetitively scanning, matching, correlating, collaborating and comparing individual words and terms in any or all said categories related to individual diagnoses or individual syndromes and individual patients in individual inputs repetitively generated and submitted to said processor units and memories by said individual physicians, physicians or said physicians in individual groups of physicians and health-care providers or individual patients using said devices, with said individual unique relational SQL units in said individual relations of said individual unique relational SQL units in and among said SQL databases and tables, or vice versa;
xi) a process for server-automatically, instantly and repetitively scanning, matching, correlating, collaborating and comparing individual words and terms in any or all said categories related to individual diagnoses or individual syndromes, individual patients and individual physicians, physicians or said physicians in individual groups of physicians and health-care providers in individual inputs repetitively generated and submitted to said processor units and memories by said individual physicians or said physicians and health-care providers or said individual patients using said devices, with said individual unique relational SQL units in said individual relations of said individual unique relational SQL units in and among said SQL databases and tables, or vice versa;
xii) a process for said individual physicians or physicians in individual groups of physicians to repetitively relate individual patients or patients related to individual diagnoses, individual syndromes or diagnoses in individual groups of diagnoses and related said categories related to individual SQL keys to individual SQL keys related to individual physicians, physicians, health-care providers, or physicians in individual groups of physicians and health-care providers in said SQL databases and tables using said devices and said relations of physicians, patients and diagnoses related to said individual SQL keys are server-automatically, repetitively and continually retrieved and displayed on said viewing screens of said physicians and patients who viewed, interactive with, use and select said interactive displays on said viewing screens of said devices;
xiii) a process for server-automatically, repetitively and continually relating individual diagnoses, individual syndromes or diagnoses in individual groups of diagnoses and individual patients to individual physicians, physicians, health-care providers or physicians in individual groups of physicians and health-care providers related to said diagnoses related to individual SQL keys in said SQL databases and tables which are server-automatically, repetitively and continually retrieved and displayed on said viewing screens of said physicians and patients who viewed, interactive with, use and select said interactive displays on said viewing screens of said devices;
xiv) a process for server-automatically and repetitively selecting, retrieving and displaying adaptable and expanding compositions of said SQL relations of individual relational SQL units related to individual diagnoses, individual syndromes or diagnoses in individual groups of related diagnoses and related differential diagnoses and related categories and individual physicians or physicians in said individual groups of physicians and health-care providers related to said individual SQL keys in said SQL databases and tables on said viewing screens of said devices to individual patients and people;
xv) a process for server-automatically guiding and adapting said decision makings, judgements, determinations and executions of said individual physicians and among physicians in said individual groups of physicians, and individual patients and impacting on the generations and inputs of said information and data into said processor units and memories coupled to said SQL Server comprising said SQL databases and tables, said adaptable and expanding relations of SQL units in said SQL databases in and manage by said SQL in said computer server or servers; and
xvi) a process for server-automatically generating and repetitively displaying individual diagnoses, individual syndromes or individual diagnoses in individual groups of related diagnoses and related categories and individual physicians or physicians in individual groups of physicians and health-care providers and related individual patients or patients related to individual SQL keys in said individual relational SQL units in said SQL databases and tables and server-automatically and continually retrieved, viewable in server-automatically generated and displayed interactive related electronic templates, HTML related Web pages and on interactive and related 2-dimensional and 3-dimensional, human figurines and images, graphics, charts, videos and as dynamic data, transactional data and streaming data and any combinations thereof and the like and derivatives on said viewing screens of said devices and useable by and interactive with said individual physicians and physicians in individual groups of physicians and health-care providers, individual patients and patients using said devices.

11. The method according to claim 6 wherein said process for server-automatically, repetitively and continually patterning and standardizing said decision makings, judgements, determinations and executions on the productions and executions of said quality, quantity and continuity of health, health-care and health-care services, related to individual diagnoses, individual syndromes or individual diagnoses in individual groups of related diagnoses, being provided or to be provided to patients or individual patients by individual physicians or physicians in individual groups of physicians and health-care providers comprises:
i) said process for server-automatically and continually guiding, assisting and adapting decision makings, judgements, determinations and executions impacting on the health, health-care and health-care services, related to individual diagnoses, individual syndromes or individual diagnoses in individual groups of related diagnoses, being provided or to be provided to patients or individual patients by individual physicians or physicians in individual groups of physicians and health-care providers and the generations and inputs of information and data on said decision makings, judgements, determinations and executions into said SQL databases and tables;
ii) a process for server-automatically, repetitively and continually composing and relating individual diagnoses, individual syndromes or diagnoses in individual groups of diagnoses and related any and all categories to individual patients or patients related to said individual SQL keys in said SQL databases and tables and continually viewable and useable by and interactive with said individual patients, patients or people;
iii) a process for server-automatically and repetitively selecting, retrieving and displaying adaptable and expanding compositions of said SQL relations of individual relational SQL units related to individual diagnoses or diagnoses in individual groups of related diagnoses and related differential diagnoses and related categories and individual physicians or physicians in said individual groups of physicians and health-care providers related to said individual SQL keys in said SQL databases and tables on said viewing screens of said devices to individual patients and people;
iv) a process for individual physicians or physicians in individual groups of physicians repetitively generating and composing adaptable and expanding SQL relations of individual relational SQL units related to individual diagnoses or individual diagnoses in individual groups of related diagnoses and related categories and individual physicians or physicians in individual groups of physicians and health-care providers related to individual patients related to individual SQL keys in said SQL databases and tables and viewable and useable by and interactive with said individual physicians and physicians in individual groups of physicians and health-care providers;
v) a process for server-automatically, repetitively and continually relating individual diagnoses, individual syndromes or diagnoses and/or syndromes in individual groups of related diagnoses and/or syndromes and related individual patients or patients to individual physicians or physicians and health-care providers in individual groups of physicians and health-care providers related to said individual diagnoses, individual syndromes or diagnoses and/or syndromes in individual groups of related diagnoses and/or syndromes related to individual SQL keys in and among said SQL databases and tables which are continually retrievable, viewable on said viewing screens and useable by and interactive with said individual physicians, health-care providers and patients;
vi) a process for individual physicians, individual health-care providers or physicians and health-care providers in individual groups of physicians and health-care providers to repetitively relate and compose individual diagnoses, individual syndromes or diagnoses and/or syndromes in individual groups of related diagnoses and/or syndromes and related individual patients or patients to individual physicians or physicians and health-care providers in individual groups of physicians and health-care providers related to said individual diagnoses, individual syndromes or diagnoses and/or syndromes in individual groups of related diagnoses and/or syndromes related to individual SQL keys in and among said SQL databases and tables which are continually retrievable, viewable on said viewing screens and useable by and interactive with said individual physicians, health-care providers and patients;
vii) a process for server-automatically, repetitively and continually relating individual diagnoses, individual syndromes or diagnoses in individual groups of diagnoses and individual patients to individual physicians or physicians in individual groups of physicians and health-care providers related to individual SQL keys in said SQL databases and tables and continually viewable and useable by and interactive with said individual physicians and physicians in individual groups of physicians and health-care providers;
viii) a process for individual physicians or physicians in individual groups of physicians to repetitively compose and relate individual diagnoses, individual syndromes or diagnoses in individual groups of diagnoses and related any and all categories to individual patients or patients related to said individual SQL keys in said SQL databases and tables viewable and useable by and interactive with said individual patients or patients;
ix) a process for server-automatically and continually qualifying and regulating payments for health-care and health-care services to individual physicians and proportional payments, distributions, adjustments, debits, redistributions and readjustments of payments in and among individual adaptable and expanding compositions of adaptable accounts of individual physicians in individual groups of physicians related to individual diagnoses or individual diagnoses in individual groups of related diagnoses and related health, health-care and health-care services provided to said individual patients by said individual groups of physicians and related individual disbursements relating and corresponding to said payments in individual adaptable and expanding compositions of adaptable accounts of said individual patients in the SQL databases and tables in and manage by a SQL server coupled to and enabled by said innovative computer programs and software in said computer server or servers viewable, manageable, adjustable and used by and interactive with said individual physicians and individual patients using said devices; and
x) a process for server-automatically, repetitively and continually expressions and displays of said adaptable and expanding individual relations of said individual unique relational SQL units in and among said SQL databases and tables in server-automatically generated and displayed interactive related electronic templates, HTML related Web pages and on interactive and related 2-dimensional and 3-dimensional, human figurines and images, graphics, charts, videos and as dynamic data, transactional data and streaming data and any combinations thereof and the like and derivatives on said viewing screens of said devices, enabled by said Internet Explorer and browsers and Web server devices and servers in said network or networks, being used by said patients and physicians using said devices.

12. The method for server-automatically and continually managing and monitoring diseases and disorders and quality, quantity and continuity of health, health-care and health-care services, being provided and to be provided by said individual physicians and said physicians in said individual groups of physicians and health-care providers to said individual patients and patients related to said diagnoses, syndromes or individual diagnoses in individual groups of related diagnoses, for said physicians and patients according to claim 6 comprises:
i) said process for server-automatically and continually guiding, assisting and adapting decision makings, judgements, determinations and executions impacting on the health, health-care and health-care services, related to individual diagnoses, individual syndromes or individual diagnoses in individual groups of related diagnoses, being provided or to be provided to patients or individual patients by individual physicians or physicians in individual groups of physicians and health-care providers and the generations and inputs of information and data on said decision makings, judgements, determinations and executions into said SQL databases and tables;
ii) a process for individual physicians or physicians in individual groups of physicians repetitively generating and composing adaptable and expanding SQL relations of individual relational SQL units related to individual diagnoses or individual diagnoses in individual groups of related diagnoses and related categories and individual physicians or physicians in individual groups of physicians and health-care providers related to individual patients related to individual SQL keys in said SQL databases and tables;
iii) a process for individual physicians or physicians in individual groups of physicians to repetitively relate individual diagnoses, individual syndromes or diagnoses in individual groups of diagnoses and individual patients to individual physicians or physicians in individual groups of physicians and health-care providers related to individual SQL keys in said SQL databases and tables and viewable and useable by and interactive with said individual physicians and physicians in individual groups of physicians and health-care providers;
iv) a process for server-automatically, repetitively and continually relating individual diagnoses, individual syndromes or diagnoses and/or syndromes in individual groups of related diagnoses and/or syndromes and related individual patients or patients to individual physicians or physicians and health-care providers in individual groups of physicians and health-care providers related to said individual diagnoses, individual syndromes or diagnoses and/or syndromes in individual groups of related diagnoses and/or syndromes related to individual SQL keys in and among said SQL databases and tables which are continually retrievable, viewable on said viewing screens and useable by and interactive with said individual physicians, health-care providers and patients;
v) a process for individual physicians, individual health-care providers or physicians and health-care providers in individual groups of physicians and health-care providers to repetitively relate and compose individual diagnoses, individual syndromes or diagnoses and/or syndromes in individual groups of related diagnoses and/or syndromes and related individual patients or patients to individual physicians or physicians and health-care providers in individual groups of physicians and health-care providers related to said individual diagnoses, individual syndromes or diagnoses and/or syndromes in individual groups of related diagnoses and/or syndromes related to individual SQL keys in and among said SQL databases and tables which are continually retrievable, viewable on said viewing screens and useable by and interactive with said individual physicians, health-care providers and patients;
v) a process for individual diagnoses, individual syndromes or diagnoses in individual groups of diagnoses and related any and all categories to individual patients or patients related to said individual SQL keys in said SQL databases and tables viewable and useable by and interactive with said individual patients or patients;
vi) a process for server-automatically, repetitively and continually composing and relating individual diagnoses, individual syndromes or diagnoses in individual groups of diagnoses and related any and all categories to individual patients or patients related to said individual SQL keys in said SQL databases and tables and continually viewable and useable by and interactive with said individual patients, patients or people;
vii) a process for server-automatically and repetitively selecting, retrieving and displaying adaptable and expanding compositions of said SQL relations of individual relational SQL units related to individual diagnoses or diagnoses in individual groups of related diagnoses and related differential diagnoses and related categories and individual physicians or physicians in said individual groups of physicians and health-care providers and individual patients related to said individual SQL keys in and among said SQL databases and tables; and
viii) a process for server-automatically, repetitively and continually expressing and displaying said adaptable and expanding individual relations of said individual unique relational SQL units in and among said SQL databases and tables in server-automatically generated and displayed interactive related electronic templates, HTML related Web pages and on interactive and related 2-dimensional and 3-dimensional, human figurines and images, graphics, charts, videos and as dynamic data, transactional data and streaming data and any combinations thereof and the like and derivatives on said viewing screens of said devices, enabled by said Internet Explorer and browsers and Web server devices and servers in said network or networks, being used by said patients and physicians using said devices.

13. The process for server-automatically and repetitively selecting, retrieving and displaying adaptable and expanding compositions of said SQL relations of individual relational SQL units related to individual diagnoses or diagnoses in individual groups of related diagnoses and related differential diagnoses and related categories and individual physicians or physicians in said individual groups of physicians and health-care providers and individual patients related to said individual SQL keys in and among said SQL databases and tables according to claim 12 comprises:
i) a process for said individual physicians or physicians in individual groups of physicians to repetitively generate, relate and compile individual patients or patients related to said words and terms and related any or all said categories related to individual diagnoses, individual syndromes or diagnoses in individual groups of related diagnoses and related to individual SQL keys in and among said SQL databases and tables to individual SQL keys related to individual physicians, physicians, health-care providers or physicians in individual groups of physicians and health-care providers in and among said SQL databases and tables using said viewing screens in said devices;
ii) a process for server-automatically, repetitively and continually expanding said relations of said physicians, patients, words and terms, categories and diagnoses, syndromes or diagnoses in individual groups of diagnoses related to said individual SQL keys in and among said SQL databases and tables; and
iii) a process for server-automatically and continually retrieving and displaying adaptable and expanding compositions of said SQL relations of individual relational SQL units in server-automatically generated and displayed interactive related electronic templates, HTML related Web pages and on interactive and related 2-dimensional and 3-dimensional, human figurines and images, graphics, charts, videos and as dynamic data, transactional data and streaming data and any combinations thereof and the like and derivatives on said viewing screens of said devices, enabled by said Internet Explorer and browsers and Web server devices and servers in said network or networks, being used by said patients and physicians using said devices.

14. A method for server-automatically and continually managing and monitoring diseases and disorders and quality, quantity and continuity of health, health-care and health-care services, being provided and to be provided by said individual physicians and said physicians in said individual groups of physicians and health-care providers to said individual patients and patients related to said diagnoses, syndromes or individual diagnoses in individual groups of related diagnoses, for said physicians and patients according to claim 6 wherein said process for server-automatically and repetitively expressing and displaying said individual computer-generated results and outcomes of said scans, matches, correlations, collaborations and comparisons of said information and data in said processor units and memories for server-automatically and continually managing and monitoring diseases and disorders and quality, quantity and continuity of health, health-care and health-care services, being provided and to be provided by physicians, said individual physicians, physicians in said individual groups of physicians and health-care providers to said individual patients and patients related to said diagnoses or individual diagnoses in individual groups of related diagnoses, for and interactive with and said physicians and patients on said viewing screens of said devices comprises:
i) a process for server-automatically, instantly and repetitively scanning, matching correlating, collaborating and comparing individual words, terms, phrases, sentences, texts, synonyms, acronyms, numbers, data, graphics and any combinations thereof and related adjectives and variables henceforth words and terms in any or all said categories in individual inputs or queries repetitively generated and submitted to said processor units and memories by said individual physicians, physicians or said physicians in individual groups of physicians and health-care providers or said individual patients using said devices, with said individual unique relational SQL units in said individual relations of said individual unique relational SQL units in and among said SQL databases and tables, or vice versa; and, consequently,
ii) a process for said individual physicians or physicians in individual groups of physicians to repetitively relate individual patients or patients related to individual diagnoses, individual syndromes or diagnoses in individual groups of diagnoses and related said categories related to individual SQL keys to individual SQL keys related to individual physicians, physicians, health-care providers, or physicians in individual groups of physicians and health-care providers in said SQL databases and tables using said devices and said relations of physicians, patients and diagnoses related to said individual SQL keys are server-automatically, repetitively and continually retrieved and displayed on said viewing screens of said physicians and patients who viewed, interactive with, use and select said interactive displays on said viewing screens of said devices;
iii) a process for server-automatically, instantly and repetitively scanning, matching, correlating, collaborating and comparing individual words and terms in any or all said categories related to individual diagnoses and individual patients in individual inputs repetitively generated and submitted to said processor units and memories by said individual physicians, physicians or said physicians in individual groups of physicians and health-care providers or individual patients using said devices, with said individual unique relational SQL units in said individual relations of said individual unique relational SQL units in and among said SQL databases and tables, or vice versa;
iv) a process for server-automatically, instantly and repetitively scanning, matching, correlating, collaborating and comparing individual words and terms in any or all said categories related to individual diagnoses, individual patients and individual physicians, physicians or said physicians in individual groups of physicians and health-care providers in individual inputs repetitively generated and submitted to said processor units and memories by said individual physicians or said physicians and health-care providers or said individual patients using said devices, with said individual unique relational SQL units in said individual relations of said individual unique relational SQL units in and among said SQL databases and tables, or vice versa; and, consequently,
v) a process for server-automatically, repetitively and continually relating individual diagnoses, individual syndromes or diagnoses and/or syndromes in individual groups of related diagnoses and/or syndromes and related individual patients or patients to individual physicians or physicians and health-care providers in individual groups of physicians and health-care providers related to said individual diagnoses, individual syndromes or diagnoses and/or syndromes in individual groups of related diagnoses and/or syndromes related to individual SQL keys in and among said SQL databases and tables which are continually retrievable, viewable on said viewing screens and useable by and interactive with said individual physicians, health-care providers and patients;
vi) a process for individual physicians, individual health-care providers or physicians and health-care providers in individual groups of physicians and health-care providers to repetitively relate and compose individual diagnoses, individual syndromes or diagnoses and/or syndromes in individual groups of related diagnoses and/or syndromes and related individual patients or patients to individual physicians or physicians and health-care providers in individual groups of physicians and health-care providers related to said individual diagnoses, individual syndromes or diagnoses and/or syndromes in individual groups of related diagnoses and/or syndromes related to individual SQL keys in and among said SQL databases and tables which are continually retrievable, viewable on said viewing screens and useable by and interactive with said individual physicians, health-care providers and patients; and
vii) a process for repetitively relating individual diagnoses, individual syndromes or diagnoses in individual groups of diagnoses and related individual patients to individual physicians, physicians, health-care providers or physicians in individual groups of physicians and health-care providers related to said diagnoses related to individual SQL keys in said SQL databases and tables which are repetitively retrieved and displayed on said viewing screens by said physicians who viewed, interactive with, use and select said interactive displays on said viewing screens in interactive related electronic templates, HTML related Web pages and on interactive and related 2-dimensional and 3-dimensional, human figurines and images, graphics, charts, videos and as dynamic data, transactional data and streaming data and any combinations thereof and the like and derivatives on said viewing screens of said devices, enabled by said Internet Explorer and browsers and Web server devices and servers in said network or networks, being used by said patients and physicians using said devices in diverse and different settings, practices, localities, regions, states and nations.

15. The process for server-automatically, instantly and repetitively scanning, matching correlating, collaborating and comparing individual words, terms, phrases, sentences, texts, synonyms, acronyms, numbers, data, graphics and any combinations thereof and related adjectives and variables henceforth words and terms in any or all said categories in individual inputs or queries repetitively generated and submitted to said processor units and memories by said individual physicians, physicians or said physicians in individual groups of physicians and health-care providers or said individual patients using said devices, with said individual unique relational SQL units in said individual relations of said individual unique relational SQL units in and among said SQL databases and tables, or vice versa according to claim 14 comprises:
i) a process for computer server-automatically and sequentially scanning and matching, collaborating, correlating and comparing individual words and terms representing chief complaints, signs and symptoms and causes, provocatives, palliatives, quality and severity of signs and symptoms and temporal factors of said signs and symptoms, and related anatomical locations and anatomical sites and related adjectives and variables in said individual inputs or queries submitted to said processor units and memories by said physicians with same, similar, equivalent or synonymous words and terms related to individual diagnoses and/or individual syndromes, which are related to first individual group of individual diagnoses related to individual SQL keys in said individual unique relational SQL units in said relations of said individual unique relational SQL units in and among said SQL databases and tables. Said computer server-automatic scans and matches in processor units and memories resulted in the server-automatic selections of said matches of said words and terms related to said first group of individual diagnoses and/or individual syndromes—number from 1—approximately less than 100—related to first group of individual SQL keys in said individual unique relational SQL units in said relations of said individual unique relational SQL units in and among said SQL databases and tables, in said processor units and memories coupled to said SQL Server and, consequently, if said number of diagnosis=1, said process is computer server-automatically terminated; however, if said number of preliminary diagnoses>1, consequently and next,
ii) a process for said computer server-automatically selecting said matches of said words and terms and related said first group of individual diagnoses and/or syndromes, related to said first group of individual SQL keys, in said processor units and memories and computer server-automatically and sequentially scanning and matching, collaborating, correlating and comparing said first group of individual diagnoses related to first group individual SQL keys with second group of individual diagnoses and/or individual syndromes related to second individual SQL keys related to anatomical locations, anatomical sites and related reviews of systems and related adjectives and variables in said relations of said individual SQL units in said individual unique relational SQL units in said relations of said individual unique relational SQL units in and among said SQL databases and tables in said processor units and memories coupled to said SQL Server and, consequently, if said number of diagnosis=1, said process is computer server-automatically terminated; however, if said number of preliminary diagnoses>1, consequently and next,
iii) a process for said computer server-automatically selecting said matches of said words and terms and related said second group of individual diagnoses and/or syndromes, related to said second group of individual SQL keys, in said processor units and memories and computer server-automatically and sequentially scanning and matching, collaborating, correlating and comparing said second group of individual diagnoses related to second group individual SQL keys with third group of individual diagnoses and/or individual syndromes related to third individual SQL keys related to anatomical locations, anatomical sites and related physical examinations or findings and related adjectives and variables in said relations of said individual SQL units in said individual unique relational SQL units in said relations of said individual unique relational SQL units in and among said SQL databases and tables in said processor units and memories coupled to said SQL Server and, consequently, if said number of diagnosis=1, said process is computer server-automatically terminated; however, if said number of preliminary diagnoses>1, consequently and next,
iv) a process for said computer server-automatically selecting said matches of said words and terms and related said third group of individual diagnoses and/or syndromes, related to said third group of individual SQL keys, in said processor units and memories and computer server-automatically and sequentially scanning and matching, collaborating, correlating and comparing said third group of individual diagnoses related to third group individual SQL keys with fourth group of individual diagnoses and/or individual syndromes related to fourth individual SQL keys related to anatomical locations, anatomical sites, organ systems and related laboratory tests, imaging, tissues examinations and results and related adjectives and variables in said relations of said individual SQL units in said individual unique relational SQL units in said relations of said individual unique relational SQL units in and among said SQL databases and tables in said processor units and memories coupled to said SQL Server and, consequently, if said number of diagnosis=1, said process is computer server-automatically terminated; however, if said number of preliminary diagnoses>1, consequently and next,
v) a process for said computer server-automatically selecting said matches of said words and terms and related said fourth group of individual diagnoses and/or syndromes, related to said fourth group of individual SQL keys, in said processor units and memories and computer server-automatically and sequentially scanning and matching, collaborating, correlating and comparing said fourth group of individual diagnoses related to fourth group individual SQL keys with fifth group of individual diagnoses and/or individual syndromes related to fifth individual SQL keys related to anatomical locations, anatomical sites, organ systems and related medications and drugs and related adjectives and variables in said relations of said individual SQL units in said individual unique relational SQL units in said relations of said individual unique relational SQL units in and among said SQL databases and tables in said processor units and memories coupled to said SQL Server and, consequently, if said number of diagnosis=1, said process is computer server-automatically terminated; however, if said number of preliminary diagnoses>1, consequently and next,
vi) a process for said computer server-automatically selecting said matches of said words and terms and related said fifth group of individual diagnoses and/or syndromes, related to said fifth group of individual SQL keys, in said processor units and memories and computer server-automatically and sequentially scanning and matching, collaborating, correlating and comparing said fourth group of individual diagnoses related to fifth group individual SQL keys with sixth group of individual diagnoses and/or individual syndromes related to sixth individual SQL keys related to anatomical locations, anatomical sites, organ systems and related treatments and procedures and related adjectives and variables in said relations of said individual SQL units in said individual unique relational SQL units in said relations of said individual unique relational SQL units in and among said SQL databases and tables in said processor units and memories coupled to said SQL Server and, consequently, if said number of diagnosis=1, said process is computer server-automatically terminated; however, if said number of preliminary diagnoses>1, consequently and next,
vii) a process for said computer server-automatically selecting said matches of said words and terms and related said sixth group of individual diagnoses and/or syndromes, related to said sixth group of individual SQL keys, in said processor units and memories and computer server-automatically and sequentially scanning and matching, collaborating, correlating and comparing said sixth group of individual diagnoses related to sixth group individual SQL keys with seventh group of individual diagnoses and/or individual syndromes related to seventh individual SQL keys related to anatomical locations, anatomical sites, organ systems and related surgeries and related adjectives and variables in said relations of said individual SQL units in said individual unique relational SQL units in said relations of said individual unique relational SQL units in and among said SQL databases and tables in said processor units and memories coupled to said SQL Server.

16. The method according to claim 6 wherein said process for server-automatically and continually qualifying and regulating payments for health-care and health-care services to individual physicians and proportional payments, distributions, adjustments, debits, redistributions and readjustments of payments in and among individual adaptable and expanding compositions of adaptable accounts of individual patients and individual physicians in individual groups of physicians related to individual diagnoses or individual diagnoses in individual groups of related diagnoses and related health, health-care and health-care services provided to said individual patients by said individual physicians or individual groups of physicians and related individual disbursements relating and corresponding to said payments in individual adaptable and expanding compositions of adaptable accounts of said individual patients in the SQL databases and tables in and manage by a SQL server coupled to and enabled by said innovative computer programs and software in said computer server or servers comprises:
i) a process for generating, relating and compiling individual words and terms in any and all said categories representing information and data on health, health-care and health-care services on or related to individual diagnoses, individual syndromes or individual diagnoses in individual groups of related diagnoses of diseases and disorders, which are integral components of said health, health-care and health-care-service information and data on or related to diseases and disorders and patients used and use by physicians of all and diverse medical and surgical practices or specialties for and in the communications of said information and data among and between physicians and between physicians and patients, and related individual prices, monetary values or costs related to said health-care and health-care services and related to individual physicians and individual SQL keys and compiled in said SQL databases and tables in and manage by said SQL Server coupled to said processor units, memories and said innovative computer programs and software;
ii) a process for generating, relating and compiling individual unique relational SQL units comprising related said words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to said diagnoses and/or syndromes related to individual SQL keys in said SQL databases and tables in and manage by said SQL Server;
iii) a process for generating, relating and compiling adaptable and expanding individual relations of said individual unique relational SQL units in and among said SQL databases and tables in and manage by said SQL Server, according to said innovative computer programs and software;
iv) a process for repetitively creating and generating related words and terms in said categories related to individual diagnoses which are integral components of electronic information and data on health, health-care and health-care-services in individual electronic medical records on or related to individual patients or patients generated and submitted to said processor units and memories by said individual physicians, physicians, or physicians and health-care providers in individual groups of physicians and health-care providers, or individual patients using said interactive electronic templates viewable and interactive with said physicians and patients on said viewing screens in said devices for accessing said computer servers;
v) said process for server-automatically and continually guiding, assisting and adapting decision makings, judgements, determinations and executions impacting on the health, health-care and health-care services, related to individual diagnoses, individual syndromes or individual diagnoses in individual groups of related diagnoses, being provided or to be provided to patients or individual patients by individual physicians or physicians in individual groups of physicians and health-care providers and the generations and inputs of information and data on said decision makings, judgements, determinations and executions into said SQL databases and tables;
vi) said process for server-automatically, repetitively and continually patterning and standardizing said decision makings, judgements, determinations and executions on the productions and executions of said quality, quantity and continuity of health, health-care and health-care services, related to individual diagnoses, individual syndromes or individual diagnoses in individual groups of related diagnoses, being provided or to be provided to patients or individual patients by individual physicians or physicians in individual groups of physicians and health-care providers;
vii) said process for server-automatically and continually managing and monitoring diseases and disorders and quality, quantity and continuity of health, health-care and health-care services, being provided and to be provided by said individual physicians and said physicians in said individual groups of physicians and health-care providers to said individual patients and patients related to said diagnoses, syndromes or individual diagnoses in individual groups of related diagnoses, for said physicians and patients; viii) a process for repetitively generating, modifying and editing said words and terms and information and data on and related to said health, health-care and health-care services related to individual diagnoses related to individual patients continually and perpetually generated and submitted to said process units, memories and SQL databases and tables by said individual physicians, physicians, or physicians and health-care related to individual diagnoses or diagnoses in individual groups of related diagnoses;
viii) a process for repetitively generating, modifying and editing said words and terms and information and data on and related to said health, health-care and health-care services related to individual diagnoses related to individual patients continually and perpetually generated and submitted to said process units, memories and SQL databases and tables by said individual physicians, physicians, or physicians and health-care related to individual diagnoses or diagnoses in individual groups of related diagnoses;
ix) a process for server-automatically and repetitively scanning and matching said individual words and terms with same, equivalent or similar individual words, and terms, compiled and related to individual prices, monetary values or costs in said SQL databases and tables, in said processor units and memories and inputting said scanned and matched words and terms from said processor units and memories into, related to said individual prices, monetary values or costs and relate and compiled in said SQL databases and tables in and manage by said SQL Server;
x) a process for server-automatically adapting and expanding compositions of said scanned and matched words and terms related to said scanned and matched words and terms and individual prices, monetary values or costs in related said adaptable and expanding compositions of accounts of said individual physicians and individual patients related and compiled in said SQL databases and tables in and manage by said SQL server;
xi) a process for computer-automatically and repetitively generating and managing the relations of said adaptable and expanding individual compositions of said scanned and matched said words and terms and related computer-automatically generated, modified, edited and managed said adaptable and expanding relational individual compositions of adaptable and expanding accounts of said individual physicians and individual physicians in individual groups of physicians related to individual patients and relating and corresponding individual disbursements relating and corresponding to said payments in said individual adaptable and expanding compositions of adaptable accounts of said individual patients in said SQL databases and tables in and manage by said SQL Server;
xii) a process for computer-automatically and repetitively adapting, compiling and expanding said relational compositions of computer-generated scanned and matched said individual words and terms and related payments to individual physicians and proportional payments, distributions, adjustments, debits, redistributions and readjustments of payments in and among individual adaptable and expanding compositions of adaptable accounts of said individual physicians in individual groups of physicians related to individual diagnoses or individual diagnoses in individual groups of related diagnoses and related health-care and health-care services provided to said individual patients and related individual disbursements relating and corresponding to said payments in individual adaptable and expanding compositions of adaptable accounts of said individual patients in the SQL databases and tables;
xiii) a process for accounting and tallies of adaptable revenues and earnings of said individual physicians and said individual physicians in individual groups of physicians comprising said payments to individual physicians and said proportional payments, distributions, adjustments, debits, redistributions and readjustments of payments in and among said individual adaptable and expanding compositions of adaptable accounts of individual physicians in individual groups of physicians, and said related individual disbursements relating and corresponding to said payments and related refunds or reimbursements relating or corresponding to deductions from said payments in said individual adaptable and expanding compositions of adaptable accounts of said individual patients according to the instructions and commands of said innovative computer programs and software for repetitively paying, proportionally paying, distributing, adjusting, debiting, readjusting and redistributing said proportional payments, calculating, tallying and accounting said revenues, earnings, disbursements, refunds, reimbursements in and among said individual adaptable and expanding compositions of adaptable accounts in said databases and tables; and
xiv) a process for repetitively retrieving and displaying on said viewing screens, in server-automatically generated and displayed interactive related electronic templates, HTML related Web pages and on interactive and related 2-dimensional and 3-dimensional, human figurines and images, graphics, charts, videos and as dynamic data, transactional data and streaming data and any combinations thereof and the like and derivatives, said adaptable and expanding relational compositions of said computer-automatically scanned and matched words and terms related to said individual prices, monetary values or costs in computer-automatically generated, modified, edited and managed adaptable and expanding relational individual compositions of said adaptable and expanding accounts on revenues and earnings comprising said adaptable payments and proportional payments, distributions, adjustments, debits, readjustments and redistributions of proportional payments in and among said individual adaptable and expanding relational compositions of adaptable accounts of said individual physicians and said individual physicians in individual groups of physicians and related and corresponding expenses, deductions and disbursements relating or corresponding to said payments, and refunds or reimbursements relating or corresponding to deductions from said payments in said adaptable and expanding compositions of accounts of said individual patients in said SQL databases and tables in and manage by said SQL server and said innovative computer programs and software coupled to said processor units and memories, upon the Web browser-generate requests from said devices to said Web server in said computer servers in said network or networks, by said individual physicians and individual patients using said devices for accessing said computer servers in said network or networks.

17. A method for server-automatically, repetitively and continually patterning and standardizing decision makings, judgements, determinations and executions on the productions and executions of said quality, quantity and continuity of health, health-care and health-care services related to individual diagnoses, individual syndromes and individual diagnoses in individual groups of related diagnoses among said patients and physicians and health-care providers related to server-automatically and continually qualifying and regulating payments for health-care and health-care services to individual physicians, individual health-care providers and proportional payments, distributions, adjustments, debits, redistributions and readjustments of payments in and among individual adaptable and expanding compositions of adaptable accounts of individual physicians in individual groups of physicians and health-care providers related to individual patients and related individual disbursements relating and corresponding to said payments in individual adaptable and expanding compositions of adaptable accounts in the SQL databases and tables in and manage by a SQL server coupled to and enabled by said innovative computer programs and software in a functioning and operating computer server or servers viewable, manageable, adjustable and used by and interactive with said individual physicians and individual patients using devices in a network or networks of said computer servers and computers, laptops, wireless, mobile communication devices comprises:
a process for operating said functioning and operating computer servers comprising said central processing units (CPU) or said processor units and memories, server operating systems, a Windows Server, Unix, Apache, VMware, said SQL Server, a Visual Studio and .Net, JavaScript, AJAX, HTML, XHTML, a Microsoft IIS, a Web server, computer scripting languages, PHP and the innovative computer programs and software for communicating with and commanding and instructing and coupled to said processor units, memories, SQL Server, said Web server, Web browsers, routers and modems, and teleconference-enabling, stream media-enabling and dynamic data-enabling programs and software programs and software in a network or networks of said computer servers and devices;
a process for operating and using said devices comprising computers, laptops, wireless, mobile communication devices including smartphones possessing processor units, memories, keyboards for repetitively viewing, managing, expanding and inputting said information and data and for repetitively generating, manipulating, relating, updating, expanding and controlling said adaptable and expandable information and data in said SQL databases and tables, application software and said viewing screens including touch-sensitive or touch screens enabled by Web browers, routers and modems for accessing said computer servers and application software for accessing applications and said system in said computer server or servers henceforth devices for accessing said computer servers in a network or networks of said devices and computer servers by said devices in said network or networks of said devices and computer servers;
a process for creating and applying stored procedures and SQL in said SQL Server, coupled to said innovative computer programs and software and said processor units and memories and said computer scripting language, created by said innovative computer programs and software for configuring, creating, generating, expanding and adapting said SQL databases and tables, generating and creating individual unique relational SQL units and adaptable and expanding relations individual unique relational SQL units in and among said SQL databases and tables;
a process for creating and computer-automatically and repetitively applying a plurality of computer server-executable algorithms for creating said system and the methods supra in said processor units, memories and said SQL Server, according to said innovative computer programs and software, comprise at least:
i) a computer server-executable algorithm for server-automatically generating individual unique relational SQL units comprising related said words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to individual SQL keys in said SQL databases and tables in and manage by said SQL Server;
ii) a computer server-executable algorithm for server-automatically, instantly and repetitively scanning, matching correlating, collaborating and comparing individual words and terms in any or all said categories in individual inputs or queries repetitively generated and submitted to said processor units and memories by said individual physicians, physicians or said physicians in individual groups of physicians and health-care providers or said individual patients using said devices, with said individual unique relational SQL units in said individual relations of said individual unique relational SQL units in and among said SQL databases and tables, or vice versa;
iii) a computer server-executable algorithm for server-automatically, instantly and repetitively scanning, matching correlating, collaborating and comparing individual words and terms in any or all said categories related to individual diagnoses and individual patients in individual inputs or queries repetitively generated and submitted to said processor units and memories by said individual physicians, physicians or said physicians in individual groups of physicians and health-care providers or individual patients using said devices, with said individual unique relational SQL units in said individual relations of said individual unique relational SQL units in and among said SQL databases and tables, or vice versa;
iv) a computer server-executable algorithm for server-automatically, instantly and repetitively scanning, matching correlating, collaborating and comparing individual words and terms in any or all said categories related to individual diagnoses, individual patients and individual physicians, physicians or said physicians in individual groups of physicians and health-care providers in individual inputs or queries repetitively generated and submitted to said processor units and memories by said individual physicians or said physicians and health-care providers or said individual patients using said devices, with said individual unique relational SQL units in said individual relations of said individual unique relational SQL units in and among said SQL databases and tables, or vice versa;
v) a computer server-executable algorithm for repetitively scanning and checking for redundant duplicates or repeats, doubles in individual physicians' submissions related to individual diagnoses, individual syndromes or diagnoses in individual groups of diagnoses and related said categories in said processor units and memories and outputting said scans and matches to, related to individual SQL keys and compiled in said SQL databases and tables, for removing said redundant duplicates or repeats, doubles from said individual unique relational SQL units in said SQL databases and tables, for not inserting said redundant duplicates or repeats, doubles into said individual unique relational SQL units;
vi) a computer server-executable algorithm for server-automatically creating and repetitively generating and expanding individual unique relational SQL units comprising related said words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to individual SQL keys in said SQL databases and tables in and manage by said SQL Server;
vii) a computer server-executable algorithm for server-automatically creating and repetitively generating and expanding adaptable and expanding individual relations of said individual unique relational SQL units in and among said SQL databases and tables in and manage by said SQL Server;
viii) a computer server-executable algorithm for server-automatically and repetitively and continually patterning and standardizing said decision makings, judgements, determinations and executions on the productions and executions of said quality, quantity and continuity of health, health-care and health-care services, related to individual diagnoses, individual syndromes or individual diagnoses in individual groups of related diagnoses, being provided or to be provided to patients or individual patients by individual physicians or physicians in individual groups of physicians and health-care providers;
ix) a computer server-executable algorithm for server-automatically identifying, determining and displaying and warning of individual deficiencies, inconsistencies, faults and misses in said decision makings, judgements, determinations and executions of said health, health-care and health-care services related to any or all categories and related definitive or preliminary diagnoses represented by individual deficiencies, inconsistencies, faults and misses in said individual selections and keyboarded words and terms in said templates on said viewing screens referencing to and scanning, matching, correlating, collaborating and comparing with the pooled and compiled decision makings, judgements, determinations and executions on said health, health-care and health-care services related to individual diagnoses, individual syndromes or individual diagnoses in individual groups of related individual diagnoses or individual syndromes related to physicians related to SQL keys in said adaptable and expanding individual relations of said individual unique relational SQL units in and among said SQL databases and tables;
x) a computer server-executable algorithm for server-automatically and continually guiding, assisting and adapting decision makings, judgements, determinations and executions of said individual physicians and among physicians in said individual groups of physicians and individual patients impacting on the health, health-care and health-care services related to individual diagnoses, individual syndromes or individual diagnoses in individual groups of related diagnoses being provided or to be provided to patients or individual patients by individual physicians or physicians in individual groups of physicians and health-care providers and on the inputs of said decision makings, judgements, determinations and executions into said SQL databases and tables;
xi) a computer server-executable algorithm for server-automatically and continually managing and monitoring diseases and disorders and quality, quantity and continuity of health, health-care and health-care services, being provided and to be provided by physicians, said individual physicians, physicians in said individual groups of physicians and health-care providers to said individual patients and patients related to said diagnoses or individual diagnoses in individual groups of related diagnoses;
xii) a computer server-executable algorithm for server-automatically, instantly and repetitively qualifying, regulating, generating, tallying and accounting individual payments for health-care and health-care services to individual physicians or health-care providers and proportional payments, distributions, adjustments, debits, redistributions and readjustments of payments in and among individual adaptable and expanding compositions of adaptable accounts of individual physicians in individual groups of physicians and health-care providers related to individual diagnoses or individual diagnoses in individual groups of related diagnoses and related health, health-care and health-care services in said categories provided to said individual patients by said individual groups of physicians and related individual disbursements relating and corresponding to said payments in individual adaptable and expanding compositions of adaptable accounts of said individual patients in the SQL databases and tables in and manage by a SQL server coupled to and enabled by said innovative computer programs and software in said computer server or servers viewable, manageable, adjustable and used by and interactive with said individual physicians and individual patients using said devices; and
xiii) computer server-executable algorithmic relations or links of said computer server-executable algorithms;
a process for creating and applying said innovative computer programs and software for:
i) commanding, instructing, enabling and effecting said computer server or servers to repetitively create, effect and enable said system and the methods infra and for commanding, instructing, enabling and effecting said computer server or servers to repetitively and continually creating, generating, apply, adapting, expanding and improving the results and outcomes in said system and of the methods infra;
ii) providing, commanding and instructing computer server or servers to execute and apply said computer server-executable algorithms for creating said system and the methods infra in said processor units, memories and SQL Server;
iii) creating, generating and displaying a plurality of individual interactive and adaptable related electronic templates, a plurality of interactive pop-up and/or drop-down lists and/or menus of interactive words and terms and word and term headers or headings related to categories of chief complaints, signs and symptoms, reviews of systems, physical examinations or findings, laboratory results, anatomical locations, anatomical sites and organ systems, diagnoses, differential diagnoses, treatments, assessments and plans, recommendations, advices, referrals and follow-ups henceforth information and data use by physicians of about 85 medical and surgical specialties and practices;
iv) managing related words and terms in all categories related to individual diagnoses used and use by physicians of all and diverse medical and surgical practices or specialties for and in the communications of said information and data among and between physicians and between and among physicians and patients and are integral components of electronic information and data on health, health-care and health-care-services in individual electronic medical records on or relating to said individual patients, generated and submitted to said processor units and memories and SQL Server comprising SQL databases and tables of said related words and terms in all categories related to individual diagnoses without redundant duplicates, repeats or doubles in said individual categories related to said individual diagnoses related to individual SQL keys in said SQL databases and tables;
v) managing related words and terms in all categories related to individual diagnoses, used and use by physicians of all and diverse medical and surgical practices or specialties for and in the communications of said information and data among and between physicians and between and among physicians and patients and are integral components of electronic information and data on health, health-care and health-care-services in individual electronic medical records on or relating to said individual patients, generated and submitted to said processor units and memories and SQL Server comprising SQL databases and tables of said words and terms in all categories related to individual diagnoses without redundant duplicates, repeats or doubles in said individual categories related to said individual diagnoses in individual groups of related diagnoses and differential diagnoses related to individual SQL keys in said SQL databases and tables;
vi) managing said individual words and terms representing information and data on health, health-care and health-care services and related said individual diagnoses or said individual diagnoses in individual groups of related diagnoses continually and perpetually generated and submitted by said physicians and between and among said individual physicians in individual groups of physicians and adaptable and expanding editions of versions of said information and data on individual diagnoses or individual diagnoses in individual groups of related diagnoses of diseases and disorders and editions of related versions of information and data on related health-care and health-care services and editions of related versions of compositions of accounts and successive editions of related versions of information and data on individual diagnoses or individual diagnoses in individual groups of related diagnoses of diseases and disorders and successive editions of related versions of information and data on health, health-care and health-care services relating to said versions of diagnoses and successive editions of compositions of accounts by physicians and said computer, computer server or servers and manage by said SQL server;
vii) repetitively scanning and checking for redundant duplicates or repeats, doubles in individual physicians' submissions related to individual diagnoses, individual syndromes or diagnoses in individual groups of diagnoses and related said categories in said processor units and memories and outputting said scans and matches to, related to individual SQL keys and compiled in said SQL databases and tables, for removing said redundant duplicates or repeats, doubles from said individual unique relational SQL units in said SQL databases and tables, for not inserting said redundant duplicates or repeats, doubles into said individual unique relational SQL units, for creating, generating, adapting and maintaining for repetitively creating, generating, relating, compiling and applying said SQL databases and tables, relational SQL units and relations of said relational SQL units in and among said SQL databases and tables;
viii) creating, generating, expanding and improving SQL databases and tables comprising relational SQL keys related to said words and terms, headers and categories, physicians and patients in individual relational SQL units in said SQL databases and tables;
ix) creating, generating, adapting, relating, compiling and maintaining adaptable and expanding SQL relations comprising said individual unique relational SQL units in and among said SQL databases and tables in and manage by said SQL Server;
x) scanning and matching said individual words and terms in said processor units and memories and inputting into, relating said scanned and matched said individual words and terms and individual prices, monetary values or costs and compiled in said SQL databases and tables;
xi) generating said adaptable and expanding compositions of said scanned and matched words and terms related to said individual prices, monetary values or costs in related said adaptable and expanding compositions of said accounts in said SQL databases and tables in and manage by said SQL server;
xii) repetitively displaying, manipulating, modifying and editing said adaptable and expanding relational compositions of said individual scanned and matched words and terms and related individual prices, monetary values or costs in said SQL databases and tables by said individual physicians and by and among said individual physicians in individual groups of physicians and individual patients;
xiii) repetitively enabling and effecting computer-automatically and repetitively adjusting said relations of said scanned and matched words and terms words and terms and related individual prices, monetary values or costs for calculating, accounting and adjusting said payments to individual physicians and said proportional payments, distributions, adjustments, redistributions and readjustments of payments and debits in and among individual adaptable and expanding compositions of accounts of said individual physicians in individual groups of physicians; and related individual adaptable and expanding compositions of accounts of said individual patients comprising disbursements, relating and corresponding to said payments, and refunds or reimbursements relating or corresponding to deductions from said payments in said individual patients' accounts; and for repetitively composing said adaptable and expanding related accounts in said processor units and memories and outputted to said SQL databases and tables in and manage by said SQL server;
xiv) repetitively enabling and effecting computer-automatically and repetitively generating relations of said adaptable and expanding compositions on said relational words and terms and said adaptable and expanding compositions of accounts on said payments, proportional payments, distributions and redistributions, adjustments and readjustments of payments in and among said individual adaptable and expanding accounts of said individual physicians relating and corresponding to expenses, deductions, disbursements, refunds and reimbursements in said adaptable and expanding compositions of accounts of said individual patients in said SQL databases and tables in and manage by said SQL Server;
xv) repetitively enabling and effecting computer-automatically and repetitively modifying, editing, relations of said adaptable and expanding compositions of said words and terms and said adaptable and expanding compositions of said accounts in said SQL databases and tables in and manage by said SQL server;
xvi) repetitively enabling and effecting computer-automatically and repetitively generating adapting and expanding said SQL units, SQL relations of said SQL units in and among said SQL databases and tables, in and manage by said SQL Server;
xvii) server-automatically and continually guiding, assisting and adapting decision makings, judgements, determinations and executions of said individual physicians and among physicians in said individual groups of physicians and individual patients impacting on the health, health-care and health-care services related to individual diagnoses, individual syndromes or individual diagnoses in individual groups of related diagnoses being provided or to be provided to patients or individual patients by individual physicians or physicians in individual groups of physicians and health-care providers and on the inputs of said decision makings, judgements, determinations and executions into said SQL databases and tables;
xviii) server-automatically and repetitively and continually patterning and standardizing said decision makings, judgements, determinations and executions on the productions and executions of said quality, quantity and continuity of health, health-care and health-care services, related to individual diagnoses, individual syndromes or individual diagnoses in individual groups of related diagnoses, being provided or to be provided to patients or individual patients by individual physicians or physicians in individual groups of physicians and health-care providers;
xix) server-automatically and continually managing and monitoring diseases and disorders and quality, quantity and continuity of health, health-care and health-care services, being provided and to be provided by physicians, said individual physicians, physicians in said individual groups of physicians and health-care providers to said individual patients and patients related to said diagnoses or individual diagnoses in individual groups of related diagnoses;
xx) server-automatically and repetitively expressing and displaying said individual computer-generated results and outcomes of said scans, matches, correlations, collaborations and comparisons of said information and data in said processor units and memories for server-automatically and continually managing and monitoring diseases and disorders and quality, quantity and continuity of health, health-care and health-care services, being provided and to be provided by physicians, said individual physicians, physicians in said individual groups of physicians and health-care providers to said individual patients and patients related to said diagnoses or individual diagnoses in individual groups of related diagnoses, for and interactive with and said physicians and patients on said viewing screens of said devices;
xxi) server-automatically and continually qualifying and regulating payments for health-care and health-care services to individual physicians and proportional payments, distributions, adjustments, debits, redistributions and readjustments of payments in and among individual adaptable and expanding compositions of adaptable accounts of individual physicians in individual groups of physicians related to individual diagnoses or individual diagnoses in individual groups of related diagnoses and related health, health-care and health-care services provided to said individual patients by said individual groups of physicians and related individual disbursements relating and corresponding to said payments in individual adaptable and expanding compositions of adaptable accounts of said individual patients in the SQL databases and tables in and manage by a SQL server coupled to and enabled by said innovative computer programs and software in said computer server or servers viewable, manageable, adjustable and used by and interactive with said individual physicians and individual patients using said devices;
xxii) server-automatically, repetitively and continually expressions and displays of said adaptable and expanding individual relations of said individual unique relational SQL units in and among said SQL databases and tables in server-automatically generated and displayed interactive related electronic templates, HTML related Web pages and on interactive and related 2-dimensional and 3-dimensional, human figurines and images, graphics, charts, videos and as dynamic data, transactional data and streaming data and any combinations thereof and the like and derivatives on said viewing screens of said devices, enabled by said Internet Explorer and browsers and Web server devices and servers in said network or networks, being used by said patients and physicians; and
xxiii) server-automatically, repetitively and continually enabling and effecting the repetitive retrievals and uses of said relations of said adaptable and expanding compositions of said scanned and matched words and terms related to said individual prices, monetary values or costs in related said adaptable and expanding compositions of said accounts of said individual physicians and individual patients as revenues and earnings of said individual physicians and said individual physicians in individual groups of physicians representing said adaptable payments and proportional payments, distributions, adjustments, debits, readjustments and redistributions of proportional payments in and among said individual adaptable and expanding compositions of adaptable accounts of said individual physicians in individual groups of physicians and related and corresponding expenses, deductions, disbursements relating or corresponding to said payments, and refunds and reimbursements in said adaptable and expanding compositions of accounts of said individual patients in said SQL databases and tables on server-automatically generated and displayed interactive related electronic templates, HTML related Web pages and on interactive and related 2-dimensional and 3-dimensional, human figurines and images, graphics, charts, videos and as dynamic data, transactional data and streaming data and any combinations thereof and the like and derivatives on said viewing screens, by individual requests from said devices enabled by said Web browsers and Web server, by said individual physicians and individual patients;
a process for using said numerous interactive electronic templates for:
i) generating individual words, terms, phrases, sentences, texts, synonyms, acronyms, numbers, data, graphics and any combinations thereof and related adjectives and variables henceforth words and terms in any and all said categories representing information and data on health, health-care and health-care services on or relating to individual diagnoses, individual syndromes or individual diagnoses in individual groups of related diagnoses of diseases and disorders which are integral components of said health, health-care and health-care-service information and data on or relating to diseases and disorders and patients used and use by physicians of all and diverse medical and surgical practices or specialties for and in the communications of said information and data among and between physicians and between physicians and patients and related individual prices, monetary values or costs in said processor units and relating and compiling in said SQL databases and tables in and manage by said SQL Server;
ii) repetitively generating, displaying, manipulating, modifying and editing said words and terms relating to diagnoses continually and perpetually generated and submitted to said process units, memories and SQL databases and tables by said individual physicians, said individual physicians in individual groups of physicians and said individual patients related to individual diagnoses or individual diagnoses in individual groups of same, equivalent or similar diagnoses and related health, health-care and health-care services;
iii) repetitively managing said individual words and terms and related said individual diagnoses or said individual diagnoses in individual groups of same, equivalent or similar diagnoses continually and perpetually generated and submitted by said physicians and between and among said individual physicians in individual groups of physicians and adaptable and expanding editions of versions of said information and data on individual diagnoses or individual diagnoses in individual groups of same, equivalent or similar diagnoses of diseases and disorders and editions of related versions of information and data on related health-care and health-care services and editions of related versions of compositions of accounts and successive editions of related versions of information and data on individual diagnoses or individual diagnoses in individual groups of same, equivalent or similar diagnoses of diseases and disorders and successive editions of related versions of information and data on health, health-care and health-care services relating to said versions of diagnoses and successive editions of compositions of accounts by physicians and said computer, computer server or servers and manage by said SQL server;
iv) repetitively generating said individual words and terms representing information and data on health, health-care and health-care services and related said individual diagnoses or said individual diagnoses in individual groups of same, equivalent or similar diagnoses continually and perpetually generated and submitted by said physicians and between and among said individual physicians in individual groups of physicians and adaptable and expanding editions of versions of said information and data on individual diagnoses or individual diagnoses in individual groups of same, equivalent or similar diagnoses of diseases and disorders and editions of related versions of information and data on related health-care and health-care services and editions of related versions of compositions of accounts and successive editions of related versions of information and data on individual diagnoses or individual diagnoses in individual groups of same, equivalent or similar diagnoses of diseases and disorders and successive editions of related versions of information and data on health, health-care and health-care services relating to said versions of diagnoses and successive editions of compositions of accounts by physicians and said computer, computer server or servers and manage by said SQL server;
v) server-automatically and continually guiding, assisting and adapting decision makings, judgements, determinations and executions impacting on the health, health-care and health-care services, related to individual diagnoses, individual syndromes or individual diagnoses in individual groups of related diagnoses, being provided or to be provided to patients or individual patients by individual physicians or physicians in individual groups of physicians and health-care providers and the generations and inputs of information and data on said decision makings, judgements, determinations and executions into said SQL databases and tables;
vi) server-automatically and instantly identifying, determining and displaying and warning of individual deficiencies, inconsistencies, faults and misses in said decision makings, judgements, determinations and executions of said health, health-care and health-care services related to any or all categories and related definitive or preliminary diagnoses represented by individual deficiencies, inconsistencies, faults and misses in said individual selections and keyboarded words and terms in said templates on said viewing screens referencing to and scanning, matching, correlating, collaborating and comparing with the pooled and compiled decision makings, judgements, determinations and executions on said health, health-care and health-care services related to individual diagnoses, individual syndromes or individual diagnoses in individual groups of related individual diagnoses or individual syndromes related to physicians related to SQL keys in said adaptable and expanding individual relations of said individual unique relational SQL units in and among said SQL databases and tables;
vii) server-automatically, instantly and concomitantly compensating or correcting for or advising and providing options and alternatives to said individual deficiencies, inconsistencies, faults and misses, prior to the inputs of said selections or keyboarded words and terms, by retrieving from and displaying interactive words and terms in said adaptable and expanding individual relations of said individual unique relational SQL units in and among said SQL databases and tables on said viewing screens for said physicians or patients;
viii) submitting said selections, keyboarded words and terms and corrections and editions to said processor units, memories from which server-automatically and repetitively outputting said words and terms in any or all categories related to individual diagnoses, individual syndromes or diagnoses in individual groups of related diagnoses related to individual physicians and patients to relate and compile in said relational individual SQL units in said adaptable and expanding relations of SQL units in said SQL databases and tables in and manage by said SQL in said computer server or servers;
ix) server-automatically, repetitively and continually patterning and standardizing said decision makings, judgements, determinations and executions on the productions and executions of said quality, quantity and continuity of health, health-care and health-care services, related to individual diagnoses, individual syndromes or individual diagnoses in individual groups of related diagnoses, being provided or to be provided to patients or individual patients by individual physicians or physicians in individual groups of physicians and health-care providers;
x) said individual physicians or physicians in individual groups of physicians to repetitively relate individual patients or patients related to individual diagnoses, individual syndromes or diagnoses in individual groups of diagnoses and related said categories related to individual SQL keys to individual SQL keys related to individual physicians, physicians, health-care providers, or physicians in individual groups of physicians and health-care providers in said SQL databases and tables using said devices and said relations of physicians, patients and diagnoses related to said individual SQL keys are server-automatically, repetitively and continually retrieved and displayed on said viewing screens of said physicians and patients who viewed, interactive with, use and select said interactive displays on said viewing screens of said devices;
xi) server-automatically, repetitively and continually relating individual diagnoses, individual syndromes or diagnoses in individual groups of diagnoses and individual patients to individual physicians, physicians, health-care providers or physicians in individual groups of physicians and health-care providers related to said diagnoses related to individual SQL keys in said SQL databases and tables which are server-automatically, repetitively and continually retrieved and displayed on said viewing screens of said physicians and patients who viewed, interactive with, use and select said interactive displays on said viewing screens of said devices;
xii) server-automatically and repetitively selecting, retrieving and displaying adaptable and expanding compositions of said SQL relations of individual relational SQL units related to individual diagnoses, individual syndromes or diagnoses in individual groups of related diagnoses and related differential diagnoses and related categories and individual physicians or physicians in said individual groups of physicians and health-care providers related to said individual SQL keys in said SQL databases and tables on said viewing screens of said devices to individual patients and people;
xiii) repetitively displaying, manipulating, modifying and editing said adaptable and expanding relational compositions of said individual scanned and matched words and terms and related individual prices, monetary values or costs in said SQL databases and tables by said individual physicians and by and among said individual physicians in individual groups of physicians and individual patients;
xiv) repetitively enabling and effecting computer-automatically and repetitively generating relations of said adaptable and expanding compositions on said relational words and terms and said adaptable and expanding compositions of accounts on said payments, proportional payments, distributions and redistributions, adjustments and readjustments of payments in and among said individual adaptable and expanding accounts of said individual physicians relating and corresponding to expenses, deductions, disbursements, refunds and reimbursements in said adaptable and expanding compositions of accounts of said individual patients in said SQL databases and tables in and manage by said SQL Server;
xv) repetitively enabling and effecting computer-automatically and repetitively modifying, editing, relations of said adaptable and expanding compositions of said words and terms and said adaptable and expanding compositions of said accounts in said SQL databases and tables in and manage by said SQL server;
xvi) repetitively enabling and effecting computer-automatically and repetitively generating and expanding said SQL databases and tables, individual SQL units and relations of said SQL units in and among said SQL databases and tables in and manage by said SQL Server; and
xvii) server-automatically and repetitively expressing and displaying said individual computer-generated results and outcomes of said scans, matches, correlations, collaborations and comparisons of said information and data in said processor units and memories and in said SQL units and relations of said SQL units in and among said SQL databases and tables for server-automatically and continually managing and monitoring diseases and disorders and quality, quantity and continuity of health, health-care and health-care services, being provided and to be provided by physicians, said individual physicians, physicians in said individual groups of physicians and health-care providers to said individual patients and patients related to said diagnoses or individual diagnoses in individual groups of related diagnoses, for and interactive with and said physicians and patients on said viewing screens of said devices;
a process for using and applying said SQL databases and tables comprise:
i) individual words, terms, phrases, sentences, texts, synonyms, acronyms, numbers, data, graphics and any combinations thereof and related adjectives and variables henceforth words and terms in any and all said categories representing information and data on health, health-care and health-care services on or relating to individual diagnoses, individual syndromes or individual diagnoses in individual groups of related diagnoses of diseases and disorders which are integral components of said health, health-care and health-care-service information and data on or relating to diseases and disorders and patients used and use by physicians of all and diverse medical and surgical practices or specialties for and in the communications of said information and data among and between physicians and between physicians and patients and related individual prices, monetary values or costs in said processor units and memories and related to individual SQL keys and compiled in said SQL databases and tables in and manage by said SQL Server;
ii) adaptable and expanding compositions of said relational words and terms related to said individual diagnoses or individual diagnoses in individual groups related diagnoses and related health, health-care and health-care services in said SQL databases and tables in and manage by said SQL Server coupled to said processor units and memories and said innovative computer programs and software;
iii) adaptable and expanding compositions of said scanned and matched words and terms related to said individual prices, monetary values or costs in related said adaptable and expanding compositions of said accounts of said individual physicians and individual patients related and compiled in said SQL databases and tables in and manage by said SQL server;
iv) individual unique relational SQL units comprising related said words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to individual SQL keys in said SQL databases and tables in and manage by said SQL Server;
v) adaptable and expanding individual relations of said individual unique relational SQL units in and among said SQL databases and tables in and manage by said SQL Server, according to said innovative computer programs and software; and
vi) adaptable and expanding accounting and tallies of adaptable revenues and earnings of said individual physicians and said individual physicians in individual groups of physicians comprising said payments to individual physicians and said proportional payments, distributions, adjustments, debits, redistributions and readjustments of payments in and among said individual adaptable and expanding compositions of adaptable accounts of individual physicians in individual groups of physicians, and said related individual disbursements relating and corresponding to said payments and related refunds or reimbursements relating or corresponding to deductions from said payments in said individual adaptable and expanding compositions of adaptable accounts of said individual patients according to the instructions and commands of said innovative, computer programs and software for repetitively paying, proportionally paying, distributing, adjusting, debiting, readjusting and redistributing said proportional payments, calculating, tallying and accounting said revenues, earnings, disbursements, refunds, reimbursements in and among said individual adaptable and expanding compositions of adaptable accounts in said databases and tables;
a process for generating, displaying and using a plurality of computer-generated relating interactive electronic templates for generating, relating, expanding and precisely managing individual adaptable, interactive and expanding compositions of said SQL information and data comprising said categories and related medical and surgical words and terms in all categories related to individual diagnoses representing information and data on individual diagnoses and related diseases, illnesses, health, health-care and health-care services in said SQL and means for keyboarding said medical and surgical words and terms in all categories related to individual diagnoses by said physicians and individual patients, upon requests by said devices, retrievable, viewable and manipulated and used in said viewing screens of said devices effected and enabled by said JavaScript, HTML, PHP and Internet Explorer and Web browsers in said network or networks and by said physicians and individual patients;
a process for repetitively creating and generating related words and terms in said categories related to individual diagnoses which are integral components of electronic information and data on health, health-care and health-care-services in individual electronic medical records, on or relating to individual patients, generated and submitted to said processor units and memories by said physicians or physicians in individual groups of physicians or individual patients using said interactive electronic templates viewable and interactive with said physicians and patients on said viewing screens in said devices for accessing said computer servers;
a process for computer server-automatically creating, generating, compiling, expanding and managing individual unique relational SQL units comprising individual unique relational SQL units comprising related said related said words and terms in any or all said categories or headings of information and data without redundant duplicates, repeats or doubles, related individual diagnoses, individual syndromes or individual diagnoses in individual groups of related diagnoses or syndromes, individual physicians, individual health-care providers or physicians and health-care providers in individual groups of physicians and health-care providers and patients related to individual SQL keys in said SQL databases and tables in and manage by said SQL Server;
a process for computer server-automatically creating, generating, expanding, managing and applying adaptable and expanding individual relations of said individual unique relational SQL units in and among said SQL databases and tables in and manage by said SQL Server, according to said innovative computer programs and software;
a process for submitting said selections, keyboarded words and terms and corrections and editions to said processor units, memories from which server-automatically and repetitively outputting said words and terms in any or all categories related to individual diagnoses or diagnoses in individual groups of related diagnoses related to individual physicians and patients to relate and compile in said relational individual SQL units in said adaptable and expanding relations of SQL units in said SQL databases and tables in and manage by said SQL in said computer server or servers;
a process for server-automatically and continually guiding, assisting and adapting decision makings, judgements, determinations and executions of said individual physicians and among physicians in said individual groups of physicians and individual patients impacting on the health, health-care and health-care services related to individual diagnoses, individual syndromes or individual diagnoses in individual groups of related diagnoses being provided or to be provided to patients or individual patients by individual physicians or physicians in individual groups of physicians and health-care providers and on the inputs of said decision makings, judgements, determinations and executions into said SQL databases and tables;
a process for server-automatically, repetitively and continually patterning and standardizing said decision makings, judgements, determinations and executions on the productions and executions of said quality, quantity and continuity of health, health-care and health-care services, related to individual diagnoses, individual syndromes or individual diagnoses in individual groups of related diagnoses, being provided or to be provided to patients or individual patients by individual physicians or physicians in individual groups of physicians and health-care providers;
a process for server-automatically and repetitively expressing and displaying said individual computer-generated results and outcomes of said scans, matches, correlations, collaborations and comparisons of said information and data in said processor units and memories for server-automatically and continually managing and monitoring diseases and disorders and quality, quantity and continuity of health, health-care and health-care services, being provided and to be provided by physicians, said individual physicians, physicians in said individual groups of physicians and health-care providers to said individual patients and patients related to said diagnoses or individual diagnoses in individual groups of related diagnoses, for and interactive with and said physicians and patients on said viewing screens of said devices;
a process for server-automatically and continually qualifying and regulating payments for health-care and health-care services to individual physicians and proportional payments, distributions, adjustments, debits, redistributions and readjustments of payments in and among individual adaptable and expanding compositions of adaptable accounts of individual physicians in individual groups of physicians related to individual diagnoses or individual diagnoses in individual groups of same, equivalent or similar diagnoses and related health, health-care and health-care services provided to said individual patients by said individual groups of physicians and related individual disbursements relating and corresponding to said payments in individual adaptable and expanding compositions of adaptable accounts of said individual patients in the SQL databases and tables in and manage by a SQL server coupled to and enabled by said innovative computer programs and software in said computer server or servers viewable, manageable, adjustable and used by and interactive with said individual physicians and individual patients using said devices; and
a process for server-automatically, repetitively and continually expressions and displays of said adaptable and expanding individual relations of said individual unique relational SQL units in and among said SQL databases and tables in server-automatically generated and displayed interactive related electronic templates, HTML related Web pages and on interactive and related 2-dimensional and 3-dimensional, human figurines and images, graphics, charts, videos and as dynamic data, transactional data and streaming data and any combinations thereof and the like and derivatives on said viewing screens of said devices.

18. The method according to claim 17 comprises various permutations and productions of any and all relations of individual prices, monetary values or costs and related any and all words and terms and relations and combinations of said words and terms representing various relations and combinations of health-care and health-care services effected and rendered by said individual physicians, individual health-care providers individual physicians, individual health-care providers in individual groups of individual physicians, individual health-care providers related to individual diagnoses or individual diagnoses in individual groups of related diagnoses and/or syndromes arising from said processes for guiding, assisting and adapting said decision makings, judgements, determinations and executions, for patterning, standardizing and tuning said decision makings, judgements, determinations and executions and for server-automatically, repetitively, continually and perpetually managing and monitoring diseases and disorders and quality, quantity and continuity of said health, health-care and health-care services among said physicians and health-care providers in related said adaptable and expanding compositions of said relations of said individual SQL units and said adaptable and expanding compositions of said individual accounts comprising payments for health-care and health-care services to individual physicians and proportional payments, distributions, adjustments, debits, redistributions and readjustments of payments in and among individual adaptable and expanding compositions of adaptable accounts of individual physicians in individual groups of physicians related to individual diagnoses or individual diagnoses in individual groups of same, equivalent or similar diagnoses and related health, health-care and health-care services provided to said individual patients by said individual groups of physicians and related individual disbursements relating and corresponding to said payments in individual adaptable and expanding compositions of adaptable accounts of said individual patients in said SQL databases and tables in and manage by a SQL server which are viewable, manageable, adjustable, adaptable and used by and interactive with said individual physicians and individual patients using said devices.
